(19) United States
(12) Patent Application Publication
(10) Pub. No.: US 2015/0205180 A1
(43) Pub. Date: Jul. 23, 2015

(54) METHOD OF MANUFACTURING ELECTROPHORESIS DISPERSION LIQUID, ELECTROPHORESIS DISPERSION LIQUID, DISPLAY DEVICE AND ELECTRONIC APPARATUS

(71) Applicant: Seiko Epson Corporation, Tokyo (JP)

(72) Inventors: Shinobu Yokokawa, Okaya-shi (JP); Masahiko Nakazawa, Matsumoto-shi (JP); Keiichi Inoue, Suwa-shi (JP); Kei Kamakura, Hara-mura (JP)

(21) Appl. No.: 14/599,579

(22) Filed: Jan. 19, 2015

(30) Foreign Application Priority Data
Jan. 20, 2014 (JP) 2014-008135
Jan. 20, 2014 (JP) 2014-008136

(51) Int. Cl. G02F 1/167

(52) U.S. Cl. CPC G02F 1/167; G02F 2001/1678

(57) ABSTRACT

A method of manufacturing a dispersion medium includes bonding a siloxane compound to the surface of core particles by a precursor of the siloxane compound and the surface of the core particles being reacted in the dispersion medium, and removing the precursor not bonded to the core particles.

### BACKGROUND

1. Technical Field

The present invention relates to a method of manufacturing an electrophoresis dispersion liquid, and an electrophoresis dispersion liquid, a display device, and an electronic apparatus.

2. Related Art

Generally, when an electrical field is operated in a dispersion system in which fine particles are dispersed in a liquid, it is known that the fine particles are moved (migrate) in the liquid by a coulomb force. This phenomenon is known as electrophoresis, and in recent years, electrophoresis display devices in which desired information (image) is displayed using electrophoresis have garnered attention as new display devices (for example, refer to JP-A-2008-216902).

The electrophoresis display device has display memory properties in a state in which application of a voltage is stopped and wide viewing angle properties, and is capable of high contrast display with low power consumption.

Since electrophoresis display devices are non-light emitting display devices, electrophoresis display devices are better for the eyes compared to a light-emitting display device such as a cathode ray tube.

In the related art, the dispersion liquid used in such electrophoresis is manufactured using a method of manufacturing such as disclosed in JP-A-2008-216902, JP-A-2012-78484, and JP-A-2005-255911.

When described more specifically, in the method of manufacturing disclosed in JP-A-2008-216902, a mixed solution of a first solvent formed from an ionic polymer, an emulsifier, a coloring agent, and silicone oil and a second solvent that is incompatible with the silicone oil, has a lower boiling point than the silicone oil and that dissolves the ionic polymer is mixed and emulsified, and the second solvent is removed from the emulsified mixed solution.

In the method for manufacturing disclosed in JP-A-2012-78484, a mixed liquid that includes a nonaqueous polar solvent, a resin dissolved in the nonaqueous polar solvent, and pigment particles dispersed in the nonaqueous polar solvent is dispersed in silicone oil, and the nonaqueous polar solvent is removed.

The method of manufacturing disclosed in JP-A-2005-255911 is a method emulsifying and dispersing a non-polar system using an organic solvent A that is a non-polar organic solvent, and an organic solvent B that is a nonpolar solvent that is almost completely incompatible with the organic solvent A and has a lower boiling point than the organic solvent A, in which, after a dispersion phase solution is made by a resin that is able to dissolve in the organic solvent B and does not dissolve in the organic solvent A being contained in the organic solvent B, and the dispersion phase solution is dispersed in the organic solvent A, thereby forming a dispersion liquid formed from a dispersion phase of the dispersion phase solution and a continuous phase of the organic solvent A, the organic solvent B is removed from the dispersion liquid by decompression or heating.

Although as surface modifier having a polymer chain is adsorbed on the surface of the particles in the solution in any of the methods of manufacturing disclosed in the above-described JP-A-2008-216902, JP-A-2012-78484, and JP-A-2005-255911, because there is no step for removing the excess surface modifier not adsorbed on the particles, excess surface modifier remains in the obtained dispersion liquid, and as a result, there is a problem of the conductivity of the dispersion liquid increasing. Because a group that contributes charging properties is not, or, if introduced, is not introduced to the mother particle independent of the surface modifier having the polymer chain (introduced to the surface modifier to impart dispersibility, rather than the mother particle itself), the charging properties of the obtained electrophoretic particles is largely dependent on the introduction amount of the surface modifier or the charging properties of the mother particles themselves. Therefore, there is a problem that is it difficult to control the charge state while exhibiting the desired dispersibility.

### SUMMARY

An advantage of the some aspects of the invention is to provide a method of manufacturing an electrophoresis dispersion liquid capable of lowering conductivity, and a method of manufacturing an electrophoresis dispersion liquid able to arbitrarily control the charging characteristics, while exhibiting excellent dispersion characteristics in the dispersion medium, and to provide an electrophoresis dispersion liquid manufactured using the method for manufacturing, and a display device and an electronic apparatus using the same.

The invention can be realized in the following forms or application examples.

According to an aspect of the invention, there is provided a method of manufacturing an electrophoresis dispersion liquid in which electrophoretic particles in which a compound that includes a polymer chain is bonded to the surface of the particles are dispersed in a dispersion medium, the method including bonding the compound to the surface of the particles in a liquid medium; and removing the compound or a precursor thereof from particles not bonded to, in which the removing is performed while maintaining a state in which the particles to which the compound is bonded contact the liquid medium.

In this case, the excess compound or precursor may be removed after the compound that includes a polymer chain is bonded to the surface of the particles. Therefore, it is possible to reduce the excess compound or precursor remaining in the obtained electrophoresis dispersion liquid. As a result, it is possible to reduce the conductivity of the electrophoresis dispersion liquid finally obtained.

In the bonding, because the state in which the liquid medium or dispersion medium is present with the particles to which the compound is bonded without drying and hardening, it is possible to effectively suppress damage to or aggregation of the particles to which the compound that includes a polymer chain is bonded.

In the method of manufacturing an electrophoresis dispersion liquid of the invention, it is preferable that in the bonding, the compound be chemically bonded to the surface of the particles by a precursor of the compound and the surface of the particles being reacted in the liquid medium.

In so doing, the bond between the compound that includes a polymer chain and the surface of the particles is strongly fixed, and it is possible to prevent the compound that includes a polymer chain being separated from the surface of the particles in the removing. As a result, it is possible to effectively reduce the conductivity of the dispersion liquid obtained in the removing and the conductivity of the electrophoresis dispersion liquid finally obtained while realizing the dispersibility of the particles (dispersibility of the electrophoretic particles) obtained after the removing.

In the method of manufacturing an electrophoresis dispersion liquid of the invention, it is preferable that the liquid medium be the dispersion medium.

In so doing, it becomes unnecessary to substitute the liquid medium with the final dispersion medium, and it is possible to comparatively simply prevent or suppress involuntary liquids being mixed in the finally obtained dispersion medium of the electrophoresis dispersion liquid. Because it becomes unnecessary to substitute the liquid medium with the final dispersion medium, it is possible to simplify the removing.

In the method of manufacturing an electrophoresis dispersion liquid of the invention, it is preferable that the liquid medium be different to the dispersion medium, and be compatible with the dispersion medium, and adding the dispersion medium, and removing the liquid medium are further included, either during the removing or after the removing.

In so doing, it is possible to substitute the liquid medium with the dispersion medium during the removing or after the removing. It is possible to select, as appropriate, a liquid medium different to the type (in particular, viscosity) of the dispersion medium of the electrophoresis dispersion medium finally obtained. Therefore, in the bonding, even without the separate use of an additive such as a dispersant, it is possible to increase the dispersibility of the particles to which the compound that includes a polymer chain are not bonded in the liquid medium. As a result, in the bonding, it is possible to effectively perform a reaction of the precursor of the compound and the surface of the particles.

In the method of manufacturing an electrophoresis dispersion liquid of the invention, it is preferable that the liquid medium have a higher viscosity than the dispersion medium.

In so doing, while using a liquid medium with chemical characteristics close to the dispersion medium, in the bonding, it is possible to increase the dispersibility of the particles to which the compound that includes a polymer chain are not bonded in the liquid medium.

In the method of manufacturing an electrophoresis dispersion liquid of the invention, it is preferable that the number average molecular weight of the polystyrene conversion of the compound be 40,000 or more, and, in the bonding, 0.01 wt % or more and 0.1 wt % or less of water be added with respect to the weight of the liquid medium.

In so doing, it is possible to prevent unnecessary liquid from being mixed into the dispersion medium of the electrophoresis dispersion liquid finally obtained, and for the characteristics of the electrophoresis dispersion liquid to be excellent.

According to method of manufacturing an electrophoresis dispersion liquid of the invention, it is preferable that the number average particle diameter of the particles be 50 nm or more and 150 nm or less, in the bonding, the weight of the liquid medium be 15 times or more and 60 times or less with respect to the weight of the particles.

In so doing, it is possible to favorably maintain the reaction opportunity between the particles and the precursor in the bonding, and to increase the dispersibility of the particles and the precursor in the liquid medium.

According to method of manufacturing an electrophoresis dispersion liquid of the invention, it is preferable that the number average particle diameter of the particles be 250 nm or more and 350 nm or less.

In this case, because the particles easily settle, it is effective to use a high viscosity liquid medium and to use a method that substitutes the liquid medium with the dispersion medium after the bonding.

According to method of manufacturing an electrophoresis dispersion liquid of the invention, it is preferable that the dynamic viscosity of the liquid medium be 10 mm²/s or more and 100 mm²/s or less.

In so doing, in a case in which the affinity between particles to which the compound is not bonded and the liquid medium is comparatively low, it is possible to increase the dispersibility of the particles with respect to the liquid medium even if the compound is not bonded.

According to method of manufacturing an electrophoresis dispersion liquid of the invention, it is preferable that, in the bonding, 8 wt % or more and 50 wt % of the compound be added with respect to the weight of the particles.

In so doing, it is possible to favorably maintain the reaction opportunity between the particles and the precursor in the bonding, and to increase the dispersibility of the particles and the precursor in the liquid medium.

According to method of manufacturing an electrophoresis dispersion liquid of the invention, it is preferable that the volume resistivity of the dispersion liquid obtained after the removing be 1011 Ω·cm or more.

In so doing, it is possible for the volume resistivity of the finally obtained electrophoresis dispersion liquid to be 1011 Ω·cm or more.

According to method of manufacturing an electrophoresis dispersion liquid of the invention, it is preferable that the removing be performed under temperature conditions of less than the boiling point of the liquid medium or the dispersion medium.

In so doing, it is possible, in the removing, to comparatively simply maintain the state which the liquid medium or the dispersion medium is present with the particles to which the compound that includes a polymer chain is bonded without drying and hardening.

According to method of manufacturing an electrophoresis dispersion liquid of the invention, it is preferable that the removing include washing the particles to which the compound is bonded using the liquid medium or the dispersion liquid.

In so doing, it is possible, in the removing, to comparatively simply maintain the state in which the liquid medium or the dispersion medium is present with the particles to which the compound that includes a polymer chain is bonded without drying and hardening. It is possible to effectively reduce unnecessary components mixed into the dispersion medium of the electrophoresis dispersion liquid finally obtained.

According to method of manufacturing an electrophoresis dispersion liquid of the invention, it is preferable that the polymer chain include a linking structure in which a plurality of siloxane bonds is linked in series.

In so doing, it is possible to increase the dispersibility of the electrophoretic particles. It is possible to reduce the amount of the compound that includes a polymer chain that bonds to the surface of the particles, and, as a result, the charging properties of the particles themselves are generated, a group having charging characteristics is introduced to the surface of the particles, and it is possible to increase the charging properties of the electrophoretic properties.

According to method of manufacturing an electrophoresis dispersion liquid of the invention, it is preferable that the polymer chain have a straight chain molecular structure configured by a main chain that includes the linking structure and a side chain bonded to the straight chain.

In so doing, the molecular structure of the long chain of the compound (siloxane compound) bonded to the surface of the particles is comparatively stably maintained, and it is possible for separation distance between particles spaced with the compound to be sufficiently set. Therefore, the function of the siloxane compound, such as providing dispersibility to the electrophoretic particles, is still significantly promoted. A comparatively low polarity compound is often used in the dispersion medium. Meanwhile, compound that includes a siloxane bond, depending on the structure frequently have a comparatively low polarity. Accordingly, the electrophoretic particles that include such a siloxane compound show particularly favorable dispersibility with respect to the dispersion medium.

According to method of manufacturing an electrophoresis dispersion liquid of the invention, it is preferable that the precursor be a reactant obtained by reacting a silicone oil and a coupling agent, and a coupling agent-derived hydrolysable group and the surface of the particles be dehydration-condensation reacted in the bonding.

In so doing, regardless of whether the long chain and straight chain molecular structure is included, control of the bonding amount with respect to particles is easy, and, as a result, it is possible to realize electrophoretic particles that include a siloxane compound strictly controlled to an amount that is a target. In other words the siloxane compound that includes a long chain and straight chain molecular structure is able to go through a process of sufficiently ensuring a reaction opportunity between the silicone oil and the coupling agent in advance by intermediating between the silicone oil-derived structure and the particles with the structure of the coupling agent derivative, in contrast to the numerous difficulties that accompany accurately introducing an amount that is a target with respect to the particles. Therefore, it is possible for the magnitude of the reactivity of the coupling agent to be effectively utilized with respect to the particles, and it is possible to precisely control the introduction amount of the siloxane compound, as a result.

According to method of manufacturing an electrophoresis dispersion liquid of the invention, it is preferable that the precursor be silicone oil, and that a silicone oil-derived functional group and the surface of the particles be reacted in the bonding.

In so doing, because the silicone oil-derived structure accounts for the majority of the siloxane compound, for example, the dispersibility of the electrophoretic particles is particularly increased when the silicone oil or modified materials thereof is used as the dispersion medium.

According to another aspect of the invention, there is provided a method of manufacturing an electrophoresis dispersion liquid in which electrophoretic particles in which a polymer chain-containing compound is bonded to the surface of the particles are dispersed in a dispersion medium, the method including bonding the polymer chain-containing compound to the surface of the particles in the liquid medium; bonding a charge control group to the surface of the particles; and preparing the electrophoresis dispersion liquid in which the electrophoretic particles are dispersed in the dispersion medium, obtained through the bonding of the polymer chain-containing compound and the bonding of the charge control group, in which the particles maintain a state of contact with the liquid medium between the bonding of the polymer chain-containing compound and the bonding of the charge control group, and between the bonding of the charge control group and the preparing of the electrophoresis dispersion liquid.

In this case, it is possible to independently introduce the polymer chain-containing compound and the charge control group to the surface of the particles. Therefore, it is possible for the obtained electrophoretic particles of the electrophoresis dispersion liquid to contribute charging properties through the charge control group, and the dispersibility in the dispersion medium is improved due to the polymer chain-containing compound. It is possible to control the charging properties of the electrophoretic particles by adjusting the type, introduction amount, or the like of the of charge control group. Therefore, regardless of the type of particle, it is possible to exhibit a desired polarity or the charging characteristics of the charging amount.

In the removing of the excess polymer chain-containing compound and the removing of the excess charge control group, it is possible to effectively suppress damage to or aggregation of the particles to which the polymer chain-containing compound is bonded.

According to method of manufacturing an electrophoresis dispersion liquid of the invention, it is preferable that the bonding of the charge control group be performed after the bonding of the polymer chain-containing compound.

According to method of manufacturing an electrophoresis dispersion liquid of the invention, it is preferable that the bonding of the charge control group be performed before the bonding of the polymer chain-containing compound.

According to still another aspect of the invention, there is provided a method of manufacturing an electrophoresis dispersion liquid in which electrophoretic particles in which a polymer chain-containing compound is bonded to the surface of the particles are dispersed in a dispersion medium, the method including bonding the polymer chain-containing compound to the surface of the particles in the liquid medium; preparing electrophoresis dispersion liquid in which the electrophoretic particles are dispersed in the dispersion medium obtained through the bonding of the polymer chain-containing compound; in which the bonding of the polymer chain-containing compound is performed at the same time as the bonding of the charge control group to the surface of the particles, and the particles maintain a state of contact with the liquid medium between the bonding of the polymer chain-containing compound and the preparing of the electrophoresis dispersion liquid.

In this case, it is possible to independently introduce the polymer chain-containing compound and the charge control group to the surface of the particles. Therefore, it is possible for the obtained electrophoretic particles of the electrophoresis dispersion liquid to contribute charging properties through the charge control group, and the dispersibility in the dispersion medium is improved due to the polymer chain-containing compound. It is possible to control the charging properties of the electrophoretic particles by adjusting the type, introduction amount, or the like of the of charge control group. Therefore, regardless of the type of particle, it is possible to exhibit a desired polarity or the charging characteristics of the charging amount.

In the removing of the excess polymer chain-containing compound and the removing of the excess charge control group, it is possible to effectively suppress damage to or aggregation of the particles to which the polymer chain-containing compound is bonded.

In this case, it is preferable that the method of manufacturing an electrophoresis dispersion liquid further include removing the excess polymer chain-containing compound or precursor thereof not bonded to the particles, after the bonding of the polymer chain-containing compound, in which the removing of the excess polymer chain-containing compound is performed while maintaining a state in which the particles contact the liquid medium or the dispersion medium.

In so doing, it is possible to reduce the excess polymer chain-containing compound or precursor thereof remaining in the obtained electrophoresis dispersion liquid. As a result, it is possible to reduce the conductivity of the electrophoresis dispersion liquid finally obtained.

In this case, it is preferable that the method of manufacturing an electrophoresis dispersion liquid include removing the excess charge control group or a precursor thereof not bonded to the particles after the bonding of the charge control group, in which the removing of the excess charge control group is performed while maintaining a state in which the particles contact the liquid medium or the dispersion medium.

In so doing, it is possible to reduce the excess charge control group or precursor thereof remaining in the obtained electrophoresis dispersion liquid. As a result, it is possible to reduce the conductivity of the electrophoresis dispersion liquid finally obtained.

In this case, it is preferable that, in the bonding of the polymer chain-containing compound, the polymer chain-containing compound be chemically bonded to the surface of the particles by the precursor of the polymer chain-containing compound and the surface of the particles being reacted in the liquid medium.

In so doing, the bond between the polymer chain-containing compound and the surface of the particles is strongly fixed, it is possible to prevent the polymer chain-containing compound from being separated from the surface of the particles in the removing of the excess polymer chain-containing compound. As a result, it is possible to effectively reduce the conductivity of the dispersion liquid obtained by the removing of the excess polymer chain-containing compound and the conductivity of the electrophoresis dispersion liquid finally obtained while realizing the dispersibility of the particles (dispersibility of the electrophoretic particles) obtained after the removing of the excess polymer chain-containing compound.

In the method of manufacturing an electrophoresis dispersion liquid of the invention, it is preferable that the liquid medium be the dispersion medium.

In so doing, it becomes unnecessary to substitute the liquid medium with the final dispersion medium, and it is possible to comparatively simply prevent or suppress involuntary liquids being mixed in the dispersion medium of the electrophoresis dispersion liquid finally obtained. Because it becomes unnecessary to substitute the liquid medium with the final dispersion medium, it is possible to simplify the process therefor in a case of performing the removing of the excess substance.

In the method of manufacturing an electrophoresis dispersion liquid of the invention, it is preferable that the liquid medium be different to the dispersion medium and have compatibility with the dispersion medium.

In so doing, it is possible to substitute the liquid medium with the dispersion medium after the bonding of the polymer chain-containing compound. It is possible to select, as appropriate, a liquid medium different to the type (in particular, viscosity) of the dispersion medium of the electrophoresis dispersion liquid finally obtained. Therefore, in the bonding of the polymer chain-containing compound, even without the separate use of an additive such as a dispersant, it is possible to increase the dispersibility of the particles to which the polymer chain-containing compound is not bonded in the liquid medium. As a result, in the bonding of the polymer chain-containing compound, it is possible to effectively perform bonding of the polymer chain-containing compound and the surface of the particles.

In the method of manufacturing an electrophoresis dispersion liquid of the invention, it is preferable that in the bonding of the charge control group bonding, the charge control group be chemically bonded to the surface of the particles by a precursor of the charge control group and the surface of the particles being reacted in the liquid medium.

In so doing, the bond between the charge control group and the surface of the particles is strongly fixed, it is possible to prevent the charge control group from being separated from the surface of the particles in the removing of the excess charge control group. As a result, it is possible to effectively reduce the conductivity of the dispersion liquid obtained in the removing of the excess charge control group and the conductivity of the electrophoresis dispersion liquid finally obtained while realizing the dispersibility of the particles (dispersibility of the electrophoretic particles) obtained after the removing of the excess charge control group.

In this case, it is preferable that the charge control group be an organic group, include a main skeleton and a substituent bonded to the main skeleton, and be a polarization group in which the electrons are biased to the particle side or the opposite side thereof of the main skeleton in a state in of being bonded to the particles.

By setting at least one condition of the type of substituent, number of bonds with respect to the main skeleton, and a binding site, the electrons in the main skeleton are biased (polarization), and in so doing, such a polarization group is able to control the charge state of the electrophoretic particles.

In this case, it is preferable that the charge control group be an organic group, include a main skeleton, and be a charging group that have a positive or negative charge.

Such a charging group is able to control the charging characteristics, such as the charging polarity or the charging amount by setting, as appropriate, the type of ion pair.

According to method of manufacturing an electrophoresis dispersion liquid of the invention, it is preferable that the polymer chain-containing compound include a linking structure in which a plurality of siloxane bonds are linked in series.

In so doing, it is possible to increase the dispersibility of the electrophoretic particles. It is possible for the amount of the polymer chain-containing compound that bonds with the surface of the particles to be reduced, and the area of the region to which the charge control group is able to be introduced on the surface of the particles to be increased, and, as a result, it is possible for the breadth of control of the charging properties of the electrophoretic particles to be increased due to the charge control group.

In this case, an electrophoresis dispersion liquid is manufactured using the method of manufacturing an electrophoresis dispersion liquid of the invention.

In so doing, it is possible to provide an electrophoresis dispersion liquid able to lower conductivity, or an electrophoresis dispersion liquid with an excellent balance between dispersibility and charging characteristics while realizing excellent dispersibility of the electrophoretic particles.

According to another aspect of the invention, there is provided a display device including a first substrate on which a first electrode is provided, a second substrate arranged facing the first substrate and on which a second electrode is provided, and a display layer provided between the first substrate and the second substrate, and that includes the electrophoresis dispersion liquid.

In so doing, it is possible to provide a display device that is capable of high contrast display.

According to another aspect of the invention, there is provided an electronic apparatus of the invention including the display device of the invention.

In this manner, it is possible to provide an electronic apparatus having excellent reliability.

### BRIEF DESCRIPTION OF THE DRAWINGS

The invention will be described with reference to the accompanying drawings, wherein like numbers reference like elements.

FIG. 1 is a cross-sectional view showing a first embodiment of a display device of the invention.

FIG. 2 is a plan view (upper surface view) of the display device shown in FIG. 1.

FIGS. 3A and 3B are cross-sectional views describing the driving of the display device shown in FIG. 1.

FIG. 4 is a cross-sectional view schematically showing the electrophoretic particles used in the display device shown in FIG. 1.

FIGS. 5A and 5B are drawings for describing the siloxane compound bonded to the particle surface of the electrophoretic particles shown in FIG. 4.

FIG. 6 is a drawing specifically showing the reactive functional group X included in the coupling agent and reactive functional group Y included in the modified silicone oil, for the coupling agent and the modified silicone oil used in obtaining the siloxane compound having the structure Z shown in FIGS. 5A and 5B.

FIG. 7 is a cross-sectional view showing a second embodiment of a display device of the invention.

FIG. 8 is a cross-sectional view showing a third embodiment of a display device of the invention.

FIGS. 9A to 9D are diagrams for describing a first embodiment of the method of manufacturing an electrophoresis dispersion liquid of the invention.

FIGS. 10A and 10B are diagrams for describing an example of the method of manufacturing a precursor of the siloxane compound bonded to the surface of the particles.

FIGS. 11A to 11D are diagrams for describing the second embodiment of the method of manufacturing an electrophoresis dispersion liquid of the invention.

FIG. 12 is a cross-sectional view schematically showing the second embodiment of the electrophoretic particles used in the display device shown in FIGS. 1, 7 and 8.

FIGS. 13A and 13B are drawings for describing the siloxane compound bonded to the particle surface of the electrophoretic particles shown in FIG. 12.

FIG. 14 is a drawing specifically showing the reactive functional group X included in the coupling agent and reactive functional group Y included in the modified silicone oil, for the coupling agent and the modified silicone oil used in obtaining the siloxane compound having the structure Z shown in FIG. 13.

FIGS. 15A to 15F are diagrams for describing an example (polarization group) of the charge control group bonded to the surface of the electrophoretic particles shown in FIG. 12.

FIG. 16 is a diagram for describing another example (polarization group) of the charge control group bonded to the surface of the electrophoretic particles shown in FIG. 12.

FIGS. 17A to 17C are diagrams for describing the type of method of manufacturing electrophoretic particles in a third embodiment of the method of manufacturing an electrophoresis dispersion liquid of the invention.

FIGS. 18A to 18D are diagrams for describing the type of method of manufacturing electrophoretic particles in the third embodiment of the method of manufacturing an electrophoresis dispersion liquid of the invention.

FIGS. 19A to 19F are diagrams for describing the second embodiment of the method of manufacturing an electrophoresis dispersion liquid of the invention.

FIGS. 20A and 20B are diagrams for describing an example of a method of manufacturing a silicon compound.

FIGS. 21A and 21B are diagrams for describing an example of a method of manufacturing the charge control group (polarization group).

FIG. 22 is a diagram for describing an example of a method of manufacturing the charge control group (polarization group) in the fourth embodiment of the method of manufacturing an electrophoresis dispersion liquid of the invention.

FIG. 23 is a perspective view showing an embodiment of a case where the electronic apparatus of the invention is applied to electronic paper.

FIGS. 24A and 24B are diagrams showing an embodiment of a case where the electronic apparatus of the invention is applied to a display.

### DESCRIPTION OF EXEMPLARY EMBODIMENTS

Below, the method of manufacturing an electrophoresis dispersion liquid, the electrophoresis dispersion liquid, a display sheet, the display device, and the electronic apparatus of the invention will be described in detail based on preferred embodiments shown in the attached drawings.

### Display Device

### First Embodiment

First, the first embodiment of the display device of the invention will be described.

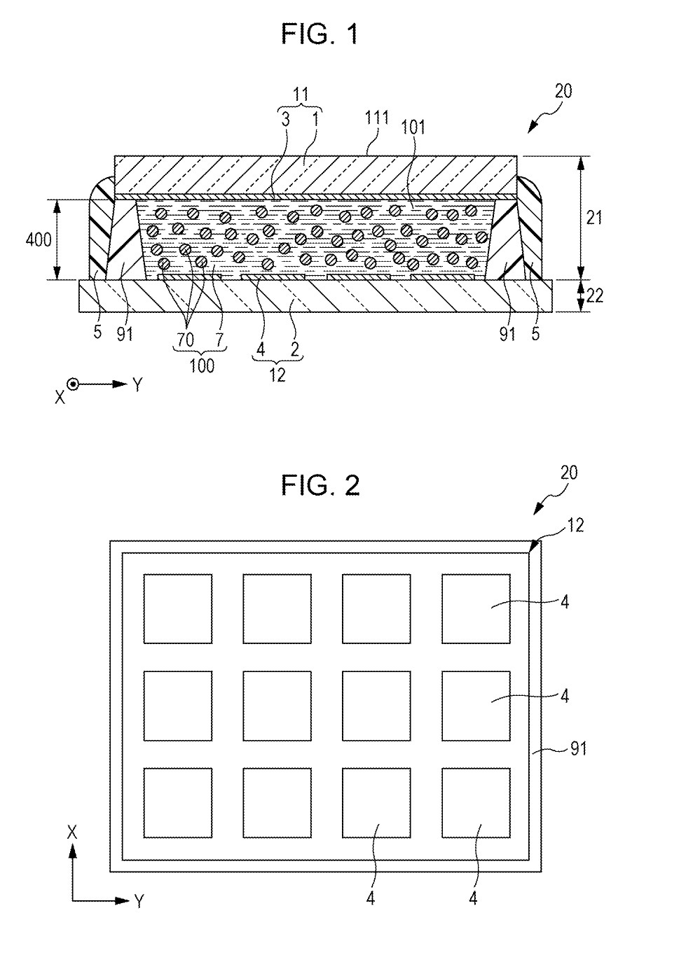

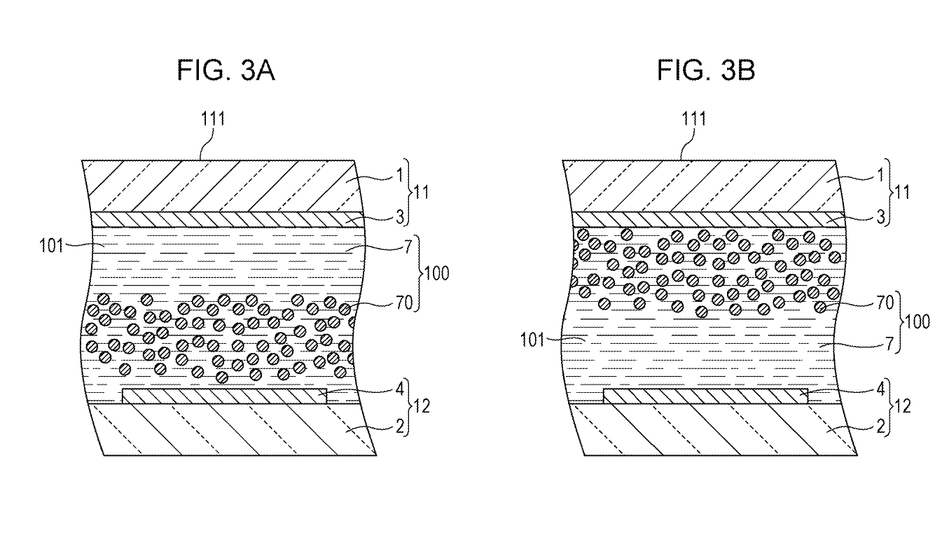

FIG. 1 is a cross-sectional view showing the first embodiment of the display device of the invention, FIG. 2 is a plan view (upper surface view) of the display device shown in FIG. 1, and FIGS. 3A and 3B are cross-sectional views describing the driving of the display device shown in FIG. 1. Below, for convenience of description, description is provided with the upper side in FIGS. 1 and 3 as “up” and the lower side as “down”. As shown in FIG. 1, the two mutually intersecting directions in the plan view of the display device are the “X direction” and the “Y direction”.

The display device (display device of the invention) 20 shown in FIG. 1 is an electrophoretic display device displaying a desired image using the migration of particles. The display device 20 includes a display sheet (front plane) 21, and a circuit substrate (back plane) 22. The display sheet 21 and the circuit substrate 22 can also be said to configure the display sheet.

As shown in FIG. 1, the display sheet 21 includes a substrate (electrode substrate) 11 including a plate-like base 1 and a first electrode 3 provided on the lower surface of the base 1, and a display layer 400 provided below the substrate 11, and that is filled with the dispersion liquid 100 (electrophoresis dispersion liquid) that includes the electrophoretic particles 70. In such a display sheet 21, the upper surface of the substrate 11 configures the display surface 111.

On the other hand, the circuit substrate 22 includes a substrate 12 including a flat base 2, and a plurality of second electrodes 4 provided on the upper surface of the base 2, and a circuit (not shown) provided on substrate 12.

The circuit includes TFTs (switching element) arranged in a matrix, a gate line and a data line formed corresponding to the TFTs, a gate driver that applies a desired voltage to the gate line, a data driver that applies a desired voltage to the data line, and a controller controlling the driving of the gate driver and the data driver.

Below, the configuration of each part will be sequentially described.

### Substrate

The base 1 and the base 2 are respectively configured by sheet-like (plate-like) members, and has a function of supporting and protecting each member arranged therebetween. Although each of the bases 1 and 2 is preferably either flexible or hard, flexible is preferable. By using flexible bases 1 and 2, it is possible to obtain a flexible display device 20, that is, a display device 20 useful in the construction of electronic paper, for example.

In cases of the bases 1 and 2 having flexibility, examples of the constituent materials include glass or resin having high transparency. Examples of the resin include, for example, polyesters such as polyethylene terephthalate (PET) and polyethylene naphthalate (PEN), polyolefins such as polyethylene, modified polyolefin, cyclic olefin (COP), polyamide, thermoplastic polyimide, polyether, polyether ether ketone, polycarbonate (PC), and polyurethanes, various types of thermoplastic elastomer such as chlorinated polyethylenes, or copolymers, blends, and polymer alloys mainly composed of these, and these may be used singly or in mixtures of two or more types.

The respective average thicknesses of the bases 1 and 2 are set, as appropriate, according to the constituent materials, the applications, and the like, and, although not particularly limited; in cases of having flexibility, approximately 20 μm or more and 500 μm or less is preferable and approximately 25 μm or more and 250 μm or less is more preferable, and approximately 50 μm or more and 200 μm or less is still more preferable. In so doing, it is possible to achieve size reductions (in particular, thinning) in the display device 20 while achieving a harmony between flexibility and strength in the display device 20.

A first electrode 3 and a second electrode 4, which are formed in a film-shape, are respectively provided on the surfaces of the display layer 400 side of the bases 1 and 2, that is, on the lower surface of the base 1 and the upper surface of the base 2. In the embodiment, the first electrode 3 is a common electrode, and the second electrode 4 is an individual electrode (pixel electrode connected to the TFT) divided into a zig-zag form in the X direction and the Y direction. In the display device 20, a region where one of the second electrodes 4 and the first electrode 3 overlap configures one pixel.

The respective constituent materials of the electrodes 3 and 4 are not particularly limited if the materials substantially have conductivity, and examples thereof include metal materials such as gold, silver, copper, or aluminum, or an alloy or the like containing these, carbon-based materials such as carbon black, graphene, carbon nanotubes, or fullerenes, conductive polymer materials such as polyacetylene, polyfluorene, and polythiophene or derivatives thereof, ion conductive polymer materials in which ionic substances such as NaCl, Cu (CF₃SO₃)₂, or the like are dispersed in a matrix resin, such as polyvinyl alcohol or polycarbonate, and various conductive materials such as conductive oxide materials, such as indium oxide (IO), indium tin oxide (ITO), fluorine-doped tin oxide (FTO), and zinc oxide (ZnO), and these may be used singly or a combination of two or more types thereof may be used.

The average thicknesses of the electrodes 3 and 4 are respectively set, as appropriate, according to the constituent materials, the applications, and, although not particularly limited, it is preferable that the thickness be approximately 0.01 μm or more and 10 μm or less, and approximately 0.02 μm or more to 5 μm or less is more preferable.

The base and electrode arranged on the display surface 111 side from the among each of the bases 1 and 2 and each of the electrodes 3 and 4 respectively have optical transparency, that is, are substantially transparent (colorless and transparent, colored and transparent, or translucent). In the embodiment, because the upper surface of the substrate 11 configures the display surface 111, at least the base 1 and the first electrode 3 are substantially transparent. In so doing, it is possible for the image displayed on the display device 20 to be easily recognized through visual observation from display surface 111 side.

### Seal Portion

Between the substrate 11 and the substrate 12, the seal portion (sealing portion) 5 is provided along the edges thereof. The display layer 400 is airtightly sealed by the sealing portion 5. As a result, it is possible to prevent the permeation of moisture into the display device 20, and to more reliably prevent the deterioration of the display performance of the display device 20.

The constituent material of the sealing portion 5 is not particularly limited, and examples thereof include various resin materials, such as thermoplastic resins such as acrylic resins, urethane resins, and olefin resins, thermosetting resins, such as epoxy resins, melamine resins, phenolic resins, and silicone resins and these may be used singly or a combination of two or more types thereof may be used.

Although the height of the seal portion 5 is not particularly limited, approximately 5 μm or more to 100 μm or less is preferable.

### Wall Portion

As shown in FIG. 1, the display layer 400 includes a wall portion (partition wall) 91 provided so as to surround the outer edge thereof, a space (dispersion liquid sealing space) 101 defined by the substrate 11, the substrate 12, and the wall portion 91, and the dispersion liquid 100 (electrophoresis dispersion liquid) filled into the space 101.

The surfaces of the wall portion 91 is preferably subjected to various water-repellent processes such as fluorocarbon plasma processing, as necessary. In so doing, as described later, the manufacturing of the display device 20 becomes simpler, and it is possible to obtain a display device 20 capable of exhibiting superior display characteristics and reliability.

The constituent material of the wall portion 91 is not particularly limited, and examples thereof include various thermoplastic resins or thermosetting resins, such as epoxy resins, acrylic resins, phenol resins, urea resins, melamine resins, polyesters (unsaturated polyesters), polyimides, silicone resins, and urethane resins, and these may be used singly or a mixture of two or more kinds may be used.

Although the height of the wall portion 91 is not particularly limited, it is preferable that the height be approximately 5 μm or more to 100 μm or less. By making the height of the wall portion 91 be within the range, it is possible for the electrophoretic particles 70 to be able to move within a short period of time according to the electric field, and to prevent the electrophoretic particles 70 to be visible in the non-display state.

Although the average width of the wall portion 91 is set, as appropriate, with reference to the mechanical strength requested of the wall portion 91, it is preferable that the width be approximately 1 μm or more and 10 μm or less. It is preferable that the aspect ratio (average height/average width) of the wall portion 91 be approximately 1 to 50.

In the embodiment, although the lateral cross-sectional shape of the wall portion 91 has a reverse tapered shape in which the width gradually reduces from the substrate 12 towards the substrate 11 side, there is no limitation to this shape, and, for example, a rectangular shape (rectangle) is also preferably used.

The cross-sectional shape of the wall portion 91 is not preferably fixed across the entirety thereof, and is preferably a shape that differs in parts. In this case, because the airtightness of the space 101 is lowered at this location, assuming bubbles are mixed into the space 101, it is possible for the bubbles to be discharged to the outside.

### Dispersion Liquid

The dispersion liquid 100 includes a dispersion medium 7, and electrophoretic particles 70 dispersed in the dispersion medium 7.

The electrophoretic particles 70 are positively or negatively charged, and exhibit a color different to the color exhibited by the dispersion medium 7.

Although the color exhibited by the electrophoretic particles 70 is not particularly limited if it is a color different to the color exhibited by the dispersion medium 7, in a case in which the color exhibited by the dispersion medium 7 is a light color or white, it is preferable that the color be a dark color or black, and, conversely, in a case in which the color exhibited by the dispersion medium 7 is a dark color or black, it is preferable that the color be a light color or white. In so doing, because the brightness difference between the electrophoretic particles 70 and the dispersion medium 7 becomes large in a case in which the electrophoretic particles 70 are locally collected, because the brightness difference between the region and the region neighboring thereto (region occupied by the dispersion medium 7) also becomes large, high contrast display is possible by controlling the collection region of the electrophoretic particles 70. The electrophoretic particles 70 are described in detail later.

It is preferable that a dispersion medium 7 having a boiling point of 100° C. or more and comparatively insulation properties be used. Examples of the dispersion medium 7 include various types of water (for example, distilled water, pure water, and the like), alcohols such as butanol and glycerin, cellosolves such as butyl cellosolve, esters such as butyl acetate, ketones such as dibutyl ketones, aliphatic hydrocarbons such as pentane (liquid paraffin), alicyclic hydrocarbons such as cyclohexane, aromatic hydrocarbons such as xylene, halogenated hydrocarbons such as methylene chloride, aromatic heterocycles such as pyridine, nitriles such as acetonitrile, amides such as N, N-dimethyl formamide, carboxylic acid salt, and silicone oil, or various other types of oil, and these may be used independently or as a mixture.

Among these, it is preferable that one having aliphatic hydrocarbons (liquid paraffin), or silicone oil as a main component be used as the dispersion medium 7. Since the dispersion medium 7 having liquid paraffin or silicone oil as a main component has a high aggregation suppression effect on the electrophoretic particles 70, it is possible suppress deterioration over time of the display characteristics of the display device 20. Liquid paraffin or silicone oil have excellent weather resistance because of not having unsaturated bonds, and have the further advantage of high safety.

It is preferable that a dispersion medium 7 with a relative dielectric constant of 1.5 or more and 3 or less be used, and more preferable that one with 1.7 or more and 2.8 or less be used. Such a dispersion medium 7 has excellent dispersibility of electrophoretic particles 70 that include a siloxane compound 72, described later, and has favorable electric insulation properties. Therefore, this contributes to realizing a display device 20 with a reduced power consumption and capable of high contrast display. The value of the dielectric constant is a value measured at 50 Hz, and a value measured for the dispersion medium 7 at a moisture amount contained at 50 ppm or less and a temperature of 25° C.

Above, although the configuration of the display device 20 was described, such a display device 20 is driven as follows. In the following description, description is made of a case of applying a voltage to one of the plurality of second electrodes 4 shown in FIG. 1. In the following description, the electrophoretic particles 70 are positively charged.

When a voltage that gives the second electrode 4 a negative potential is applied between the first electrode 3 and the second electrode 4, the electrical field generated by the voltage application acts on the electrophoretic particles 70 in the display layer 400. Thus, the electrophoretic particles 70 migrate and gather on the second electrode 4 side. In so doing, as shown in FIG. 3A, the color exhibited by the dispersion medium 7 is mainly displayed on the display surface 111.

Meanwhile, when a voltage that gives the second electrode 4 that is a positive potential is applied, the electrical field generated by the voltage application acts on the electrophoretic particles 70 in the display layer 400. Thus, the electrophoretic particles 70 migrate and gather on the first electrode 3 side. In so doing, as shown in FIG. 3B, the color exhibited by the electrophoretic particles 70 is mainly displayed on the display surface 111.

By performing driving of the electrophoretic particles 70 as above for each pixel (for each second electrode 4), it is possible to display a desired image on the display surface 111.

In this way, in the display device 20, the electrophoretic particles 70 migrate according to the orientation of the electric field, image display is performed according to the difference in chromaticity and brightness that arise thereby. In this case, in order to perform favorable image display, fast is necessary when the electrical field is generated, along with a plurality of electrophoretic particles 70 being stably present in the dispersion medium 7 without aggregating to one another. That is, there is demand for both dispersibility in the dispersion medium 7 (below, simply referred to as “dispersibility”) and charging characteristics to be achieved in the electrophoretic particles 70.

### Electrophoretic Particles

Below, the electrophoretic particles 70 included in the dispersion liquid 100 will be described in detail.

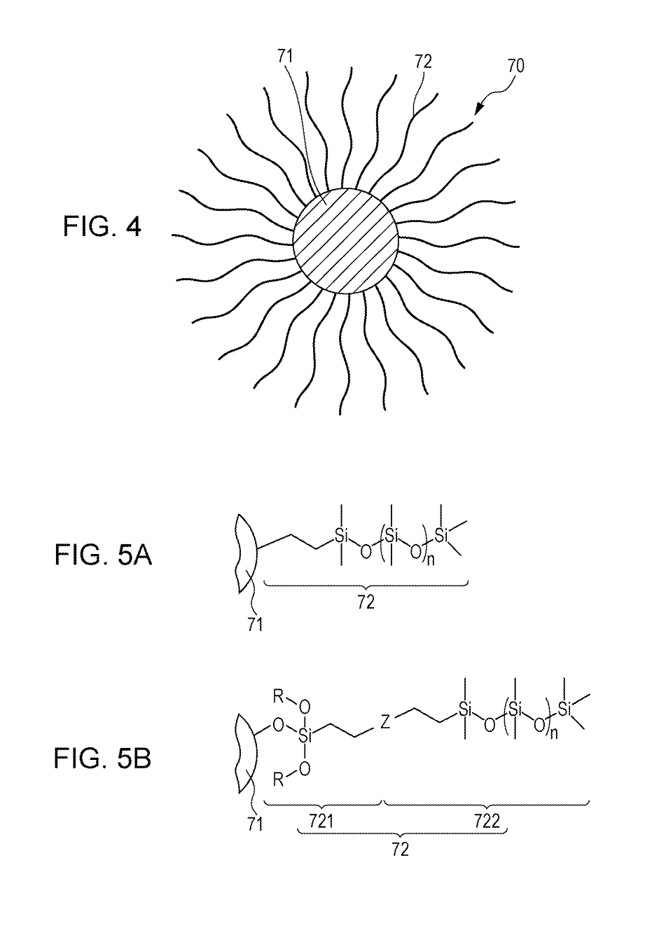

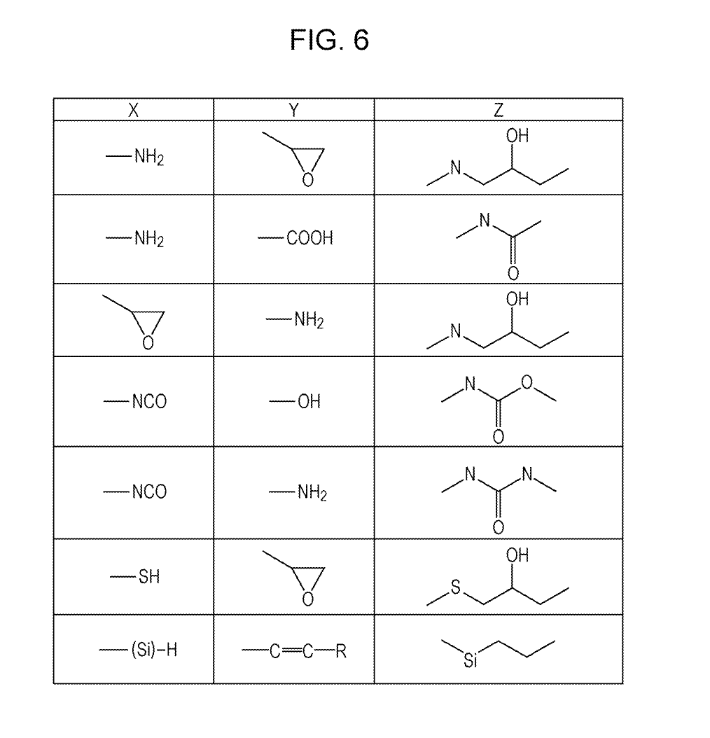

FIG. 4 is a cross-sectional view schematically showing the electrophoretic particles used in the display device shown in FIG. 1 and FIGS. 5A and 5B is a drawing for describing the siloxane compound bonded to the particle surface of the electrophoretic particles shown in FIG. 4. FIG. 6 is a drawing specifically showing the reactive functional group X included in the coupling agent and reactive functional group Y included in the modified silicone oil, for the coupling agent and the modified silicone oil used in obtaining the siloxane compound having the structure Z shown in FIGS. 5A and 5B.

As shown in FIG. 4, the electrophoretic particles 70 include a core particle 71 (particle), and a siloxane compound 72 bonded to the surface of the core particle 71.

Because such electrophoretic particles 70 are remarkably inhibited from approaching the other electrophoretic particles 70 due to the siloxane compound 72, appropriate dispersibility is provided in the dispersion medium 7. Since the siloxane compound 72 has a high affinity to the non-polar or low-polarity dispersion medium 7, it is possible for the dispersibility of the electrophoretic particles 70 in the dispersion medium 7 to be increased. Because the effect of the siloxane compound 72 increasing the dispersibility of the electrophoretic particles 70 in the dispersion medium 7 is high, it is possible to reduce the area of the surface of the core particles 71 covered by the siloxane compound 72. In other words, it is possible to increase the area of the region to which the siloxane compound 72 is not bonded in the surface of the core particles 71. Therefore, in this region, the charging properties of the core particles 71 themselves sufficiently arises, and a group having charging properties is introduced to the region, thereby it is possible for the charging properties of the electrophoretic particles 70 to be increased.

In light of this, it is possible for the electrophoretic particles 70 to exhibit excellent dispersibility and charging properties in the dispersion medium 7. Accordingly, the aggregation of the electrophoretic particles 70 to one another is suppressed by a fixed repulsive force occurring due to the siloxane compound 72, and because a fixed coulomb force is generated in the electrophoretic particles 70 by the charging properties of the core particles 71 themselves and the polarization group, along with thereby reducing the migration resistance of the electrophoretic particles 70, sufficient electrophoresis is possible under a weaker electric field as a result. As a result, it is possible to a display device with low power consumption and high responsiveness.

Because the dispersibility of the electrophoretic particles 70 is increased due to the siloxane compound 72 as described above, a dispersant is preferably not added at all to the dispersion medium 7. Therefore, it is possible to prevent lowering of the insulation properties between the first electrode 3 and the second electrode 4 arising in cases in which a large amount of dispersant is added. In so doing, the occurrence of a leak current during voltage application is suppressed, and it is possible to achieve a reduction in the power consumption of the display device 20.

A dispersant is preferably added to the dispersion medium 7, and, in this case, it is possible for the addition amount of the dispersant added to the dispersion medium 7 to be reduced, and to suppress the insulation properties between the first electrode 3 and the second electrode 4. Examples of the dispersant include, for example, polyamide amine and salts thereof, a basic functional group modified polyurethane, a basic functional group modified polyester, a basic functional group modified poly(meth)acrylate, a polyoxyethelyne alkylamine, an alkanolamine, and a polyacrylamide, and these may be used singly or a mixture of two or more types thereof may be used.

It is preferable that the addition amount of the dispersant be 0.3 wt % or less of the dispersion medium 7, and 0.1 wt % or less is more preferable. By suppressing the addition amount of the dispersant to be within the range, even if the dispersant is added, it is possible to lower of the insulation properties between the first electrode 3 and the second electrode 4 to be suppressed to the minimum limit.

Below, each portion that configures the electrophoretic particles 70 will be sequentially described in detail.

First, the core particles 71 are described.

The core particles 71 are not particularly limited, and examples thereof include oxide particles such as titanium oxide, zinc oxide, iron oxide, chromium oxide, and zirconium oxide, nitride particles such as silicon nitride, and titanium nitride, sulfide particles such as zinc sulfide, boride particles such as titanium boride, inorganic pigment particles such as strontium chromate, cobalt aluminate, copper chromite, and ultramarine, and organic pigment particles such as azo, quinacridone, anthraquinone, dioxazine, and perylene. It is also possible for composite particles in which a pigment is coated on the surface of resin particles configured by an acrylic resin, a urethane resin, a urea resin, an epoxy resin, a polystyrene, a polyester, or the like, to be used.

In a case of using a coupling agent as described later, taking the reactivity with the coupling agent into consideration, it is preferable that the core particles 71 have a hydroxyl group present in the surface, and, on this point, more preferable that an inorganic material be used.

It is preferable that the average particle diameter of the core particles 71, although not particularly limited, be approximately 10 nm or more to 800 nm or less and approximately 20 nm or more to 400 nm or less is more preferable. By setting the average particle diameter of the core particles 71 to be within the range, it is possible for both a sufficiently chromatic display due to the electrophoretic particles 70 and fast electrophoresis of the electrophoretic particles 70 to be achieved. As a result, it is possible for both a high contrast display and a high response speed to be achieved.

By setting the average particle diameter of the core particles 71 to be within the range, it is possible to suppress settling of the electrophoretic particles 70 and variations in the migration speed, and to suppress the occurrence of display unevenness and display defects.

The average particle diameter of the core particles 71 signifies the volume average particle diameter measured by a dynamic light diffusion type particle size distribution measurement device (for example, product name: LB-500, manufactured by Horiba, Ltd.).

In the embodiment, although a case of one type of core particle 71 being included in the dispersion liquid 100 is described, a plurality of types of core particles 71 is preferably included. In this case, by selecting a plurality of types of core particles 71 in a combination with large differences in brightness and chromaticity, such as black and white, or a light color and a dark color, a display with still superior contrast is possible. In a case of using a plurality of different types of core particles 71, the types or introduction amounts of the siloxane compound 72 may be the same or may be different between the plurality of different type of core particles 71.

Next, the siloxane compound 72 will be described.

Although the siloxane compound 72 is preferably any compound if that compound (compound that includes a polymer chain) includes a linking structure (below, referred to as “silicone main chain”) in which a plurality of siloxane bonds is linked in series, it is preferable that a compound having a straight chain molecular structure configured by a main chain that includes the linking structure and a side change bonded to the straight chain. If such a compound is used, the long chain molecular structure of the siloxane compound 72 is comparatively stably maintained, and since it is possible to sufficiently form the separation distance between core particles 71 spaced with the siloxane compound 72, the function of the siloxane compound 72 of providing dispersibility to the electrophoretic particles 70 is still further promoted.

A compound with a comparatively weak polarity (non-polar or low polarity) is often used in the dispersion medium 7. Meanwhile, compound that includes a siloxane bond, depending on the structure frequently have a comparatively low polarity. Accordingly, the electrophoretic particles 70 that include such a siloxane compound 72 show exhibit favorable dispersibility with respect to the dispersion medium 7.

It is preferable that the siloxane compound 72 include a structure derived from silicone oil having a silicone main chain or a modified material thereof (below, simply referred to as a “silicone oil-derived structure”). Since the silicone oil or a modified material thereof is often used as the dispersion medium 7, the dispersibility of the electrophoretic particles 70 is particularly increased by the siloxane compound 72 including a structure derived therefrom.

Such a silicone oil-derived structure is preferably directly linked to the surface of the core particles 71, as shown in FIG. 5A, and, is preferably linked to the surface of the core particles 71 via a coupling agent-derived structure, as shown in FIG. 5B.

When more specifically described, the siloxane compound 72 of the example shown in FIG. 5A is obtained by a silicone oil-derived functional group and a hydroxyl group of the surface of the core particles 71 being reacted. The siloxane compound 72 of the example is configured only with the silicone oil-derived structure, and the hydrocarbon structure bonded to the terminal end of the main chain (silicone main chain) configured by the siloxane bonds is linked to the core particles 71. Accordingly, because the silicone oil-derived structure accounts for the majority of the siloxane compound 72, for example, the dispersibility of the electrophoretic particles 70 is particularly increased when the silicone oil or modified materials thereof is used as the dispersion medium 7.

Meanwhile, the siloxane compound 72 of the example shown in FIG. 5B is obtained by modified silicone oil and a coupling agent being reacted, and the coupling agent-derived hydrolysable group from the obtained reactants and the hydroxyl group of the surface of the core particles 71 being dehydration-compression reacted. The siloxane compound 72 of the example is configured by a silicone oil-derived structure and a coupling agent-derived structure, and the silicone oil-derived structure 722 is linked to the core particles 71 via the coupling agent-derived structure 721. Regardless of whether the siloxane compound 72 with such a structure includes the long chain and straight chain molecular structure, control of the bonding amount with respect to core particles 71 is easy, and, as a result, it is possible to realize electrophoretic particles 70 that include a siloxane compound 72 strictly controlled to an amount that is a target. In other words the siloxane compound 72 that includes a long chain and straight chain molecular structure is able to go through a process of sufficiently ensuring a reaction opportunity between the modified silicone oil and the coupling agent by in advance by intermediating between the silicone oil-derived structure 722 and the core particles 71 with the structure of the coupling agent derivative 721, in contrast to the numerous difficulties that accompany accurately introducing an amount that is a target with respect to the core particles 71. Therefore, it is possible for the magnitude of the reactivity of the coupling agent to be effectively utilized with respect to the core particles 71, and it is possible to precisely control the introduction amount of the siloxane compound 72, as a result.

It is preferable that weight average molecular weight of the siloxane compound 72 be approximately 1000 or more and 100,000 or less, and approximately 10000 or more and 60000 or less is more preferable. By setting the weight average molecular weight to be within the range, the length of the molecular structure of the siloxane compound 72 is optimized, and electrophoretic particles 70 to which dispersibility is sufficiently provided derived from the long chain and straight chain structure are obtained, while sufficiently securing a region able to exhibit charging properties of the core particles 71 themselves and introduce the polarization group to the surface of the core particles 71.

The weight average molecular weight of the siloxane compound 72 is a polystyrene-converted average molecular weight which is measured using gel permeation chromatography (GPC).

It is preferable that n in FIGS. 5A and 5B be approximately 12 or more and 1400 or less for the same reasons as the weight average molecular weights each described above, and approximately 130 or more and 800 or less is more preferable.

The structure Z in FIG. 5B is a structure in which the reactive functional group X included in the coupling agent and the reactive functional group Y included in the silicone oil are reacted.

Examples of the reactive functional groups X and Y are shown in FIG. 6. R in FIG. 6 is an aliphatic hydrocarbon group, such as an alkyl group.

It is preferable that the terminal end and the side chain of the siloxane compound 72 be configured by a substituent with a low polarity. In so doing, it is possible to increase the dispersibility of the electrophoretic particles 70. Specific examples of the substituent include, for example, an alkyl group.

It is preferable that the occupancy ratio (coverage) of the region to which the siloxane compound 72 in the surface of the core particles 71 is bonded be 0.05% or more and 20% or less, 0.1% or more and 10% or less is more preferable, and 0.2% or more and 5% or less is still more preferable. By setting the occupancy ratio of the region to be within the range, it is possible for both the dispersibility caused mainly by the siloxane compound 72 and the charging characteristics caused mainly by the surface of the core particles 71 or the group introduced to the surface thereof to be further strengthened. That is, it is possible to achieve both dispersibility and charging characteristics to be achieved even in an environment in which the temperature at which the dispersion liquid 100 is left changes greatly, or an environment in which the strength of the electric field is low.

In a case in which the occupancy ratio of the region drops below the lower limit value, the dispersibility is lowered, and there is concern of the electrophoretic particles 70 aggregating according to the environment in which the dispersion liquid 100 is left. Meanwhile, in a case in which the occupancy ratio of the region goes over the upper limit value, it becomes difficult for the charging characteristics of the core particles 71 themselves to be exhibited and to introduce another group to the surface of the core particles 71 according to the type method of manufacturing the electrophoretic particles 70.

Here the occupancy ratio (coverage) [%] of the region to which the siloxane compound 72 is bonded on the surface of the core particles 71 is obtained by the following formula when the area occupied for each molecule of the siloxane compound 72 bonded to the surface of the core particles 71 is the “unit area” and the number of molecules of the siloxane compound 72 bonded to the surface of the core particles 71 is the “molecule number”.

Occupancy ratio (coverage)=(unit area X molecule number)/(surface area of core particle)×100

It is possible for the “unit area” to be obtained from the molecular structure of the siloxane compound 72 through a calculation.

It is possible to obtain the “molecule number” from the mass [g] of the siloxane compound 72 bonded per core particle 71, the molecular weight [g/mol] of the siloxane compound 72, and the number of molecules 6.02×1023 [units/mol] per mol through a calculation.

According to the dispersion liquid 100 including the electrophoretic particles 70 as described above, it is possible to lower the conductivity while realizing excellent dispersibility of the electrophoretic particles 70.

According to the display sheet 21 and the display device 20 in which such a dispersion liquid 100 is used, a high contrast display is possible.

### Second Embodiment

Next, description will be given of a second embodiment of the display device of the invention.

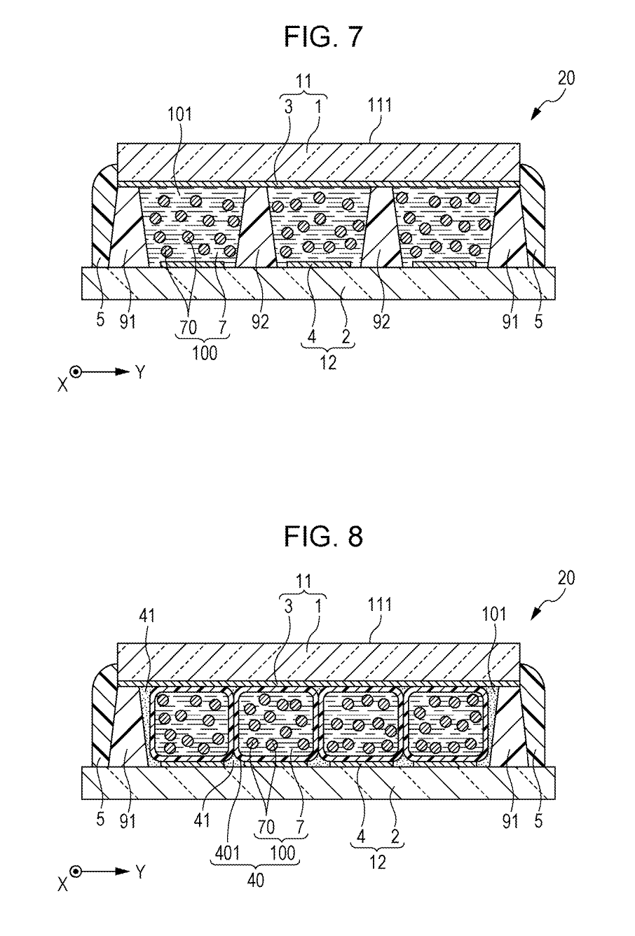

FIG. 7 is a cross-sectional view showing a second embodiment of a display device of the invention. In the following description, for convenience of description, the upper side in FIG. 7 as described as “up” and the lower side as “down”.

Below, although the second embodiment is described, the description will focus on the points of difference with the first embodiment and description of similar matters will not be made. Where the configuration is the same as the first embodiment described above, the same reference numerals are used.

The display device 20 according to the second embodiment is the same as the display device 20 according to the first embodiment, other than further including a wall portion 92 that divides the space 101 on the inside of the wall portion 91 into a plurality of segments.

That is, in the display layer 400, a plurality of wall portions 92 is provided in the Y direction spaced by a predetermined gap. Although not shown, in the display layer 400, a plurality of wall portions is provided in the X direction spaced by a predetermined gap. In so doing, pixels segments partitioned in a matrix-form are formed in the space 101.

Each pixel segment is arranged corresponding to a second electrode 4. Therefore, by controlling, as appropriate, the voltage applied to the second electrode 4, it is possible to control the color emitted by each pixel segment, and to freely generate an image visible from the display surface 111.

Although such a wall portion 92 has the same structure as the above-described wall portion 91, the average width is preferably smaller than the wall portion 91. In so doing, it is possible to increase the aperture ratio of the pixel.

Even in such a second embodiment, it is possible to obtain the same actions and effects as that of the first embodiment.

### Third Embodiment

Next, the third embodiment of the display device of the invention will be described.

FIG. 8 is a cross-sectional view showing the third embodiment of a display device of the invention. In the following description, for convenience of description, the upper side in FIG. 8 is described as “up” and the lower side as “down”.

Below, although the third embodiment will be described, the description will focus on the points of difference with the above-described first and second embodiments, and description of the similar matters will not be made. Where the configuration is the same as the first embodiment described above, the same reference numerals are used.

The display device 20 according to the embodiment is the same as the first embodiment, other than including microcapsules 40 in which the dispersion liquid 100 is sealed ins a capsule main body (shell body) 401.

That is, the display device 20 according to the embodiment is configured by a plurality of microcapsules 40 in which the dispersion liquid 100 is sealed in the capsule main body 401 being fixed (held) in the space 101 by a binder 41.

The microcapsules 40 are lined up in a single layer (one at a time without overlapping in the thickness direction) between each substrate 11 and 12 so as to spread in the X direction and the Y direction.

Examples of the constituent materials of the capsule main body (shell body) 401 include, for example, gelatin, composite materials of Gum Arabic and gelatin, and various resin materials such as urethane resins, melamine resins, urea resins, epoxy resins, phenolic resins, acrylic resins, urethane resins, olefin resins, polyamides and polyethers, and these may be used singly or a combination of two or more types thereof may be used.

The capsule main body 401 is preferably configured by layered body of a plurality of layers. In this case, it is preferable that a melamine resin, an amino resin such as a urea resin, or a combined resin thereof be used as the constituent material of the innermost layer. Meanwhile, it is preferable that an epoxy resin be used as the constituent material of the outermost layer.

The constituent material of the capsule main body 401 preferably forms a cross-link (three-dimensional cross-link) due to a cross-linking agent. In so doing, it is possible for the strength of the capsule main body 401 to be improved, while maintaining the flexibility. As a result, it is possible to prevent the microcapsules 40 from being easily destroyed.

It is preferable that such microcapsules 40 have an approximately uniform size. In so doing, in the display device 20, it is possible for the occurrence of display unevenness to be prevented or reduced, and to exhibit still superior display capacity.

It is preferable that microcapsules 40 be present in a spherical shape. In so doing, the microcapsules 40 have excellent pressure resistance and bleed-out resistance. Accordingly, when the display device 20 is operated in this way, or when the display device 20 is stored, even in cases of the display device 20 being subjected to impact or pressure to the display surface 111, breakdown of the microcapsules 40 or dissipation of the dispersion liquid 100 is prevented, and stable operation over the long term is possible.

It is preferable that average particle diameter of the microcapsules 40 be approximately 5 μm or more and 50 μm or less, and approximately 10 μm or more and 30 μm or less is more preferable. By making the average particle diameter of the microcapsules 40 to be within the range, it is possible to reliably control the electrophoresis of the electrophoretic particles 70 in the display device 20. That is, even if a pulse-like electrical field acts on the electrophoretic particles 70, it is possible for electrophoresis to be reliably performed up to the end portions in the microcapsules 40. As a result, it is possible to increase the contrast of the display.

The binder 41 is supplied, for example, with the purpose of binding the substrate 11 and 12 together, the purpose of fixing the microcapsule 40 between the substrates 11 and 12, the purpose of securing the insulation properties between the first electrode 3 and the second electrode 4, or the like. In so doing, it is possible for the durability and reliability of the display device 20 to be further improved.

A resin material with excellent affinity (adhesiveness) with the substrates 11 and 12, and the capsule main body 401 (microcapsule 40), and with excellent insulation properties (a resin material with insulation properties or in which only a very small current flows) is suitably used as the binder 41.

Examples of the binder 41 include various types of resin, such as thermoplastic resins such as polyethylenes, polypropylenes, ABS resins, methacrylic acid ester resins, methacrylic acid methyl resins, vinyl chloride resins, and cellulose resins, and silicone resins and urethane resins, and these may be used singly or a combination of two or more types thereof may be used.

The display device 20 according to the embodiment as above, exhibits the same actions and effects as the first and second embodiments described above.

### Method of Manufacturing Electrophoresis Dispersion Liquid

Next, the method of manufacturing the electrophoresis dispersion liquid will be described. Below, a case of manufacturing the above-described dispersion liquid 100 will be described as an example.

### First Embodiment of Method of Manufacturing Electrophoresis Dispersion Liquid

Firstly, a first embodiment of the method of manufacturing an electrophoresis dispersion liquid of the invention will be described.

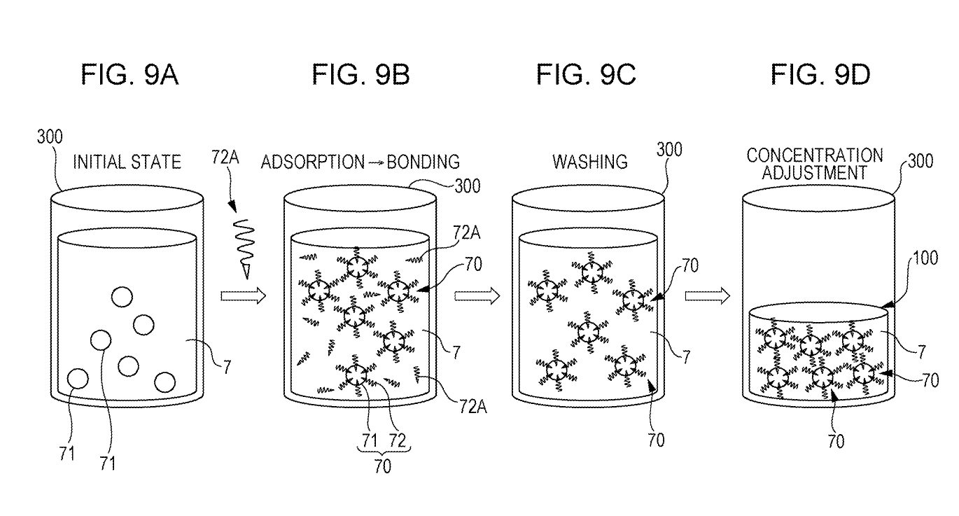

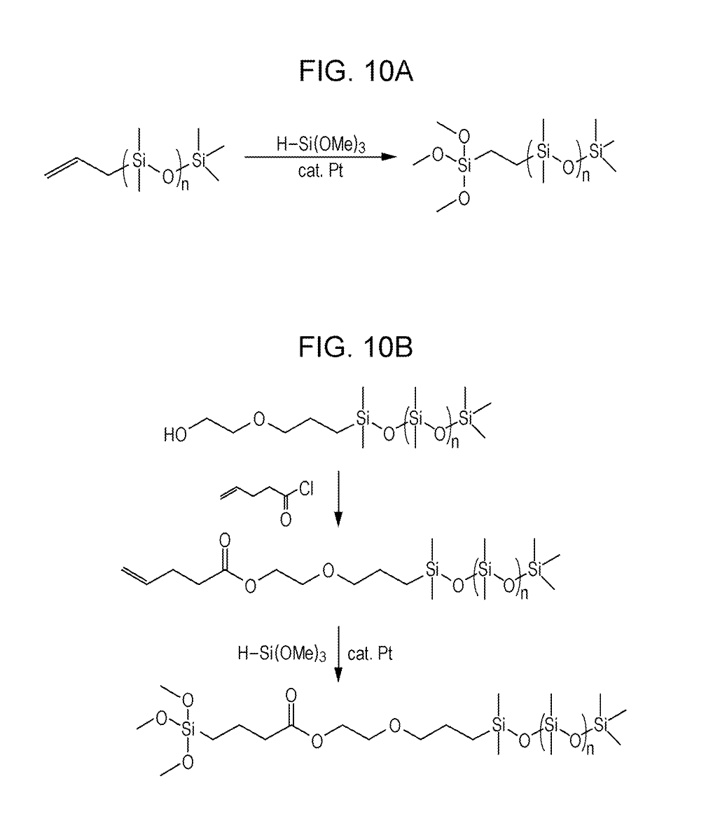

FIGS. 9A to 9D are diagrams for describing the a first embodiment of the method of manufacturing an electrophoresis dispersion liquid of the invention, and FIGS. 10A and 10B are diagrams for describing an example of method of manufacturing a precursor of a siloxane compound bonded to the surface of the particles.

The method of manufacturing the dispersion liquid 100 shown in FIGS. 9A to 9D includes [1] a step for bonding the siloxane compound 72 to the surface of the core particles 71 in the dispersion medium 7, [2] a step for removing the precursor 72A of the siloxane compound not bonded to the core particles 71.

Below, each step will be sequentially described in detail.

### [1] Bonding Step

1-1

First, the core particles 71 are dispersed in the dispersion medium 7 in a container 300, as shown in FIG. 9A.

The dispersion medium 7 functions as a liquid medium used as a reaction medium in step 1-2 described later.

By the liquid medium being the dispersion medium 7, it becomes unnecessary to substitute the liquid medium with the final dispersion medium 7, and it is possible to comparatively simply prevent or suppress involuntary liquids being mixed in the dispersion medium 7 of the electrophoresis dispersion liquid 100 finally obtained. Because it becomes unnecessary to substitute the liquid medium with the final dispersion medium 7, it is possible to simplify the removing step [2], described later.

In the embodiment, the viscosity (kinematic viscosity at 25° C.) of the dispersion medium 7 is determined in advance according to the type or the like of the core particle 71 or the type or the like of the siloxane compound 72, and, although not particularly limited, 0.5 mm²/s or more and 20 mm²/s or lower is preferable. In so doing, it is possible for the dispersibility of the core particles 71 with respect to dispersion medium 7 even if not bonded with the siloxane compound 72 while having excellent responsiveness of the electrophoretic particles 70 in the dispersion medium 100 finally obtained.

Another solvent is preferably included in the liquid medium in addition to the dispersion medium 7, and for example, the liquid medium is preferably a two-phase based solvent. Whether the liquid medium is a single phase-based solvent or a two phase-based solvent of the dispersion medium 7 is preferably selected according to the type of the core particles 71 or the type of modifier (compound that includes a polymer chain) bonded to the particle surface. For example, in a case in which the number average molecular weight of the polystyrene conversion of the modifier bonded to the surface of the core particles is less than 40,000, or a case in which the viscosity is less than 2000 mm²/s, it is preferable that the liquid medium be as single phase-based solvent of the dispersion medium 7. In a case in which the molecular weight of the modifier bonded to the surface of the core particles is 40,000 or more or a case in which the viscosity is 2,000 mm²/s or more, it is preferable that a minute amount of a polar solvent be added with respect to the overall weight of the liquid medium. It is preferable that water be added as the polar solvent, it is preferable that the content amount occupied in the overall liquid medium of the polar solvent added be 0.01 wt % or more and 0.1 wt % or less, and 0.02 wt % or more and 0.1 wt % or less is more preferable. In so doing, it is possible to prevent unnecessary liquid from being mixed into the dispersion medium 7 of the electrophoresis dispersion liquid 100 finally obtained, and for the characteristics of the electrophoresis dispersion liquid 100 to be excellent. When the amount of water (polar solvent) added is excessive, the modifier may react with itself, and there are cases in which the dispersibility of the core particles 71 is lowered.

From this viewpoint, even in a case in which other solvents of the dispersion medium 7 are included in the liquid medium, it is preferable that the content amount of the solvent in the liquid medium be 0.1 wt % or less, and 0.01 wt % or less is more preferable. The wording “the liquid medium is a single phase-based solvent of the dispersion medium” in the specification includes a state in which a plurality of types of solvent with similar polarities are mixed together without excessive phase separation or suspension occurring. “Two phase-based” refers to a state in which the plurality of types of solvent are in a state of phase separation or suspension.

It is preferable that the usage amount of the liquid medium (dispersion medium 7 in the embodiment) with respect to the addition amount of the core particles 71 in this step be 3 times or more and 80 times or less, and 5 times or more and 60 times or less is more preferable. In a case in which the particle diameter (number average particle diameter) of the core particles 71 is 50 nm or more and 150 nm or less, 15 times or more and 60 times or less with respect to the addition amount of the core particles 71 is more preferable. In so doing, it is possible to favorably maintain the reaction opportunity between the core particles 71 and the precursor 72A in the step 1-2, described later, and to increase the dispersibility of the core particles 71 and the precursor 72A in the liquid medium.

1-2

Next, as shown in FIG. 9B, the precursor 72A of the siloxane compound 72 is added. In the dispersion medium 7, by the precursor 72A and the surface of the core particles 71 being reacted, the siloxane compound 72 is chemically bonded to the surface of the core particles 71.

The precursor 72A is a coupling agent that includes the structure of the siloxane compound 72, and is obtained by a siloxane bond-containing substance and a coupling agent being reacted. The reaction is between a reactive functional group included in the siloxane bond-containing substance and a reactive functional group included in the coupling agent. In so doing, the siloxane bond-containing substance is modified by the coupling agent, and the coupling agent-derived hydrolysable group is positioned on one terminal end of the obtained reactant.

It is possible for the reaction of the siloxane bond-containing substance and the coupling agent to be performed by adding a sufficient amount of the coupling agent that includes a reactive functional group with respect to the siloxane bond-containing substance that includes a reactive functional group. In so doing, it is possible for the reaction probability between the siloxane bond-containing substance and the coupling agent to be improved, and for the yield of the reactant to be particularly improved.

Although examples of the siloxane bond-containing substance include silicone oil, organopolysiloxane, or modified materials thereof, it is particularly preferable that a modified material of silicone oil be used.

Any modified silicone oil is preferably used if it includes a reactive functional group such as an amino group, an epoxy group, a carboxyl group, a hydroxyl group, a mercapto group, an isocyanate group, a carbinol group, and an acid chloride. Specifically, examples thereof include an amino-modified silicone oil, an epoxy-modified silicone oil, a carboxyl-modified silicone oil, and a carbinol-modified silicone oil.

The silicone oil preferably includes two or more types from the above-described reactive functional groups.

Meanwhile, any coupling agent is preferably used if it includes a reactive functional group such as an amino group, an epoxy group, a sulfide group, a vinyl group, an acryloxy group, a methacryloxy group, and a mercapto group. Specifically, examples thereof include a silane coupling agent and a titanium coupling agent.

The coupling agent preferably includes two or more types from the above-described reactive functional groups.

It is preferable that the addition amount of the coupling agent be set to an amount that includes one equivalent or more of the reactive functional group with respect to the reactive functional group in the siloxane bond-containing substance, and being set to an amount including 1.5 equivalents or more of the reactive functional group is more preferable.

FIGS. 10A and 10B show an example of the reaction formula showing the reaction pathway of the modified silicone oil and the silane coupling agent.

The reaction shown in FIG. 10A is a reaction known as hydrosilylation in which an Si—H bond is added to an organic double bond, such as C═C. A metal complex or the like from groups 8 to 10 of the periodic table is used, and it is particularly preferable that platinum or a compound thereof be used.

As necessary, as shown in FIG. 10B, first, a linking portion is reacted with the modified silicone oil, and thereafter, the coupling agent is further reacted with respect to the obtained reactant, and a reactant is preferably finally obtained. At this time, it is possible to use 10-undecenoyl chloride, 10-undecenic acid, and 4-pentenic acid, in addition to 4-pentenoyl chloride shown in FIG. 10B. By using such a method, it is possible to more finely tune the molecular weight of the siloxane compound 72 and the hydrophobic and hydrophilic balance.

It is possible to perform the reaction in conditions of a temperature of 0° C. or higher and 70° C. or lower, and time of 30 min or more and 6 hours or less, in a case of using a chloride.

The coupling agent-derived hydrolysable group in the reactant and the functional group of the surface of the core particles 71 are reacted by adding the precursor 72A that is the reactant obtained as above to the dispersion medium 7 in which the core particles 71 are dispersed. As a result, it is possible to introduce the siloxane compound 72 to the surface of the core particles 71. That is, the electrophoretic particles 70 are obtained.

When adding the precursor 72A, the precursor 72A is preferably added in a solution state of being dissolved in a solvent different to the dispersion medium 7. In this case, it is preferable that the concentration of the precursor 72A in the solution be 5 wt % or more, 10 wt % or more is more preferable, 20 wt % or more is still more preferable, and 40 wt % or more is still more preferable. When the precursor 72A is reacted with the functional group of the surface of the core particles 71, it is preferable that 8 wt % or more and 50 wt % or less of the precursor 72A be added with respect to the weight of the core particles 71, and more preferable that 8 wt % or more and 40 wt % or less be added. In so doing, electrophoretic particles 70 with still superior dispersibility are obtained.

From the viewpoint of reliably performing the reaction of the precursor 72A and the surface of the core particles 71, that is, from the viewpoint of chemical bonding between the siloxane compound 72 and the core particles 71 occurring, it is preferable that reaction temperature of the reaction be 100° C. or higher and 200° C. or lower, and 120° C. or higher and 180° C. or lower is more preferable, and further it is preferable that the reaction time of the reaction be 1 hour or more and 10 hours or less, and 2 hours or more and 8 hours or less is more preferable. In contrast, when the reaction temperature is too low or the reaction time is too short, there are cases in which the chemical bonding of the siloxane compound 72 and the core particles 71 is insufficient according to the type of precursor 72A and the core particles 71, whereas when the reaction temperature is too high or the reaction time is too long, an increased effect of performing the reaction of the precursor 72A and the surface of the core particles 71 is not obtained and there is concern of not only the waste increasing, but also of the siloxane compound 72 bonded to the core particles 71 being damaged according to the type of siloxane compound 72.

According to the method of introducing the siloxane compound 72 to the surface of the core particles 71 as above, after obtaining the reactant by reacting the siloxane bond-containing substance with the coupling agent in advance, since a process of reacting the reactant with the surface of the core particles 71 is passed through, as described above, it is possible to increase the reaction probability because it is possible to sufficiently ensure the reaction chance between the siloxane bond-containing substance and the coupling agent when generating the reactant, and it is possible to increase the reaction chance. As a result, it is possible for the yield of the reactant to be increased.

In contrast, in a case in which, after the coupling agent is introduced to the core particles and modified, the siloxane bond-containing substance is added thereto and a process of reacting the siloxane bond-containing substance and the coupling agent is passed through, it is difficult to control the reaction frequency of the reactive functional group of the coupling agent introduced to the core particles and the reactive functional group of the siloxane bond-containing substance, and, therefore, it becomes difficult to strictly adjust the introduction amount of the siloxane compound 72. In particular, because the siloxane bond-containing substance has a straight chain molecular structure as a long chain, the reactive functional group has a tendency toward the probability of reacting with another functional group becoming lower, in order to supplement the lowering of the probability, it is necessary to add as much coupling agent as possible in advance with respect to the core particles. As a result, the charging characteristics derived from the core particles cancel each other out through large amounts of the coupling agent. Accordingly, if the siloxane compound is only introduced, it is difficult to sufficiently achieve both the dispersibility and the charging characteristics.

Meanwhile, in the embodiment, by reliably reacting the siloxane bond-containing substance and the coupling agent in advance, the introduction amount of the obtained reactant is easily controlled with respect to the core particles 71. It is thought that one cause is because the coupling agent-derived hydrolysable group is multi-functional, the reaction probability with the surface of the core particles 71 easily increases, and, furthermore, the amount of the siloxane compound 72 introduced to the core particles 71 is easily strictly adjusted by reacting the reactant in an amount according to the amount of the siloxane compound 72 to be reacted with respect to the surface of the core particles 71.

In the bonding step [1], because the siloxane compound 72 is chemically bonded to the surface of the core particles 71, the bond between the siloxane compound 72 and the surface of the core particles 71 is strongly fixed, and it is possible to prevent the siloxane compound 72 from separating from the surface of the core particles 71 in the removing step [2], described later. As a result, it is possible to effectively reduce the conductivity of the dispersion liquid obtained in the removing step [2] and the conductivity of the electrophoresis dispersion liquid 100 finally obtained while realizing the dispersibility (dispersibility of the electrophoretic particles 70) of the core particles 71 obtained after the removing step [2].

### [2] Removal Step

2-1

Next, the precursor 72A not bonded to the core particles 71 is removed. In so doing, as shown in FIG. 9C, it is possible to attain a state in which the electrophoretic particles 70 are dispersed in the dispersion medium 7, without excess precursor 72A being present. Concentration adjustment is performed as necessary, and, as shown in FIG. 9D, the dispersion liquid 100 is obtained. In so doing, it is possible to reduce the excess precursor 72A remaining in the obtained dispersion liquid 100. As a result, it is possible to reduce the conductivity of the dispersion liquid 100 finally obtained.

As the method for removing the precursor 72A in the removing step [2], although not particularly limited, it is preferable that removing step [2] be performed while maintaining a state (state of contact between the core particles 71 and the dispersion medium 7) in which core particles 71 to which the siloxane compound 72 is bonded are present in the dispersion medium 7 without drying and hardening. In so doing, in the removing step [2], it is possible for damage to or aggregation of the core particles 71 to which the siloxane compound 72 is bonded to be effectively suppressed. In the specification, the wording “the core particles 71 are not dried and hardened” indicates maintaining a state in which the modifier bonded to the core particles 71 is dispersed in the dispersion medium 7. If the volume of the dispersion medium 7 included in the system is 50% or more of the volume of the core particles 71, it is possible to maintain a state in which the modifier bonded to the core particles 71 is dispersed in the dispersion medium 7. Thus, in the method of manufacturing an electrophoresis dispersion liquid of the invention, it is preferable that the volume of the dispersion medium 7 be managed so as to not drop below 50% of the volume of the core particles 71.

Specifically, it is preferable that removing step [2] include a step for washing the core particles 71 to which the siloxane compound 72 is bonded using a new dispersion medium 7. In so doing, in the removing step [2], it is possible to comparatively simply maintain the state which the dispersion medium 7 is present with the core particles 71 to which the siloxane compound 72 is bonded without drying and hardening. It is possible to effectively reduce unnecessary components mixed into the dispersion medium 7 of the dispersion liquid 100 finally obtained.

Examples of the washing method, although not particularly limited, include a method using a filter and a method using centrifugation. A solvent different to the dispersion medium 7 is preferably used as the washing solvent. In this case, after washing using the washing solvent different to the dispersion medium 7, washing is performed using the dispersion medium 7, and the washing solvent is preferably substituted with the dispersion medium 7. In this case, it is preferable that a washing solvent having the same characteristics (in particular, electrical characteristics) as the dispersion medium 7.

It is preferable that washing be repeated a plurality of times. In so doing, it is possible to more reliably prevent excess precursor 72A from remaining. For example, it is preferable that the washing be repeated until the volume resistivity of the dispersion liquid obtained after the removing step [2] is 1011 Ω·cm or more.

By the volume resistivity of the dispersion liquid obtained after the removing step [2] being 1011 Ω·cm or more, it is possible to make the volume resistivity of the dispersion liquid 100 finally obtained 1011 Ω·cm or more.

It is preferable that the removing step [2] be performed in temperature conditions of less than the boiling point of the dispersion medium 7. In so doing, in the removing step [2], it is possible to comparatively simply maintain the state which the dispersion medium 7 is present with the core particles 71 to which the siloxane compound 72 is bonded without drying and hardening. From the same viewpoint, it is preferable that the removing step [2] be performed at atmospheric pressure or a higher pressure, and, in particular, from the viewpoint of simplifying the facilities, performing at atmospheric pressure is preferable.

As described above, it is possible to obtain the dispersion liquid 100.

### Second Embodiment of Method of Manufacturing Electrophoresis Dispersion Liquid

Next, the second embodiment of the method of manufacturing an electrophoresis dispersion liquid of the invention will be described.

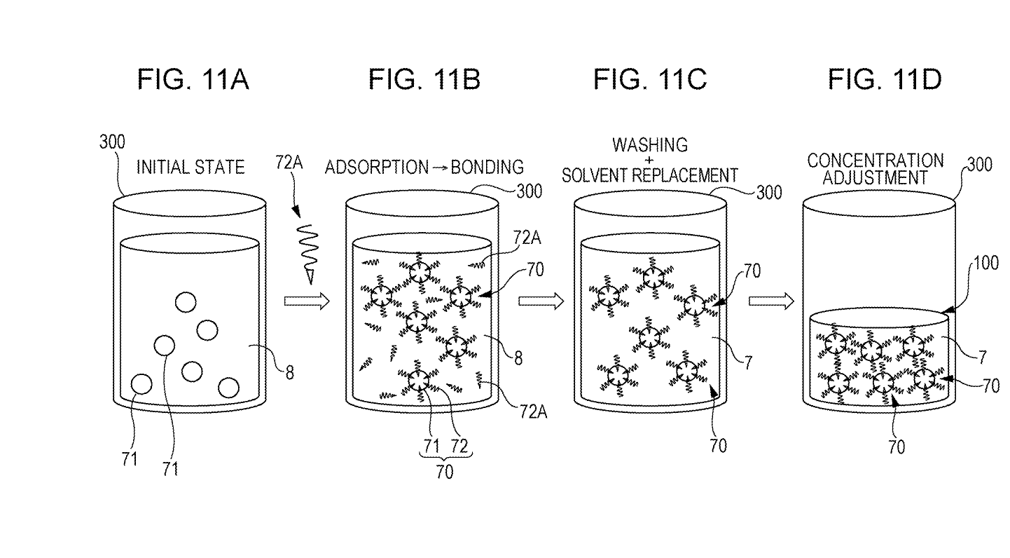

FIGS. 11A to 11D are diagrams for describing the second embodiment of the method of manufacturing an electrophoresis dispersion liquid of the invention.

In the description below, description will be given focusing on the points of difference with the above-described embodiment and description of the points of similarity will not be made.

The embodiment is the same as the above-described embodiment, other than using a solvent different to the dispersion medium 7 as the reaction solvent in the bonding step.

The method of manufacturing the dispersion liquid 100 shown in FIGS. 11A to 11D includes [1A] a bonding step for bonding the siloxane compound 72 to the surface of the core particles 71 in the dispersion medium 8, [2A] a removing step for removing the precursor 72A of the siloxane compound not bonded to the core particles 71.

### [1A] Bonding Step

### 1A-1

First, the core particles 71 are dispersed in the dispersion medium 8 in a container 300, as shown in FIG. 11A.

The liquid medium 8 is different to the final dispersion medium 7, and has compatibility with the dispersion medium 7.

Although the liquid medium 8 is used as the reaction solvent in step 1A-2 described later, the medium is substituted with the dispersion medium 7 in the removing step [2A], described later.

By using the liquid medium 8 different to the dispersion medium 7 in this way, it is possible to select, as appropriate, a liquid medium 8 with different type (in particular, viscosity) to the dispersion medium 7 of the dispersion liquid 100 finally obtained. Therefore, in the bonding step [1A], even without the separate use of an additive such as a dispersant, it is possible to increase the dispersibility of the core particles 71 to which the siloxane compound 72 is not bonded in the liquid medium 8. As a result, in the bonding step [1A], it is possible to effectively perform a reaction of the precursor 72A and the surface of the core particles 71.

It is preferable that a liquid having similar characteristics to the dispersion medium 7 be used as the liquid medium 8, and specifically, it is preferable to have the same comparatively high insulation properties as the above-described dispersion medium 7, and it is more preferable that one having aliphatic hydrocarbons (liquid paraffin), or silicone oil as a main component be used.

It is preferable that the liquid medium 8 have a higher viscosity than the dispersion medium 7. In so doing, while using a liquid medium 8 with chemical characteristics close to the dispersion medium 7, in the bonding step [1A], it is possible to increase the dispersibility of the core particles 71 to which the siloxane compound 72 is not bonded in the liquid medium 8. From such a viewpoint, it is preferable that the liquid medium 8 be the same type of liquid with a higher viscosity than the dispersion medium 7. For example, in a case in which the dispersion medium 7 is a silicone oil, it is preferable that silicone oil with a higher viscosity than the dispersion medium 7 be used as the liquid medium 8.

The viscosity (kinematic viscosity at 25° C.) of the specific liquid medium 8 is determined in advance according to the type or the like of the core particles 71 or the type or the like of the liquid medium 8, and, although not particularly limited, 0.5 mm²/s or more and 100 mm²/s or lower is preferable. In particular, in a case in which the affinity between the core particles 71 to which the siloxane compound is not bonded and the liquid medium 8 is comparatively low, it is preferable that the viscosity of the liquid medium 8 be 10 mm²/s or more and 100 mm²/s or less, and 20 mm²/s or more and 100 mm²/s or less is more preferable, whereas, in a case in which the affinity between the core particles 71 to which the siloxane compound is not bonded and the liquid medium 8 is comparatively high, it is preferable that the viscosity of the liquid medium 8 be 0.5 mm²/s or more and 100 mm²/s or less, and 0.5 mm²/s or more and 10 mm²/s or less is more preferable. In so doing, it is possible to increase the dispersibility of the core particles 71 with respect to the liquid medium 8 even without bonding with the siloxane compound 72.

It is preferable that the liquid medium 8 have a lower boiling point than the dispersion medium 7. In so doing, in the removing step [2A] described later, it is possible to easily remove the liquid medium 8 using the difference in boiling point with the dispersion medium 7, in other words, it is possible to easily substitute the liquid medium 8 with the dispersion medium 7.

Such a method is particularly effective in a case in which the core particles 71 easily precipitate. For example, in a case in which the particle diameter of the core particles 71 is 250 nm or more and 350 nm or less, it is more preferable that the manufacturing method in the embodiment be used.

### 1A-2

Next, as shown in FIG. 11B, the precursor 72A of the siloxane compound 72 is added. By the precursor 72A and the surface of the core particles 71 being reacted in the dispersion medium 8, the siloxane compound 72 is chemically bonded to the surface of the core particles 71.

### [2A] Removing Step

### 2A-1

Next, the precursor 72A not bonded to the core particles 71 is removed. In this case, the liquid medium 8 is substituted for the dispersion medium 7. In so doing, as shown in FIG. 11C, it is possible to attain a state in which the electrophoretic particles 70 are dispersed in the dispersion medium 7, without excess precursor 72A being present. Concentration adjustment is performed as necessary, and, as shown in FIG. 11D, the dispersion liquid 100 is obtained.

As described above, since the liquid medium 8 is different to the final dispersion medium 7, and has compatibility with the dispersion medium 7, it is preferable that the method for substituting the liquid medium 8 with the dispersion medium 7 include a step for adding the dispersion medium 7 and a step for removing the liquid medium 8. In so doing, it is possible to substitute the liquid medium 8 with the dispersion medium 7 during the removing step or after the removing step. These steps are preferably performed during the washing, or are preferably performed after the washing (after the removing step). For example, if the dispersion medium 7 is used as the washing solvent, it is possible for the liquid medium 8 to be substituted with the dispersion medium 7 during washing.

### EXAMPLES

Next, specific examples according to an aspect of the invention will be described.

### 1. Method of Manufacturing Electrophoresis Dispersion Liquid

The electrophoresis dispersion liquid is manufactured as follows. Each reference example, and the manufacturing conditions in each example and each reference example are shown in Table 1.

### Embodiment 1

### [1] Manufacturing of Precursor of Siloxane Compound

First, the silicone oil shown by formula (3), a silane coupling agent that includes a reactive functional group of one equivalent or more with respect to reactive silicone oil-derived functional group included therein, and toluene are mixed in a round bottomed flask, and the platinum catalyst is added thereto. The obtained mixture is left in a state of being stirred, and heated. Next, the mixture is cooled to room temperature, the solvent removed under reduced pressure, and the residue dried. As above, the reactant of the modified silicone oil and the silane coupling agent (coupling agent that includes a siloxane compound structure) shown by formula (4) is obtained as the precursor of the siloxane compound (below, referred to as “coupling agent A”). The molecular weight of the siloxane compound was measured at 16, 000.

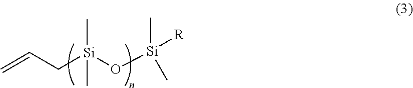

[In the formula (3), n is 50 to 500. R is an alkyl group (butyl group).]

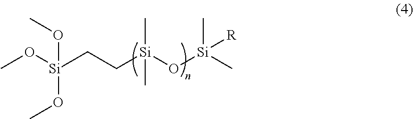

[In formula (4), n is 50 to 500. R is an alkyl group (butyl group).]
[2]

Next, the following bonding step and removing step are performed using the siloxane compound obtained with [1], and the electrophoresis dispersion liquid is obtained.

### Bonding Step (Granulating Step)

First, 3 g of titania mother particles (“CR-97”, manufactured by Ishihara Sangyo Kaisha, Ltd.) with a particle diameter 270 nm as mother particles, and 15 g of silicone oil (“KF-96L-2cs”, manufactured by Shin-Etsu Chemical Co., Ltd. (kinematic viscosity, 2 mm²/s)) as the liquid medium were introduced to a 100 mL glass container, mixed, and the titania mother particles dispersed in the liquid medium.

Thereafter, 0.3 g of the siloxane compound obtained in [1] is added to the obtained mixture.

Next, a dispersion process is performed on the obtained mixture using an ultrasound washing machine. A heat-insulating material covers the container, and the mixture is heated and stirred at a temperature of 180° C. (reaction temperature) using a hot stirrer (“1-5477-02”, manufactured by AS ONE Corporation). In so doing, the surface of the titania mother particles and the precursor of the siloxane compound are reacted, and a dispersion liquid (pre-washing electrophoresis dispersion liquid) in which the electrophoretic particles in which the siloxane compound is bonded to the surface of the titania mother particles are dispersed in the liquid medium is obtained.

### Removing Step (Washing Step)

The dispersion liquid obtained in the bonding step is transferred to a centrifuge bottle, and, after weight adjustment with a washing solvent (“KF-96L-2cs” manufactured by Shin-Etsu Silicone), the mixture is centrifuged using a centrifuge (“High speed Refrigerated Micro Centrifuge MX-207”, manufactured by TOMY Digital Biology Co., Ltd.) and the supernatant liquid is decanted (first washing).

After the same washing is repeated, the washing solvent is added to the precipitate, and adjusted to 40 wt %. In so doing, a dispersion liquid (post-washing (precursor of siloxane compound is removed) electrophoresis dispersion liquid) in which the electrophoretic particles in which the siloxane compound is bonded to the titania mother particles are suspended in the washing solvent (dispersion medium) is obtained.

### Reference Example 1

Other than not performing the removing step, the electrophoresis dispersion liquid of Reference Example 1 was obtained similarly to Example 1.

The electrophoresis dispersion liquid of Reference Example 1 was the pre-washing electrophoresis dispersion liquid in Example 1.

### Example 2

When manufacturing the precursor of the siloxane compound, other than n in formula (3) being 300 to 2000, and n in formula (4) being 300 to 2000, the electrophoresis dispersion liquid of Example 2 was obtained similarly to the above-described Example 1. Below, the molecular weight of the siloxane compound used in the embodiment was 60,000. The precursor is referred to as “coupling agent B”.

### Reference Example 2

Other than not performing the removing step, the electrophoresis dispersion liquid of Reference Example 2 was obtained similarly to Example 2.

The electrophoresis dispersion liquid of Reference Example 2 was the pre-washing electrophoresis dispersion liquid in Example 2.

### Example 3

Other than using a silicone macromer dispersant (no charging group) instead of the precursor of the siloxane compound, the electrophoresis dispersion liquid of Example 3 was obtained similarly to the above-described Example 1.

The silicone macromer dispersant of the example was manufactured as follows.

Along with dissolving 15 mol % of “Silaplane FM-FM-0711 (manufactured by Chisso Corporation)” as a polymerization component having a silicon chain, 65 mol % of methacrylic acid methyl as a hydrophobic polymerization component, 5 mol % of methoxypoly(ethylene glycol)-9-methacrylate (manufactured by Shin-Nakamura Chemical Co., Ltd.) as a polymerization component having a polyalkylene glycol structure, and 15 mol % of methacrylic acid as a hydrophilic polymerization component in 1-methoxy-2-propanol, 1.5 mol % of a polymerization initiator (dimethyl-2,2′-azobis(2-methylpropionate “V-601”, manufactured by Wako Pure Chemical Industries, Ltd.) was dissolved at a ratio with respect to the total of the polymerization components, oxygen was removed by nitrogen bubbling, and polymerization was performed at 80° C. In the process, two hours and four hours after the start of polymerization, 1.5 mol % of the polymerization initiator (V-601) was added at a ratio with respect to the total of the polymerization components, and polymerization was performed for a total of six hours. After polymerization, a purification treatment and drying were performed, and a silicone macromer dispersant was obtained.

By the obtained silicone macromer dispersant being added the mixture formed from the titania mother particles and the liquid medium, heated, and stirred, the pre-washing electrophoresis dispersion liquid was obtained. The silicone macromer dispersant used in the embodiment was a dispersant with a type that physically bonds to the particle surface.

### Reference Example 3

Other than not performing the removing step, the electrophoresis dispersion liquid of Reference Example 3 was obtained similarly to Example 3.

The electrophoresis dispersion liquid of Reference Example 3 was the pre-washing electrophoresis dispersion liquid in Example 3.

### Example 4

Other than using a silicone macromer dispersant (no charging group) instead of the precursor of the siloxane compound, the electrophoresis dispersion liquid of Example 4 was obtained similarly to the above-described Example 1.

The silicone macromer dispersant of the example was a copolymer (molar ratio 3/26/69/2) of “Silaplane FM-0721 (manufactured by Chisso Corporation)” as a polymerization component having a silicon chain, phenoxypolyethyleneglycol acrylate AMP-10G (Shin-Nakamura Chemical Co., Ltd.) as a polymerization component having a charging group and HEMA (2-hydroxyethylmethacrylate) and isocyanate monomer as a polymerization component having a reactive group (crosslinking group) (isocyanate monomer having a blocked isocyanate group “Karenz MOI-BP (manufactured by SHOWA DENKO K.K)”).

By the silicone macromer dispersant being added the mixture formed from the titania mother particles and the liquid medium, heated, and stirred, the pre-washing electrophoresis dispersion liquid was obtained. The silicone macromer dispersant used in the embodiment was dispersant with a type that is physically adsorbed on the particle surface.

### Reference Example 4

Other than not performing the removing step, the electrophoresis dispersion liquid of Reference Example 4 was obtained similarly to Example 4.

The electrophoresis dispersion liquid of Reference Example 4 was the pre-washing electrophoresis dispersion liquid in Example 4.

### Examples 5 to 7

Other than using a mixed solution of 15 g of silicone oil (manufactured by Shin-Etsu Chemical Co., Ltd., “KF-96L-2cs”) and 0.003 g of water, the electrophoresis dispersion liquids of Examples 5 to 7 were obtained similarly to the above-described Examples 1 to 3.

### Reference Examples 5 to 7

Other than using a mixed solution of 15 g of silicone oil (manufactured by Shin-Etsu Chemical Co., Ltd., “KF-96L-2cs”) and 0.003 g of water, the electrophoresis dispersion liquids were obtained similarly to the above-described Examples 1 to 3.

The electrophoresis dispersion liquid of Reference Example 5 was the pre-washing electrophoresis dispersion liquid in Example 5. The electrophoresis dispersion liquid of Reference Example 6 was the pre-washing electrophoresis dispersion liquid in Example 6. The electrophoresis dispersion liquid of Reference Example 7 was the pre-washing electrophoresis dispersion liquid in Example 7.

### Examples 8 and 9

Other than using a mixed solution of silicone oil (manufactured by Shin-Etsu Chemical Co., Ltd., “KF-96L-20cs”, (kinematic viscosity 20 mm²/s)) with a different viscosity as the liquid medium, the electrophoresis dispersion liquids of Examples 8 and 9 were obtained similarly to the above-described Examples 1 and 2.

### Reference Example 8 and 9

Other than using a mixed solution of silicone oil (manufactured by Shin-Etsu Chemical Co., Ltd., “KF-96L-20cs”) with a different viscosity as the liquid medium, the electrophoresis dispersion liquids of Reference Examples 8 and 9 were obtained similarly to the above-described Reference Examples 1 and 2.

### Example 10

Other than using an ester solution (“Pastel M8” manufactured Lion) as the liquid medium and the dispersion medium, the electrophoresis dispersion liquid of Example 10 was obtained similarly to the above-described Example 1.

### Example 11

Other than using a paraffin solution (“Isopar-M” manufactured Exon Chemical Co., Ltd.) as the liquid medium and the dispersion medium, the electrophoresis dispersion liquid of Example 11 was obtained similarly to the above-described Example 1.

### Example 12

Other than using titania mother particles (“SC-13M-T”, manufactured by Mitsubishi Materials Corporation) with a particle diameter of 100 nm as the mother particles, the electrophoresis dispersion liquid of Example 12 was obtained similarly to the above-described Example 1.

### Example 13

Other than using the coupling agent B instead of the precursor of the siloxane compound, the electrophoresis dispersion liquid of Example 13 was obtained similarly to the above-described Example 12.

### Examples 14 and 15

Other than using a mixed solution of 15 g of silicone oil (“KF-96L-2cs” manufactured by Shin-Etsu Chemical Co., Ltd.) as the liquid medium and 0.003 g of water, the electrophoresis dispersion liquids of Examples 14 and 15 were obtained similarly to the above-described Examples 12 and 13.

### Example 16

Other than using a silicone oil (manufactured by Shin-Etsu Chemical Co., Ltd., “KF-96L-20cs”) with a different viscosity as the liquid medium, the electrophoresis dispersion liquid of Example 16 was obtained similarly to the above-described Example 12.

### Example 17

Other than using a mixed solution of silicone oil (manufactured by Shin-Etsu Chemical Co., Ltd., “KF-96L-20cs”) as the liquid medium and 0.003 g of water, the electrophoresis dispersion liquid of Example 17 was obtained similarly to the above-described Example 13.

The type of mother particles in the above Examples 1 to 17 and Reference Examples 1 to 9, the type of liquid medium, the type of precursor of the siloxane compound and the presence or absence of the removing step are collected and shown in Table 1. In Table 1, although the evaluation results for the dispersibility of the electrophoresis dispersion liquid, the migration and the resistance value are also shown, the evaluation and method are described later.

TABLE 1

| | | LIQUID MEDIUM | | | | |
|---|---|---|---|---|---|---|
| | | (REACTION | | | | |
| | | SOLVENT) | | | PARTICLE | DISPERSION |
| | PARTICLE | A | B | POLYMER CHAIN | WASHING | LIQUID |
| EXAMPLE 1 | CR-97 | KF-96L-2cs | — | COUPLING AGENT A | YES | KF-96L-2cs |
| REFERENCE | | | | | NO | |
| EXAMPLE 1 | | | | | | |
| EXAMPLE 2 | | | | COUPLING AGENT B | YES | |
| REFERENCE | | | | | NO | |
| EXAMPLE 2 | | | | | | |
| EXAMPLE 3 | | | | MACROMER | YES | |
| REFERENCE | | | | | NO | |
| EXAMPLE 3 | | | | | | |
| EXAMPLE 4 | | | | CHARGED | YES | |
| | | | | MACROMER | | |
| REFERENCE | | | | | NO | |
| EXAMPLE 4 | | | | | | |
| EXAMPLE 5 | | | WATER | COUPLING AGENT A | YES | |
| REFERENCE | | | | | NO | |
| EXAMPLE 5 | | | | | | |
| EXAMPLE 6 | | | | COUPLING AGENT B | YES | |
| REFERENCE | | | | | NO | |
| EXAMPLE 6 | | | | | | |
| EXAMPLE 7 | | | | MACROMER | YES | |
| REFERENCE | | | | | NO | |
| EXAMPLE 7 | | | | | | |
| EXAMPLE 8 | | KF-96-20cs | — | COUPLING AGENT A | YES | |
| REFERENCE | | | | | NO | |
| EXAMPLE 8 | | | | | | |
| EXAMPLE 9 | | | | COUPLING AGENT B | YES | |
| REFERENCE | | | | | NO | |
| EXAMPLE 9 | | | | | | |
| EXAMPLE 10 | | PASTEL M8 | — | COUPLING AGENT A | YES | PASTEL M8 |
| EXAMPLE 11 | | Isopar-M | — | COUPLING AGENT A | YES | Isopar-M |
| EXAMPLE 12 | SC-13MT-T | KF-96L-2cs | — | COUPLING AGENT A | YES | KF-96L-2cs |
| EXAMPLE 13 | | | | COUPLING AGENT B | YES | |
| EXAMPLE 14 | | | WATER | COUPLING AGENT A | YES | |
| EXAMPLE 15 | | | | COUPLING AGENT B | YES | |
| EXAMPLE 16 | | KF-96-20cs | — | COUPLING AGENT A | YES | |
| EXAMPLE 17 | | | WATER | COUPLING AGENT B | YES | |

| | EVALUATION | | | |
|---|---|---|---|---|
| | DISPERSIBILITY | MIGRATION | RESISTANCE VALUE | DETERMINATION |
| EXAMPLE 1 | A | ++ | B | A |
| REFERENCE | A | ++ | C | C |
| EXAMPLE 1 | | | | |
| EXAMPLE 2 | C | + | B | C |
| REFERENCE | C | − | C | D |
| EXAMPLE 2 | | | | |
| EXAMPLE 3 | D | + | B | D |
| REFERENCE | C | +/− | C | D |
| EXAMPLE 3 | | | | |
| EXAMPLE 4 | C | + | B | C |
| REFERENCE | B | +/− | C | C |
| EXAMPLE 4 | | | | |
| EXAMPLE 5 | C | + | B | C |
| REFERENCE | A | ++ | C | C |
| EXAMPLE 5 | | | | |
| EXAMPLE 6 | B | + | B | B |
| REFERENCE | B | +/− | C | C |
| EXAMPLE 6 | | | | |
| EXAMPLE 7 | D | + | B | D |
| REFERENCE | C | +/− | C | C |
| EXAMPLE 7 | | | | |
| EXAMPLE 8 | A | ++ | B | A |
| REFERENCE | A | + | B | B |
| EXAMPLE 8 | | | | |
| EXAMPLE 9 | C | + | B | C |
| REFERENCE | C | − | C | D |
| EXAMPLE 9 | | | | |
| EXAMPLE 10 | B | + | C | C |
| EXAMPLE 11 | B | * | B | B |
| EXAMPLE 12 | B | −− | B | A |
| EXAMPLE 13 | C | −− | B | C |
| EXAMPLE 14 | C | − | B | C |
| EXAMPLE 15 | B | − | B | B |
| EXAMPLE 16 | B | −− | B | B |
| EXAMPLE 17 | B | −− | B | B |

### Examples 18 to 41

### Reference Examples 10 to 17

When adding the precursor of the siloxane compound to the mixture consisting of mother particles and the liquid medium in the bonding step along with using 15 g of silicone oil (“KF-96L-2cs”, manufactured by Shin-Etsu Chemical Co., Ltd.) as a liquid medium, other than using a silicone solution of the precursor of the siloxane-based compound, and setting the reaction temperature in the binding process, the solution concentration of the precursor of the siloxane compound added and the number of washes in the removing step to the conditions shown in Table 2 below, the electrophoresis dispersion liquids of Examples 18 to 41 and Reference Examples 10 to 17 was obtained similarly to Example 1.

TABLE 2

| | | ADDITION AMOUNT OF | | | | |
|---|---|---|---|---|---|---|
| | REACTION | SILOXANE COMPOUND | NUMBER | EVALUATION | | |
| | TEMPERATURE | WITH RESPECT TO CORE | OF | | RESISTANCE | |
| | (° C.) | PARTICLE WEIGHT | WASHES | DISPERSIBILITY | VALUE | DETERMINATION |
| REFERENCE | 65 | 5 | 0 | D | C | D |
| EXAMPLE 10 | | | | | | |
| EXAMPLE 18 | | | 1 | D | B | D |
| EXAMPLE 19 | | | 2 | D | B | D |
| EXAMPLE 20 | | | 3 | D | B | D |
| REFERENCE | | 10 | 0 | C | C | C |
| EXAMPLE 11 | | | | | | |
| EXAMPLE 21 | | | 1 | D | B | D |
| EXAMPLE 22 | | | 2 | D | B | D |
| EXAMPLE 23 | | | 3 | D | B | D |
| REFERENCE | | 20 | 0 | C | C | C |
| EXAMPLE 12 | | | | | | |
| EXAMPLE 24 | | | 1 | C | C | C |
| EXAMPLE 25 | | | 2 | D | B | D |
| EXAMPLE 26 | | | 3 | D | B | D |
| REFERENCE | | 40 | 0 | B | D | D |
| EXAMPLE 13 | | | | | | |
| EXAMPLE 27 | | | 1 | C | C | D |
| EXAMPLE 28 | | | 2 | D | C | D |
| EXAMPLE 29 | | | 3 | D | B | D |
| REFERENCE | 180 | 5 | 0 | C | B | C |
| EXAMPLE 14 | | | | | | |
| EXAMPLE 30 | | | 1 | C | B | C |
| EXAMPLE 31 | | | 2 | C | B | C |
| EXAMPLE 32 | | | 3 | C | B | C |
| REFERENCE | | 10 | 0 | B | C | C |
| EXAMPLE 15 | | | | | | |
| EXAMPLE 33 | | | 1 | B | B | B |
| EXAMPLE 34 | | | 2 | A | B | A |
| EXAMPLE 35 | | | 3 | A | B | A |
| REFERENCE | | 20 | 0 | B | C | C |
| EXAMPLE 16 | | | | | | |
| EXAMPLE 36 | | | 1 | B | B | B |
| EXAMPLE 37 | | | 2 | A | B | A |
| EXAMPLE 38 | | | 3 | A | B | A |
| REFERENCE | | 40 | 0 | B | C | C |
| EXAMPLE 17 | | | | | | |
| EXAMPLE 39 | | | 1 | B | C | C |
| EXAMPLE 40 | | | 2 | B | B | B |
| EXAMPLE 41 | | | 3 | A | B | A |

In Table 2, although the evaluation results for the dispersibility of the electrophoresis dispersion liquid, the migration and the resistance value are also shown, the evaluation and method are described later.

### Examples 42 to 65

In the bonding step, when adding the precursor of the siloxane compound to the mixture formed from mother particles and the liquid medium, other than using a silicone solution with 2 wt % of the precursor of the siloxane compound and setting the type of mother particles, the type of liquid medium (silicone oil (“KF-96L-0.5cs” (kinematic viscosity 0.5 mm²/s), “KF-96L-2cs, “KF-96L-20cs”, and “KF-96L-100cs” (kinematic viscosity 100 mm²/s), all manufactured by Shin-Etsu Chemical Co., Ltd.)) and the solution amount of the precursor of the siloxane compound added to the conditions shown in Table 3, the electrophoresis dispersion liquids of Examples 42 to 65 are obtained similarly to the Example 1.

TABLE 3

| | | SOLUTION AMOUNT | | | | |
|---|---|---|---|---|---|---|
| | | OF SILOXANE | | | | |
| | | COMPOUND (2 WT %) | | EVALUATION | | |
| | PARTICLES | TYPE | AMOUNT (g) | DISPERSIBILITY | RESISTANCE VALUE | DETERMINATION |
| EXAMPLE 42 | CR-97 | KF-96L-0.5cs | 15 | B | B | B |
| EXAMPLE 43 | | | 60 | B | B | B |
| EXAMPLE 44 | | | 120 | C | B | C |
| EXAMPLE 45 | | KF-96L-2cs | 15 | A | B | B |
| EXAMPLE 46 | | | 60 | B | B | B |
| EXAMPLE 47 | | | 120 | B | B | B |
| EXAMPLE 48 | | KF-96L-20cs | 15 | A | B | A |
| EXAMPLE 49 | | | 60 | A | B | A |
| EXAMPLE 50 | | | 120 | A | B | A |
| EXAMPLE 51 | | KF-96-100cs | 15 | A | B | A |
| EXAMPLE 52 | | | 60 | A | B | A |
| EXAMPLE 53 | | | 120 | A | B | A |
| EXAMPLE 54 | SC-13M-T | KF-96I-0.5cs | 15 | D | B | C |
| EXAMPLE 55 | | | 60 | A | B | A |
| EXAMPLE 56 | | | 120 | B | B | B |
| EXAMPLE 57 | | KF-96L-2cs | 15 | B | B | B |
| EXAMPLE 58 | | | 60 | A | B | A |
| EXAMPLE 59 | | | 120 | A | B | A |
| EXAMPLE 60 | | KF-96-20cs | 15 | C | B | C |
| EXAMPLE 61 | | | 60 | B | B | B |
| EXAMPLE 62 | | | 120 | B | B | B |
| EXAMPLE 63 | | KF-96-100cs | 15 | D | B | D |
| EXAMPLE 64 | | | 60 | B | B | B |
| EXAMPLE 65 | | | 120 | B | B | B |

In Table 3, although the evaluation results for the dispersibility of the electrophoresis dispersion liquid, the migration and the resistance value are also shown, the evaluation and method are described later.

### 2. Evaluation of Electrophoresis Dispersion Liquid

### 2.1 Evaluation of Dispersibility

The electrophoresis dispersion liquid of each example and each reference example was poured into a pectinate electrode cell, and the inside of the cell is observed using an optical microscope. Samples confirmed to have dispersibility were further measured using a laser diffraction-scattering type particle size analyzer MT 3400 II, manufactured by Nikkiso Co., Ltd., and the dispersibility was evaluated according to the following evaluation standard.

A: no aggregation and is a monodispersion.
B: no aggregation; however, is a polydispersion.
C: aggregation present but is a monodispersion.
D: aggregation present and is a polydispersion.

In the evaluation standard, a case in which the volume average particle diameter (Mv) of the electrophoretic particles is 1.2 times or more with respect to the average particle diameter of the mother particles was determined to be a polydispersion.

### 2.2 Evaluation of Resistance Value

The volume resistivity ρv (Ω·cm) was measured for the electrophoresis dispersion liquid of each example and each reference example, and the resistance value was evaluated according to the following evaluation standard.

B: ρv>1011
C: 109≦ρv≦1011
D: ρv<109

Based on the evaluation results of the dispersibility and the resistance value according to the evaluation standard above, the worst of the any of the evaluation results is shown in Tables 1 to 3 as an overall evaluation.

For the electrophoresis dispersion liquid of Examples 1 to 17 and Reference Examples 1 to 9, the movement of the electrophoretic particles was observed when a predetermined voltage (fixed voltage) was applied between a pair of electrodes with the electrophoresis dispersion liquid interposed, evaluation of the migration was performed according to the following evaluation standard, and the results thereof are shown in Table 1.

++: large movement to the positive electrode side.
+: movement to the positive electrode side, but movement is small.
+/−: mixture of movement to the positive electrode side and movement to the negative electrode side.
−: movement to the negative electrode side, but movement is small.
−−: large movement to the negative electrode side.
*: no movement.

As shown by the results of the above evaluation and Tables 1 to 3, the electrophoresis dispersion liquid according to each example was compared to the electrophoresis dispersion liquid according to each reference example in which the corresponding removing step was not performed, and the resistance value was found to be lower.

### Second Embodiment of Electrophoresis Dispersion Particles

Below, a second embodiment of the electrophoretic particles included in the dispersion liquid 100 will be described.

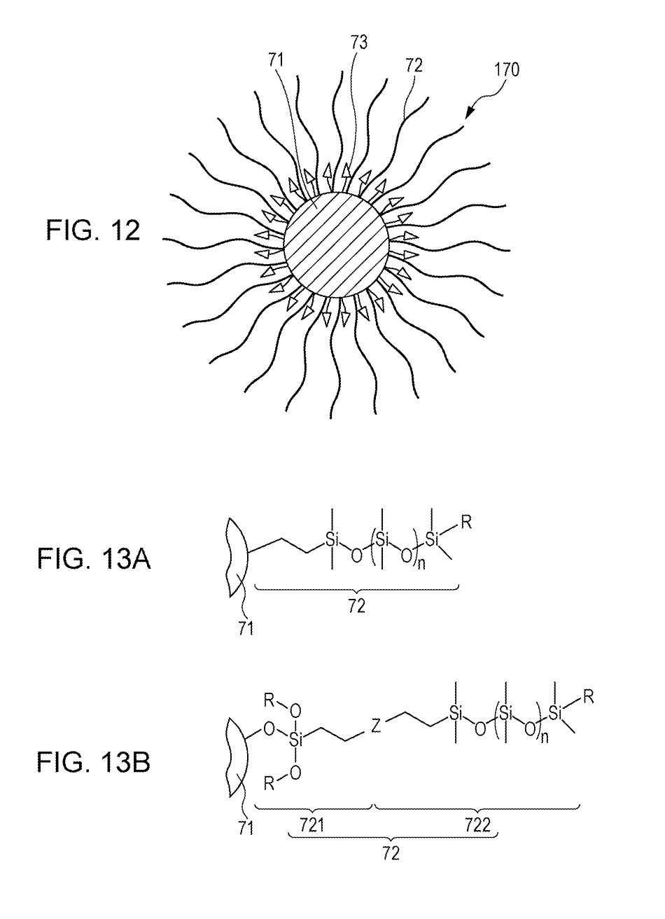

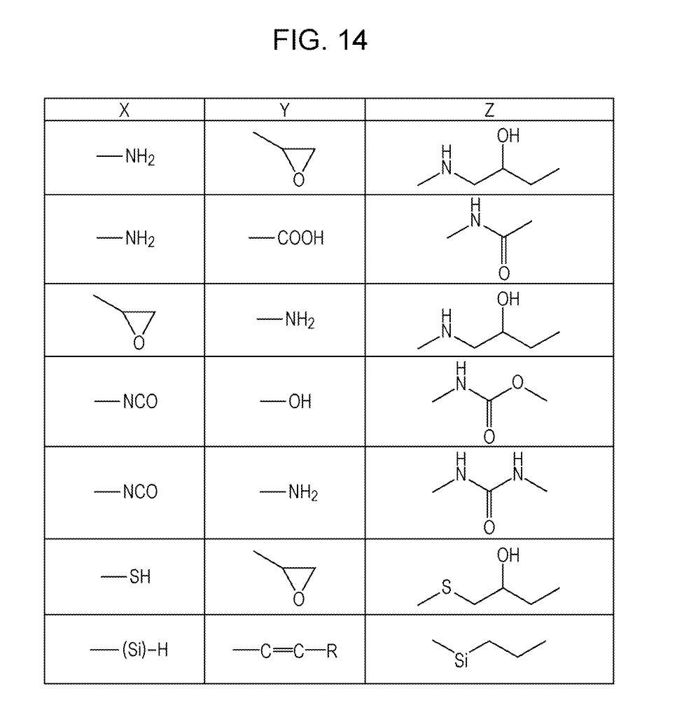

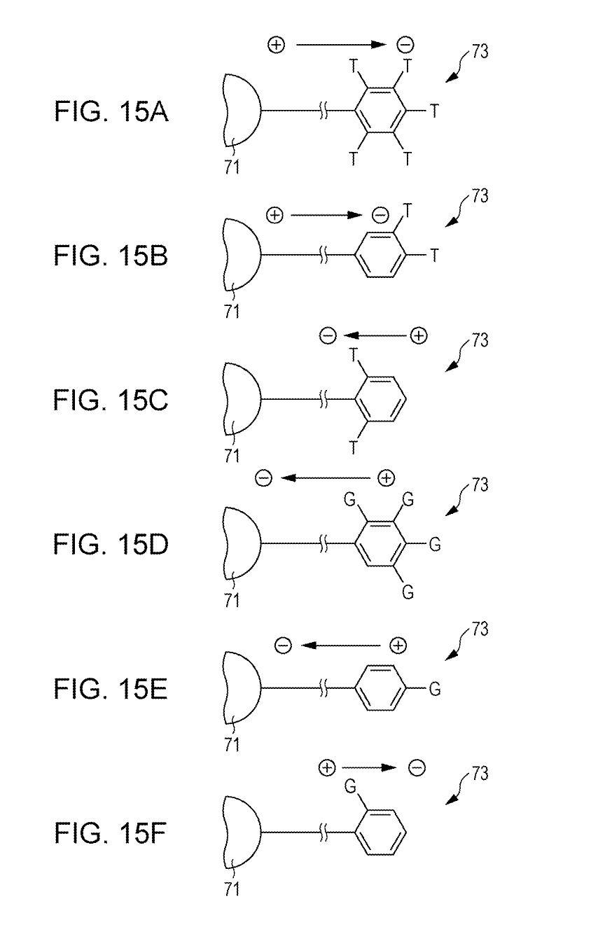

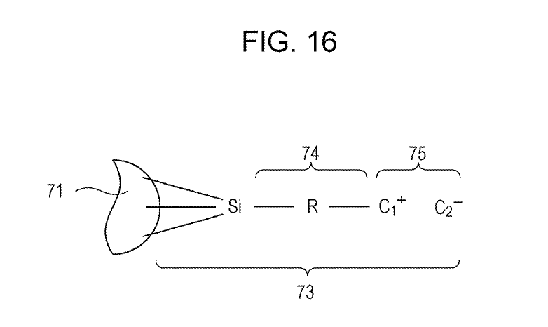

FIG. 12 is a cross-sectional view schematically showing the second embodiment of the electrophoretic particles used in the display device shown in FIGS. 1, 7 and 8. FIGS. 13A and 13B are drawings for describing the siloxane compound bonded to the particle surface of the electrophoretic particles shown in FIG. 12. FIG. 14 is a drawing specifically showing the reactive functional group X included in the coupling agent and reactive functional group Y included in the modified silicone oil, for the coupling agent and the modified silicone oil used in obtaining the siloxane compound having the structure Z shown in FIGS. 13A and 13B. FIGS. 15A to 15F are diagrams for describing an example (polarization group) of the charge control group bonded to the surface of the electrophoretic particles shown in FIG. 12, and FIG. 16 is a diagram for describing another example (charging group) of the charge control group bonded to the surface of the electrophoretic particles shown in FIG. 12. The same constituent portions as the first embodiment of the electrophoretic particles use the same numbers.

As shown in FIG. 12, the electrophoretic particles 170 of the embodiment includes core particles 71 (particles), a siloxane compound 72 (example of polymer chain-containing compound) bonded to the surface of the core particles 71, and a charge control group 73.

Because such electrophoretic particles 170 are remarkably inhibited from approaching the other electrophoretic particles 170 due to the siloxane compound 72, appropriate dispersibility is provided in the dispersion medium 7. Since the siloxane compound 72 has a high affinity to the non-polar or low-polarity dispersion medium 7, it is possible for the dispersibility of the electrophoretic particles 170 in the dispersion medium 7 to be increased. Because the effect of the siloxane compound 72 increasing the dispersibility of the electrophoretic particles 170 in the dispersion medium 7 is high, it is possible to reduce the area of the surface of the core particles 71 covered by the siloxane compound 72. Therefore, it is possible to sufficiently ensure the region to which the charge control group 73 is able to bond on the surface of the core particles 71.

Meanwhile, charging properties are provided to the core particles 71 by the charge control group 73. By adjusting the type, the amount, or the like of the charge control group 73, it is possible to control the charging amount, polarity or the like of the electrophoretic particles 170 in the charging state. In particular, it is possible to sufficiently ensure the region to which the charge control group 73 is able to bond on the surface of the core particles 71. Accordingly, regardless of the type of core particle 71, it is possible to exhibit desired charging characteristics of the polarity, charging amount, or the like of the electrophoretic particles 170.

In light of this, it is possible for the electrophoretic particles 170 to exhibit excellent dispersibility and charging properties in the dispersion medium 7. Accordingly, the aggregation of the electrophoretic particles 170 to one another is suppressed by a fixed repulsive force occurring due to the siloxane compound 72, and because a fixed coulomb force is generated in the electrophoretic particles 170 by the conductivity of the electrophoretic particles 170 themselves and the charge control group 73, along with thereby reducing the migration resistance of the electrophoretic particles 170, sufficient electrophoresis is possible under a weaker electric field as a result. As a result, it is possible to a display device with low power consumption and high responsiveness.

Because the dispersibility of the electrophoretic particles 170 is increased due to the siloxane compound 72 as described above, a dispersant is preferably not added at all to the dispersion medium 7. Therefore, it is possible to prevent lowering of the insulation properties between the first electrode 3 and the second electrode 4 arising in cases in which a large amount of dispersant is added. In so doing, the occurrence of a leak current during voltage application is suppressed, and it is possible to achieve a reduction in the power consumption of the display device 20.

A dispersant is preferably added to the dispersion medium 7, and, in this case, it is possible for the addition amount of the dispersant added to the dispersion medium 7 to be reduced, and to suppress the insulation properties between the first electrode 3 and the second electrode 4. Examples of the dispersant include, for example, polyamide amine and salts thereof, a basic functional group modified polyurethane, a basic functional group modified polyester, a basic functional group modified poly(meth)acrylate, a polyoxyethelyne alkylamine, an alkanolamine, and a polyacrylamide, and these may be used singly or a mixture of two or more types thereof may be used.

It is preferable that the addition amount of the dispersant be 0.3 wt % or less of the dispersion medium 7, and 0.1 wt % or less is more preferable. By suppressing the addition amount of the dispersant to be within the range, even if the dispersant is added, it is possible for the lower in of the insulation properties between the first electrode 3 and the second electrode 4 to be suppressed to the minimum limit.

Below, each portion that configures the electrophoretic particles 170 will be sequentially described in detail.

First, the core particles 71 are described.

The core particles 71 are not particularly limited, and examples thereof include oxide particles such as titanium oxide, zinc oxide, iron oxide, chromium oxide, and zirconium oxide, nitride particles such as silicon nitride, and titanium nitride, sulfide particles such as zinc sulfide, boride particles such as titanium boride, inorganic pigment particles such as strontium chromate, cobalt aluminate, copper chromite, and ultramarine, and organic pigment particles such as azo, quinacridone, anthraquinone, dioxazine, and perylene. It is also possible for composite particles in which a pigment is coated on the surface of resin particles configured by an acrylic resin, a urethane resin, a urea resin, an epoxy resin, a polystyrene, a polyester, or the like, to be used.

In a case of using a coupling agent as described later, taking the reactivity with the coupling agent into consideration, it is preferable that the core particles 71 have a hydroxyl group present in the surface, and, on this point, more preferable that an inorganic material be used.

It is preferable that the average particle diameter of the core particles 71, although not particularly limited, be approximately 10 nm or more to 800 nm or less and approximately 20 nm or more to 400 nm or less is more preferable. By setting the average particle diameter of the core particles 71 to be within the range, it is possible for both a sufficiently chromatic display due to the electrophoretic particles 170 and fast electrophoresis of the electrophoretic particles 170 to be achieved. As a result, it is possible for both a high contrast display and a high response speed to be achieved.

By setting the average particle diameter of the core particles 71 to be within the range, it is possible to suppress settling of the electrophoretic particles 170 and variations in the migration speed, and to suppress the occurrence of display unevenness and display defects.

The average particle diameter of the core particles 71 signifies the volume average particle diameter measured by a dynamic light diffusion type particle size distribution measurement device (for example, product name: LB-500, manufactured by Horiba, Ltd.).

In the embodiment, although a case of one type of core particle 71 being included in the dispersion liquid 100 is described, a plurality of types of core particles 71 is preferably included. In this case, by selecting a plurality of types of core particles 71 in a combination with large differences in brightness and chromaticity, such as black and white, or a light color and a dark color, a display with still superior contrast is possible. In a case of using a plurality of different types of core particles 71, the types or introduction amounts of the siloxane compound 72 may be the same or may be different between the plurality of different type of core particles 71.

Next, the siloxane compound 72 will be described.

Although the siloxane compound 72 is preferably any compound if that compound (compound that includes a polymer chain) includes a linking structure (below, referred to as “silicone main chain”) in which a plurality of siloxane bonds is linked in series, it is preferable that a compound having a straight chain molecular structure configured by a main chain that includes the linking structure and a side change bonded to the straight chain. If such a compound is used, the long chain molecular structure of the siloxane compound 72 is comparatively stably maintained, and since it is possible to sufficiently form the separation distance between core particles 71 spaced with the siloxane compound 72, the function of the siloxane compound 72 of providing dispersibility to the electrophoretic particles 170 is still further promoted.

A compound with a comparatively weak polarity (non-polar or low polarity) is often used in the dispersion medium 7. Meanwhile, compound that includes a siloxane bond, depending on the structure frequently have a comparatively low polarity. Accordingly, the electrophoretic particles 170 that include such a siloxane compound 72 show particularly favorable dispersibility with respect to the dispersion medium 7.

It is preferable that the siloxane compound 72 include a structure derived from silicone oil having a silicone main chain or a modified material thereof (below, simply referred to as a “silicone oil-derived structure”). Since the silicone oil or a modified material thereof is often used as the dispersion medium 7, the dispersibility of the electrophoretic particles 170 is particularly increased by the siloxane compound 72 including a structure derived therefrom.

Such a silicone oil-derived structure in the embodiment is preferably directly linked to the surface of the core particles 71, as shown in FIG. 13A, and, is preferably linked to the surface of the core particles 71 via a coupling agent-derived structure, as shown in FIG. 13B.

When more specifically described, the siloxane compound 72 of the example shown in FIG. 13A is obtained by a silicone oil-derived functional group and a hydroxyl group of the surface of the core particles 71 being reacted. The siloxane compound 72 of the example is configured only with the silicone oil-derived structure, and the hydrocarbon structure bonded to the terminal end of the main chain (silicone main chain) configured by the siloxane bonds is lined to the core particles 71. Accordingly, because the silicone oil-derived structure accounts for the majority of the siloxane compound 72, for example, the dispersibility of the electrophoretic particles 170 is particularly increased when the silicone oil or modified materials thereof is used as the dispersion medium 7.

Meanwhile, the siloxane compound 72 of the example shown in FIG. 13B is obtained by modified silicone oil and a coupling agent being reacted, and the coupling agent-derived hydrolysable group from the obtained reactants and the hydroxyl group of the surface of the core particles 71 being dehydration-compression reacted. The siloxane compound 72 of the example is configured by a silicone oil-derived structure and a coupling agent-derived structure, and the silicone oil-derived structure 722 is linked to the core particles 71 via the coupling agent-derived structure 721. Regardless of whether the siloxane compound 72 with such a structure includes long chain and straight chain molecular structure, control of the bonding amount with respect to core particles 71 is easy, and, as a result, it is possible to realize electrophoretic particles 170 that include a siloxane compound 72 strictly controlled to an amount that is a target. In other words the siloxane compound 72 that includes a long chain and straight chain molecular structure is able to go through a process of sufficiently ensuring a reaction opportunity between the silicone oil and the coupling agent by in advance by intermediating between the silicone oil-derived structure 722 and the core particles 71 with the structure of the coupling agent derivative 721, in contrast to the numerous difficulties that accompany accurately introducing an amount that is a target with respect to the core particles 71. Therefore, it is possible for the magnitude of the reactivity of the coupling agent to be effectively utilized with respect to the core particles 71, and it is possible to precisely control the introduction amount of the siloxane compound 72, as a result.

It is preferable that weight average molecular weight of the siloxane compound 72 be approximately 1000 or more and 100,000 or less, and approximately 10000 or more and 60000 or less is more preferable. By setting the weight average molecular weight to be within the range, the length of the molecular structure of the siloxane compound 72 is optimized, and electrophoretic particles 170 to which dispersibility is sufficiently provided derived from the long chain and straight chain structure are obtained, while sufficiently securing a region able to exhibit charging properties of the core particles 71 themselves and introduce the polarization group to the surface of the core particles 71.

It is preferable that n in FIGS. 13A and 13B be approximately 12 or more and 1400 or less for the same reasons as the weight average molecular weights each described above, and approximately 130 or more and 800 or less is more preferable.

The structure Z in FIG. 13B is a structure in which the reactive functional group X included in the coupling agent and the reactive functional group Y included in the silicone oil are reacted.

Examples of the reactive functional groups X and Y are shown in FIG. 14. R in FIG. 14 is an aliphatic hydrocarbon group, such as an alkyl group.

It is preferable that the terminal end and the side chain of the siloxane compound 72 be configured by a substituent with a low polarity. In so doing, it is possible to increase the dispersibility of the electrophoretic particles 170. Specific examples of the substituent include, for example, an alkyl group.

It is preferable that the occupancy ratio (coverage) of the region to which the siloxane compound 72 in the surface of the core particles 71 is bonded be 0.05% or more and 20% or less, 0.1% or more and 10% or less is more preferable, and 0.2% or more and 5% or less is still more preferable. By setting the occupancy ratio of the region to be within the range, it is possible for both the dispersibility caused mainly by the siloxane compound 72 and the charging characteristics caused mainly by the surface of the core particles 71 or the group introduced to the surface thereof to be further strengthened. That is, it is possible to achieve both dispersibility and charging characteristics to be achieved even in an environment in which the temperature at which the dispersion liquid 100 is left changes greatly, or an environment in which the strength of the electric field is low.

In a case in which the occupancy ratio of the region drops below the lower limit value, the dispersibility is lowered, and there is concern of the electrophoretic particles 170 aggregating according to the environment in which the dispersion liquid 100 is left. Meanwhile, in a case in which the occupancy ratio of the region goes over the upper limit value, it becomes difficult to introduce the charge control group 73 to the surface of the core particles 71 according to the type method of manufacturing the electrophoretic particles 170 (in particular, the introduction method and introduction timing of the charge control group 73).

Here the occupancy ratio (coverage) [%] of the region to which the siloxane compound 72 is bonded on the surface of the core particles 71 is obtained by the following formula when the area occupied for each molecule of the siloxane compound 72 bonded to the surface of the core particles 71 is the “unit area” and the number of molecules of the siloxane compound 72 bonded to the surface of the core particles 71 is the “molecule number”.

Occupancy ratio (coverage)=(unit area X molecule number)/(surface area of core particle)×100

It is possible for the “unit area” to be obtained from the molecular structure of the siloxane compound 72 through a calculation.

It is possible to obtain the “molecule number” from the mass [g] of the siloxane compound 72 bonded per core particle 71, the molecular weight [g/mol] of the siloxane compound 72, and the number of molecules 6.02×1023 [units/mol]per mol through a calculation.

Next, the charge control group 73 will be described.

The charge control group 73 is bonded to the surface of the core particles 71, and has a function of controlling the charging properties of the core particles 71.

Although not particularly limited if the group has the function as described above, examples of such a charge control group 73 include a polarization group having a main skeleton in which the electrons are biased, and a charging group having a main skeleton forming an ion pair. These will be described below.

### Polarization Group

First, a polarization group used as the charge control group 73 will be described.

The polarization group is an organic group having a main skeleton, and a substituent bonded to the main skeleton.

In the polarization group, by setting at least one condition of the type of substituent (either or both of an electron absorbing group and an electron donating group), number of bonds with respect to the main skeleton, and the binding site, the electrons in the main skeleton are biased (polarization), and in so doing, the charge state of the electrophoretic particles 170 is controlled.

That is, on the end portion (below, referred to “terminal of the main skeleton”) side of the opposite side to the core particles 71 of the main skeleton, the electrons are biased further toward the terminal end side than to the core particle 71 side of the main skeleton in the polarization group in which the electron absorbing group (electron withdrawing group) as a substituent. When such a polarization group is introduced, the core particles 71 (electrophoretic particles 170) are negatively charged.

Meanwhile, on the core particle 71 side of the main skeleton, the electrons are biased further to the core particle 71 side than the terminal side of the main skeleton in the polarization group in which the electron withdrawing group is bonded as a substituent. When such a polarization group is introduced, the core particles 71 (electrophoretic particles 170) are positively charged.

In the polarization group in which an electron donating group (electron donor group) as a substituent, because a bias arises in the opposite electron concentration to the above-described, when the polarization group in which the electron donor group is bonded to the terminal side of the main skeleton, the core particles 71 (electrophoretic particles 170) are positively charged, and when the power group in which the electron donor group is bonded to the core particle 71 side of the main skeleton, the core particles 71 (electrophoretic particles 170) are negatively charged.

As the number of bonds of the substituent bonded to the main skeleton increases the bias in the electron concentration exhibits a tendency to increasing.

In the invention, the polarization group in which the bias in the electron concentration arises is made the charge control group 73, and by selection, as appropriate, and introduction to the surface of the core particles 71, it is possible to control (adjust) the core particles 71 to a desired charging state.

Although examples of charging state of the core particles 71 (electrophoretic particles 170) include, for example, positiveness or negativeness of a charge, charging amount, and distribution of charge, it is possible to easily perform control of at least one of the positiveness or negativeness of the charge and the charging amount.

It is preferable to be in a state in which the bias in electron concentration easily arises in the main skeleton of the polarization group. Accordingly, it is preferable that the main skeleton have a part (structure) in which n electrons are delocalized. In so doing, the movement of electrons in the main skeleton easily arises, and the effects described above are more remarkably exhibited.

Although the part in which the n electrons are delocalized are all preferably in a structure in which the conjugated double bonds are linearly linked, it is preferable to have a ring structure in which at least a part thereof form a ring. In so doing, the movement of the electrons more easily and smoothly occurs.

Although various types of such a ring structure exist, it is preferable that the ring structure be an aromatic ring, and it is particularly preferable that the ring structure be a benzene ring, a naphthalene ring, a pyridine ring, a pyrrole ring, a thiophene ring, an anthracene ring, a pyrene ring, a perylene ring, a pentacene ring, a tetracene ring, a chrysene ring, an azulene ring, a fluorene ring, a triphenelene ring, a phenanthrene ring, a quinoline ring, an indole ring, a pyrazine ring, an acridine ring, a carbazole ring, a furan ring, a pyran ring, a pyrimidine ring, or a pyridazine ring. In so doing, bias (polar) in the electron concentration in the ring structure easily arises, and, as a result, it is possible for the bias in the electron concentration to be more remarkable.

It is preferable that the main structure further have the ring structure at the terminal thereof, and the substituent be bonded to the ring structure. In so doing, bias (polar) in the electron concentration in the ring structure easily arises, and, as a result, it is possible for the bias in the electron concentration to be more remarkable.

Here, a case of the main skeleton having a benzene ring at the terminal thereof is described as an example.

In this case, when the electron absorbing group as the substituent is bonded to at least the three third to fifth positions (all of the second to sixth positions in FIG. 15A) from the second to sixth positions of the I: benzene ring, as shown in FIG. 15A, the electrons in the main skeleton are drawn to the terminal side by the presence of the electron absorbing group T, and biased. Therefore the core particles 71 are negatively charged.

When the electron absorbing group T as the substituent is bonded to at least one position (in FIG. 15B, third and fourth positions) of the third, fourth and fifth positions of the II: benzene ring, as shown in FIG. 15B, the electrons in the main skeleton (in particular, on the benzene ring) are drawn to the terminal side by the presence of the electron absorbing group T, and biased. Therefore the core particles 71 are negatively charged.

When the electron absorbing group T as the substituent is bonded to at least one position (in FIG. 15C, second and sixth positions) of the second and sixth positions of the III: benzene ring, as shown in FIG. 15C, the electrons in the main skeleton (in particular, on the benzene ring) are drawn to the core particles 71 side by the presence of the electron absorbing group T, and biased. Therefore the core particles 71 are positively charged.

When the electron donating group G as the substituent is bonded to at least the three third to fifth positions (in FIG. 15D, four positions of second to fifth positions) from the second to sixth positions of the IV: benzene ring, as shown in FIG. 15D, the electrons in the main skeleton are drawn to the core particles 71 side by the presence of the electron donating group G, and biased. Therefore the core particles 71 are positively charged.

When the electron donating group G as the substituent is bonded to at least one position (in FIG. 15E, fourth position) from the third, fourth, and fifth positions of the V: benzene ring, as shown in FIG. 15E, the electrons in the main skeleton (in particular, on the benzene ring) are drawn to the core particles 71 side by the presence of the electron donating group G, and biased. Therefore the core particles 71 are positively charged.

When the electron donating group G as the substituent is bonded to at least one position (in FIG. 15F, second position) from the second and sixth positions of the VI: benzene ring, as shown in FIG. 15F, the electrons in the main skeleton (in particular, on the benzene ring) are drawn to the terminal side by the presence of the electron donating group G, and biased. Therefore the core particles 71 are negatively charged.

The II structure and VI structure, and the III structure and V structure, are preferably combined, respectively. In so doing, it is possible for the bias in the electron concentration in the main skeleton (in particular, on the benzene ring) to be still more remarkable.

The main skeleton is preferably configured by only one ring structure described above, or is preferably a structure in which a plurality of ring structures is bonded in a straight chain. Specific examples of the latter main skeleton include, for example, the following formulae (A-1) to (A-3).

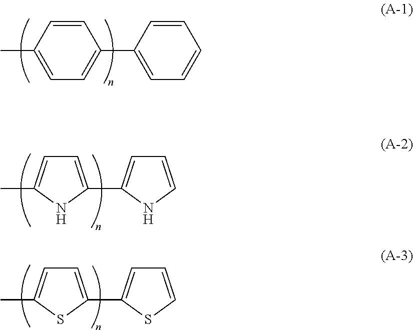

wherein, in formulae (A-1) to (A-3), n in the formula indicates an integer of 1 or more.

In the main skeleton represented in formulae (A-1) to (A-3), although it is preferable that the substituent be bonded to the ring structure of the terminal, the substituent is preferably bonded to another ring structure other than the terminal. The electron absorbing group T is not particularly limited if it is a substituent that exhibits the tendency of being strongly drawn (withdrawn) compared to hydrogen atoms, and examples thereof include halogen atoms, such as F, Cl, Br and I, a cyano group, a nitro group, a carboxyl group, a trifluoromethyl group, a formyl group, and a sulfo group. Among these, it is preferable that the electron absorbing group T be at least one type selected from a group formed from a halogen atom, a cyano group, a nitro group, a carboxyl group, and a trifluoromethyl group. These have a particularly high capacity for drawing electrons.

Meanwhile, the electron donating group G is not particularly limited if it is a substituent that exhibits a tendency toward strongly expelling (donating) electrons compared to hydrogen atoms, and examples thereof include an amino group, an alkyl group, an alkoxy group, and a hydroxyl group. Among these, the electron donating group is at least one type selected from a group formed from an amino group, an alkyl group, and an alkoxy group. These have a particularly high capacity for expelling electrons.

The alkyl group preferably contains 1 to 30 carbon atoms, and more preferably 1 to 18 carbon atoms. The alkoxy group preferably contains 1 to 30 carbon atoms, and more preferably 1 to 18 carbon atoms. When the number of carbon atoms is too high in the alkyl group and the alkoxy group, either one of the alkyl group and the alkoxy group exhibit a tendency to easily aggregate to themselves, and, as a result, there is concern of difficulty in adjusting the charging state of the core particles 71 to a desired state.

It is preferable that the total number of carbon atoms in the main skeleton be 6 to 40, and 6 to 35 is more preferable. When the total number of carbon atoms is too low, the atoms do not easily become delocalized, and there is concern that it may therefore be difficult for bias in the electrons to effectively arise, whereas, when the total number of carbon atoms is too high, there is concern of it being difficult to introduce the charge control group 73 to the surface of the core particles 71.

It is preferable that the main skeleton further have a part (structure) that functions as a spacer on the core particle 71 side thereof. That is, it is preferable that the main skeleton have a part that functions as a spacer positioned between the core particle 71 and the ring structure. In so doing, each charge control group 73 is positioned by the part (part contributing to the control of the charging state) exhibiting the characteristics (nature) thereof being moderately separated from the core particles 71, and as a result, the characteristics of each charge control group 73 are more remarkably exhibited.

Although various structures can be considered as the part (below, referred to as the “spacer portion”) that functions as the spacer, for example, examples thereof include structures having a saturated carbon chain, a bond to another portion thereof, and an atom other than a carbon atom.

Here, although examples of another bond include the bond represented by the following formulae (B-1) to (B-23), and an unsaturated bond such as a double bond or a triple bond, the bonds represented by the following formulae (B-1) to (B-23) are preferable.

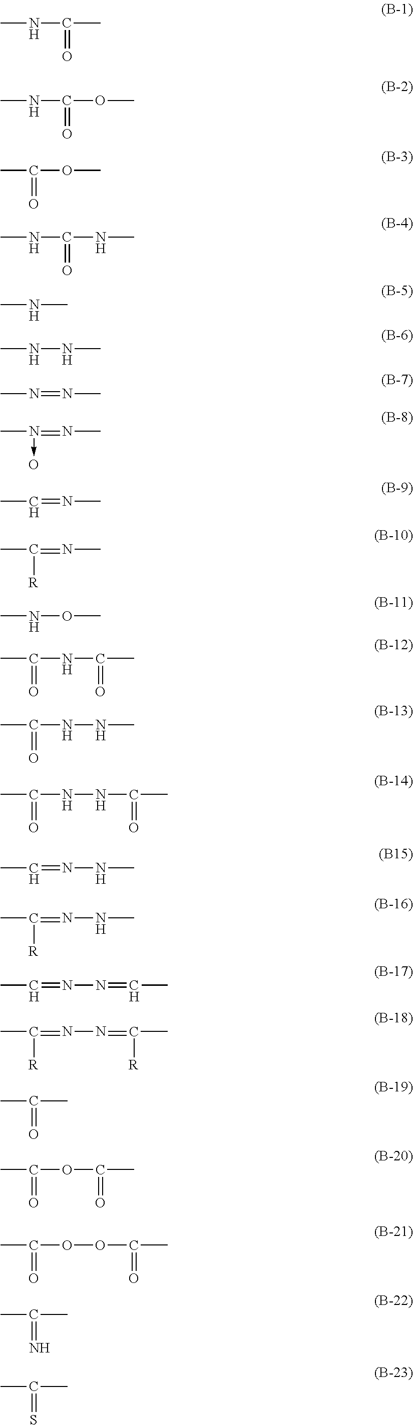

By interposing the bonds represented by formulae (B−1) to (B-23), it is possible to more easily and reliably introduce the charge control group 73 (polarization group) to the surface of core particles 71.

Because the bias in the electron concentration arises in the bond part represented by formulae (B-1) to (B-23), by polarization group having these bonds, an attractive force, and a repulsive force due to the bias in the electron concentration act between the neighboring polarization groups. In so doing, the polarization groups are arranged at more stable positions in the surface of the core particles 71. Specifically, the polarization groups are accurately arranged along the normal line direction of the surface of the core particles 71. As a result, the parts exhibiting the characteristics of the polarization groups are more reliably separated form the core particles 71 and positioned, and the characteristics of the polarization group are more remarkably exhibited.

Among these, in particular, an amide bond (formula (B-1)), a urethane bond (formula (B-2)), an ester bond (formula (B-3)), or a urea bond (formula (B-4)) is suitable. By selecting these bonds, the effects are more remarkably exhibited.

Examples of the atoms other than carbon, for example, include oxygen atoms and sulfur atoms. By interposing oxygen atoms or sulfur atoms, it is possible to more easily and reliably introduce the polarization group to the surface of the core particles 71.

Among these, oxygen atoms are particularly favorable. By selecting the oxygen atoms, the effects are more remarkably exhibited.

As described above, because there is a favorable range in the total number of carbon atoms in the main skeleton, in a case in which this is considered, in particular, it is preferable that the part that functions as a spacer be represented by the following formula (C).

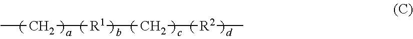

[herein, R1 and R2 in the formula (C) each independently represent an amide bond, a urethane bond, an ester bond, a urea bond or an oxygen atom, a represents an integer of 0 to 20, b represents 0 or 1, c represents an integer of 0 to 20, and d represents 0 or 1.]

When the value of a is too high, collection in which the amide bond, urethane bond, ester bond, and urea bond are biased easily form at positions separated from the core particles 71, there is concern of the characteristics of the position not being sufficiently exhibited. Therefore, it is preferable that a in formula (C) be 2 to 4 (in particular, 3 or 4).

When c is too large, there is concern of the distribution of the polarization group in the surface of the core particles 71 being uneven, whereas, when c is too small, there is concern of the introduction efficiency of the polarization group to the core particles 71 being lowered at the extreme end in cases where the substituent is introduced at the two- or six-position of the benzene ring. Accordingly, it is preferable that the value of c be adjusted in a range of 0 to 20, according to the type or position of the substituent introduced to the main chain.

It is preferable that the polarization group as above be introduced to the surface of the core particles 71 by a covalent bond. In so doing, it is possible to more reliably prevent the charge control group 73 (polarization group) from separating from the surface of the core particles 71. Therefore, it is possible to maintain the charging state of the core particles 71 over an extended period.

It is preferable that the polarization group have a coupling agent-derived structure bonded to the surface of the core particles 71, and that the ring structure be linked to the surface of the core particles 71 via the coupling agent-derived structure.

That is, a method using a coupling agent is suitable as a method (introduction method) for introducing the polarization group to the surface of the core particles 71 by the covalent bond. Examples of the method that use a coupling agent include, for example, [A] a method of reacting a hydroxyl group present in the surface of the core particles 71 and a coupling agent having a polarization group that is the target, and [B] a method of reacting a hydroxyl group present in the surface of the core particles 71 and the coupling agent having a portion of the polarization group that is the target, and thereafter reacting a portion of the polarization group introduced and the remainder of the polarization group, thereby completing the polarization group that is a target. According to such a method using the coupling agent, it is possible to easily and reliably introduce the polarization group to the surface of the core particles 71 with the covalent bond.

The hydroxyl group present in the surface of the core particles 71 preferably is inherently included in the core particles 71, or is preferably introduced by a hydrophilic treatment. Examples of method of the hydrophilic treatment include, a plasma treatment, a corona treatment, surface treatment with a solvent, and surface treatment with a surfactant.

Although any one of a silane coupling agent, a titanium coupling agent, an aluminum coupling agent, a compound having a carboxylic acid terminal, and a compound having a phosphoric acid terminal is usable as the coupling agent, a silane coupling agent is particularly suitable.

By using the silane coupling agent, since the siloxane bond (siloxane network) is formed in the surface of the core particles 71, it is possible for the polarization group to be more strongly bonded to the surface of the core particles 71. The silane coupling agent is easily purchased or synthesized, and has an advantage of being easily handled.

The method of introducing the polarization group to the surface of the core particles 71 is not limited thereto, and it is possible to introduce the polarization group to the surface of the core particles 71 by reacting the reactive functional group and the compound having the polarization group as described above, if another reactive functional group instead of the hydroxyl group in the surface of the core particles 71.

When represented as a ratio (wt %) with respect to the total mass of the mass of the core particles 71 and the mass of the charge control group 73, it is preferable that the introduction amount of the charge control group 73 to the surface of the core particles 71 be approximately 0.1 wt % to 20 wt %, 0.1 wt % to approximately 10 wt % is more preferable, and 0.1 wt % to approximately 5 wt % is still more preferable. By setting the introduction amount of the charge control group 73 to the appropriate range, it is possible to more reliably control (adjust) the charging state of the core particles 71 to the desired state.

### Charging Group

Next, the charging group used as the charge control group 73 will be described. The same matter as the above-described polarization group will not be described, as appropriate.

The charging group is an organic group having a main skeleton 74, and an ion pair 75 bonded to the main skeleton, as shown in FIG. 16.

The charging group is able to control the charging characteristics, such as the charging polarity or the charging amount by setting, as appropriate, the type of ion pair 75.

That is, in a case in which the ion pair 75 has an overall positive charge, when the charging group including the ion pair 75 is introduced, the electrophoretic particles 170 are positively charged. Whereas, in a case in which the ion pair 75 has an overall negative charge, when the charging group including the ion pair 75 is introduced, the electrophoretic particles 170 are negatively charged.

Among these, the main skeleton 74 has a molecular structure interposed between the surface of the core particles 71 and the ion pair 75. Examples of the main skeleton include a carbon-carbon bond, a carbon-oxygen bond, a siloxane bond, and other bonds, and these may be present singly, or two or more types may be present together. In the case of another bond, an unsaturated bond, such as a double bond or a triple bond is preferably included.

Although not particularly limited, it is preferable that the total number of carbon atoms in the main skeleton 74 be approximately 2 or more and 30 or fewer, and approximately 3 or more and 20 or fewer is more preferable. In so doing, the ion pair 75 is positioned by being moderately separated from the core particles 71, and as a result, the characteristics of the charging group are more remarkably exhibited. When the total number of carbon atoms is too low, it is difficult to sufficiently ensure the separation distance between the core particles 71 and the ion pair 75, and there is concern that the charging characteristics of the ion pair 75 may unintentionally influence the core particles 71. Whereas, when the total number of carbon atoms is too high, there is concern that it may be difficult to introduce the charging group to the surface of the core particles 71.

Although an arbitrary substituent is preferably bonded, as necessary, to the side chain of the main skeleton 74, a hydrocarbon group such as an alkyl group is preferable. In so doing, because the main skeleton 74 is compatible with the dispersion medium 7, and is easily expanded, it is possible to sufficiently ensure the separation distance between the ion pair 75 and the core particles 71.

The ion pair 75 is an association in which a cation (cation) and an anion (anion) approach each other, and the entirety is positively charged or negatively charged by setting, as appropriate, the combination of the cation and anion. It is possible to adjust, as appropriate, the charging amount thereof. Accordingly, by having a charging group including the ion pair 75, the electrophoretic particles 170 are able to freely control the charging characteristics thereof.

Among these, although examples of the cation include organic nitrogen (ammonium) cations, organic phosphorous (phosphonium) cations, and organic sulfur (sulfonium) cations, it is particularly preferable that organic nitrogen cations be used. Because design or change to the structure is comparatively easy, organic nitrogen cations are suitable to freely control the charging characteristics of the charging group.

It is preferable that an organic nitrogen cations including a structure represented by the following formulae (C-1) to (C-4) be used. It is possible to particularly finely control the charging characteristics of the charging group by using cations that include these structures.

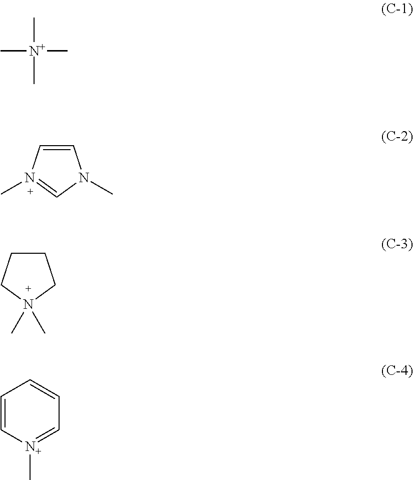

Meanwhile, examples of the anion include those with structures such as COO—, B—, SO3-, PO3H—, AlCl4-, NO2-, NO3-, I—, BF4-, PF6-, AsF6-, SbF6-, NbF6-, TaF6-, F(HF)2.3-, p-CH3PhSO3-, CH3CO2-, CF3CO2-, CH3SO3-, CF3SO3-, (CF3SO2)3C—, C3F7CO2-, C4F9SO3-, (CF3SO2)2N—, (C2F5SO2)2N—, (CF3SO2)(CF3CO)N—, and (CN)2N—, and a structure including one or two or more types thereof may be used.

Among these, it is preferable that the anion include at least one type selected from a group formed from carboxylic acid-based anions, sulfonic acid-based anions, phosphoric acid-based anions, and boron-based anions. By using an anion including these structures, the stability of the ion pair 75 is further increased, and electrophoretic particles 170 with excellent stability are obtained.

It is preferable that the caroxylic acid-based anion include a structure represented by the following formula (D-1), that the sulfonic acid-based anion include a structure represented by the following formula (D-2), and the phosphoric acid-based anion include a structure represented by the following formula (D-3).

—COO⁻ (D-1)

—SO₃⁻ (D-2)

—PO₃H⁻ (D-3)

The ion pair 75 is an association of a fixed ion covalently bonded to the main skeleton 74 and a counter ion that electrically attracts the fixed ion, the structure taken by the cation or the anion on either the fixed ion side or on the counter ion side may change.

In a case of the counter ion being a sulfonic acid-based anion, it is preferable that a structure represented by the following formula (D-4) be included, and in the case of the counter ion being a boron-based anion, it is preferable that a structure represented by the following formulae (D-5) and (D-6) be included.

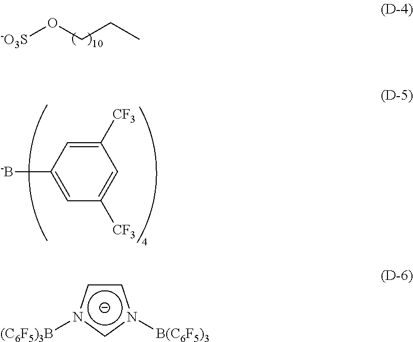

In such an ion pair 75, although the ion pair 75 may is positively charged overall or is negatively charged overall, among these, examples of combinations having an overall positive charge in the ion pair 75 include (1a) a combination of a cation including a structure represented by formula (C-1) and an anion including a structure represented by formula (D-5), and (2a) a combination of a cation including a structure represented by formula (C-1) and an anion including a structure represented by formula (D-6). In these combinations, the cation is the fixed ion, and the anion is the counter ion.

Meanwhile, examples of combinations having an overall negative charge in the ion pair 75 include (1b) a combination of a cation including a structure represented by formula (C-2) and an anion including a structure represented by formula (D-2), and (2b) a combination of a cation including a structure represented by formula (C-2) and an anion including a structure represented by formula (D-3). In these combinations, the anion is the fixed ion, and the cation is the counter ion.

In addition to being able to set the overall charging polarity of the ion pair 75 as above, it is possible to control the dissociation degree of the ion pair 75 according to the type of ion used, and to control the charging amount having a correlation relationship to the dissociation degree. In a case of a combination in which ion pair 75 has a positive charge overall, because the dissociation degree has a relationship of (1a)>(2a), the charging amount also has a relationship of (1a)>(2a).

In a case of a combination in which ion pair 75 has a negative charge overall, because the dissociation degree has a relationship of (1b)>(2b), the charging amount also has a relationship of (1b)>(2b).

It is preferable that the charging group as above be introduced to the surface of the core particles 71 by a covalent bond. In so doing, it is possible to more reliably prevent the charge control group 73 (charging group) from separating from the surface of the core particles 71. Therefore, it is possible to maintain the charging state of the core particles 71 over an extended period.

It is preferable that the charging group be lined to the surface of the core particles 71 via the coupling agent-derived structure. In so doing, it is more possible to more easily and reliably introduce the charging group to the surface of the core particles 71 by the covalent bond.

That is, a method using a coupling agent is suitable as a method (introduction method) for introducing the charging group to the surface of the core particles 71 by the covalent bond. Examples of methods using a coupling agent include a method of introducing the ion pair 75 and a compound including a coupling agent-derived structure to the core particles 71 via the coupling agent-derived structure, and, thereafter, performing ion exchange with the counter ion of the ion pair 75 as necessary, and a method of performing ion exchange on the counter ion of the ion pair 75 as necessary for the ion pair 75 and the compound including a coupling agent-derived structure, and, thereafter, introducing the ion pair 75 and the compound to the core particles 71 via the coupling agent-derived structure. According to such a method using the coupling agent, it is possible to easily and reliably introduce the charging group to the surface of the core particles 71 with the covalent bond.

In the ion exchange process, by immersing the compound including the ion pair 75 before ion exchange in a solution including ions that are the exchange subject, ion exchange with the ions in the solution is performed on the counter ion. In so doing, it is possible to perform ion exchange on the counter ion of the ion pair 75 with ions that are a target, and, as a result, it is possible to adjust the charging characteristics (charging amount) of the entire ion pair 75.

Although each portion of the structure of the charging group was described above, examples of the overall structure of the charging group including the ion pair 75 and the coupling agent-derived structure include the following formulae (E-1) to (E-3).

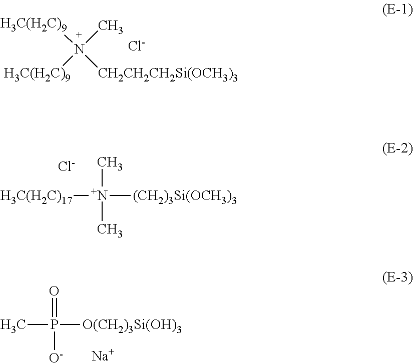

These structures are any structure of compounds (below, referred to as “charging group forming compound”) that become charging groups by being introduced to the surface of the core particles 71. These charging group forming compounds (precursor) are introduced to the core particles 71 by the coupling agent-derived hydrolysable group being dehydration-decompression reacted with surface of the core particles 71, and thereby, able to form the charging group. As described above, even in cases in which the charging group forming compound with such a structure includes a long chain molecular structure, control of the bonding amount with respect to the core particles 71 is easy, and, as a result, it is possible to realize electrophoretic particles 170 in which the introduction amount of the charging group is strictly controlled. In other words, the charging group forming compound that includes a long chain molecular structure is able to accurately control the introduction amount of the charging group by effectively utilizing the magnitude of the reactivity of the coupling agent with respect to the core particles 71, in contrast to the numerous difficulties that accompany accurately introducing an amount that is a target with respect to the core particles 71.

Such a charging group forming compound including the ion pair 75 is able to be prepared by performing various reactions, such as a dissociation reaction, a ring-opening reaction, an addition reaction, and a hydrolysis reaction, with respect to compounds not including the ion pair 75. Examples of compounds not including the ion pair 75 provided in such a preparation include the following formula (F-1) to (F-5).

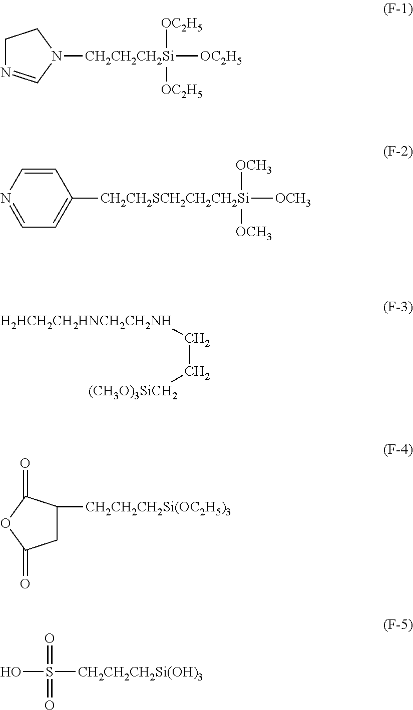

Among these, by reacting a halogenized alkyl in the compound represented by the formulae (F-1) to (F-3), the nitrogen-containing compound is quaternized, and it is possible to generate the ion pair 75.

By reacting a halogenized alkyl in the compound represented by the formulae (F-4), the nitrogen-containing compound is generated, and it is possible to generate the ion pair 75.

It is possible to generate the carboxylic acid-based anion by hydrolyzing the compound that includes the ester bond. In so doing, it is possible to carboxylic acid-based anion is generated, and generate the ion pair 75.

It is possible for the charge control group 73 such as described above to be introduced to a region in the surface of the core particles 71 other than region to which the above-described siloxane compound 72 is introduced, and the charge control group 73 is preferably introduced to at least a portion of the region. The introduction amount is determined according to the charging characteristics that are the target of the electrophoretic particles 170. That is, the introduction amount of the charge control group 73 is adjusted such that the electrophoretic particles 170 attain desired charging characteristics.

From the viewpoint of superior dispersibility of the electrophoretic particles 170 in the dispersion medium 7, it is preferable that the total content amount of the siloxane compound 72 and the charge control group 73 be 0.5 parts by mass or more and 10 parts by mass or less with respect to 100 parts by mass of the core particles 71 (mother particles).

It is preferable that the occupancy ratio of the region to which the charge control group 73 is bonded in the surface of the core particles 71 be smaller than the occupancy ratio of the region to which the siloxane compound 72 is bonded in the above-described surface of the core particles 71. In so doing, it is possible to prevent or suppress the charge control group 73 from inhibiting of the dispersibility caused by siloxane compound 72.

It is preferable that the molecular weight of the charge control group 73 be lower than the molecular weight of the siloxane compound 72. In so doing, it is possible to prevent or suppress the charge control group 73 from inhibiting of the dispersibility caused by siloxane compound 72. Since it is possible for the occupancy ratio of the region to which the siloxane compound 72 is bonded in the surface of the core particles 71 to be reduced, it is possible to sufficiently ensure the region to which the polarization group is introduced in the surface of the mother particles. Therefore, it is possible to widen the breadth of control of the charging properties.

According to the dispersion liquid 100 including the electrophoretic particles 170 of the second embodiment as described above, it is possible to lower the conductivity while realizing excellent dispersibility of the electrophoretic particles 170.

According to the display sheet 21 and the display device 20 in which such a dispersion liquid 100 is used, a high contrast display is possible.

### Method of Manufacturing Electrophoresis Dispersion Liquid

Next the method of manufacturing an electrophoresis dispersion liquid including the electrophoretic particles 170 of the second embodiment will be described. Below, a case of manufacturing the above-described dispersion liquid 100 will be described as an example.

### Third Embodiment of Method of Manufacturing Electrophoresis Dispersion Liquid

Firstly, the third embodiment of the method of manufacturing an electrophoresis dispersion liquid of the invention will be described. Below, an example of using the polarization group as shown in the above-described FIG. 15A to 15F as the charge control group is described.

First, the type of formation for forming the electrophoretic particles 170 in a case in which a polarization group is used as the charge control group will be simply described.

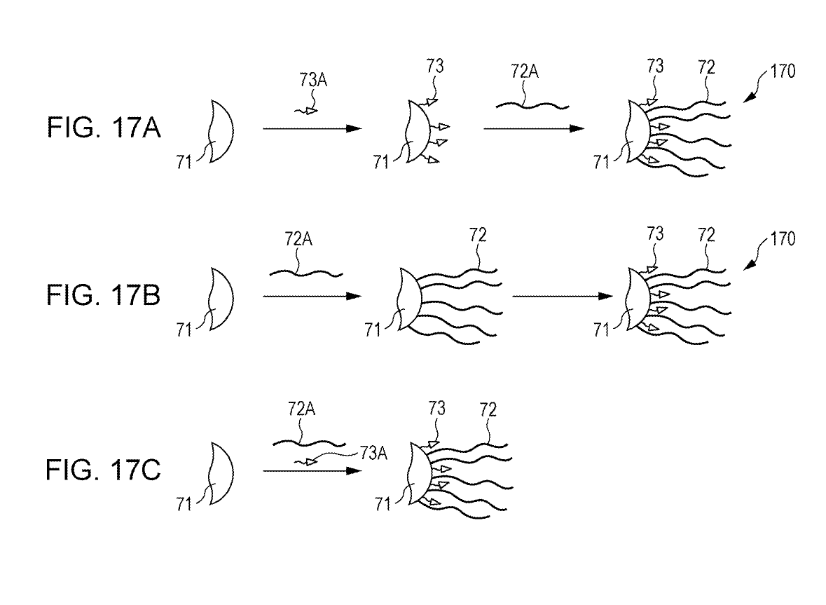

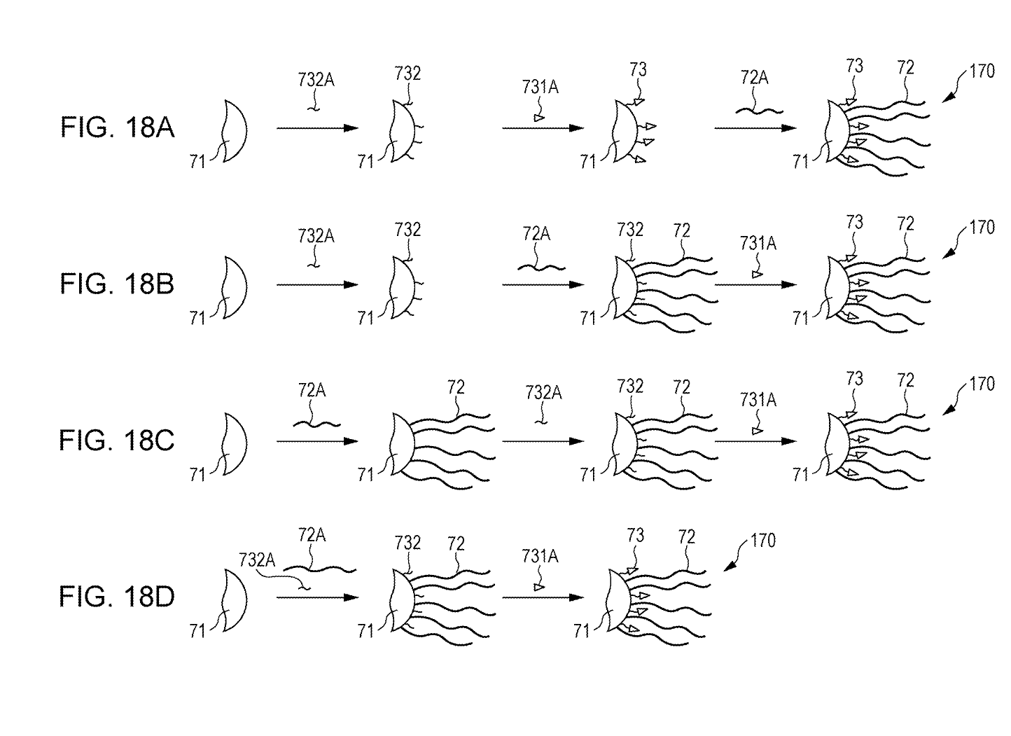

FIGS. 17A to 17C and 18A to 18D are each diagrams for describing the type of method of manufacturing electrophoretic particles in a third embodiment of the method of manufacturing an electrophoresis dispersion liquid of the invention.

As described above, in a case in which the polarization group is used as the charge control group 73, it is possible for the method for introducing the charge control group 73 to the core particles 71 to be divided into [A] a method for introducing the charge control group 73 to the surface of the core particles 71 by reacting the coupling agent and the surface of the core particles 71 after synthesizing the coupling agent having the charge control group 73 (below, referred to simply as “method [A]”) and [B] a method of forming the charge control group 73 by reacting the coupling agent and the compound having the remainder of the charge control group 73 after introducing the coupling agent including a portion of the charge control group 73 to the surface of the core particles 71 (below, referred to simply as “method [B]”).

Accordingly, it is possible to divide the method of manufacturing electrophoretic particles 170 into a case of using method [A] and a case of using method [B] as the method of introducing the charge control group 73 to the core particles 71.

In a case of introducing the charge control group 73 to the surface of the core particles 71 using the method [A], as shown in FIGS. 17A to 17C, examples of the method of manufacturing the electrophoretic particles 170 include <a> a method of introducing the siloxane compound 72 after introducing the charge control group 73 to the surface of the core particles 71 (refer to FIG. 17A), <b> a method of introducing the charge control group 73 after introducing the siloxane compound 72 to the surface of the core particles 71 (refer to FIG. 17B), and <c> a method of introducing the siloxane compound 72 and the charge control group 73 to the surface of the core particles 71 (refer to FIG. 17C).

Meanwhile, in a case of introducing the charge control group 73 to the surface of the core particles 71 using the method [B], examples of the method of manufacturing the electrophoretic particles 170 include <d> a method of introducing the siloxane compound 72 after introducing a portion of the charge control group 73 to the surface of the core particles 71, and forming a remainder (refer to FIG. 18A), <e> a method of introducing the siloxane compound 72 after forming a portion of the charge control group 73 in the surface of the core particles 71, and, thereafter, forming a remainder of the charge control group 73 (refer to FIG. 18B), <f> a method of introducing a portion of the charge control group 73 and forming a remainder after introducing the siloxane compound 72 to the surface of the core particles 71 (refer to FIG. 18C), and <g> a method of forming a remainder of the charge control group 73 after the siloxane compound 72 and a portion of the charge control group 73 are introduced at the same time to the surface of the core particles 71 (refer to FIG. 18D), as shown in FIGS. 18A to 18D.

Below, a case of using <b> a method of introducing the charge control group 73 after introducing the siloxane compound 72 to the surface of the core particles 71 (refer to FIG. 17B) as the method of manufacturing the dispersion liquid 100 will be described as representative.

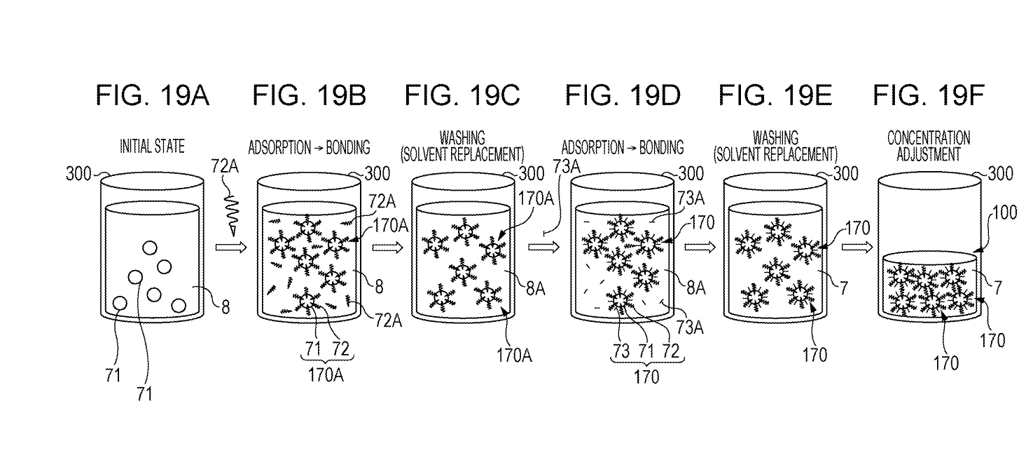

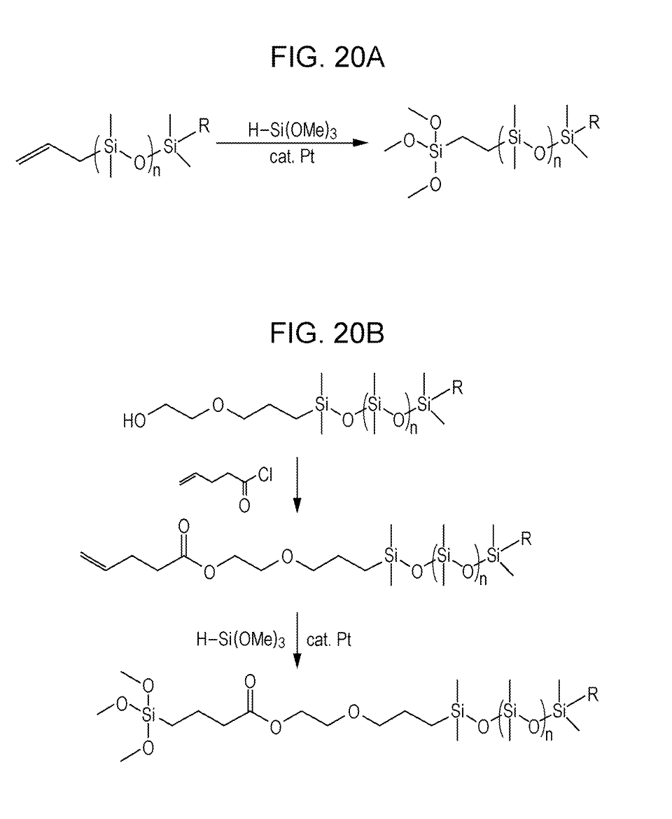

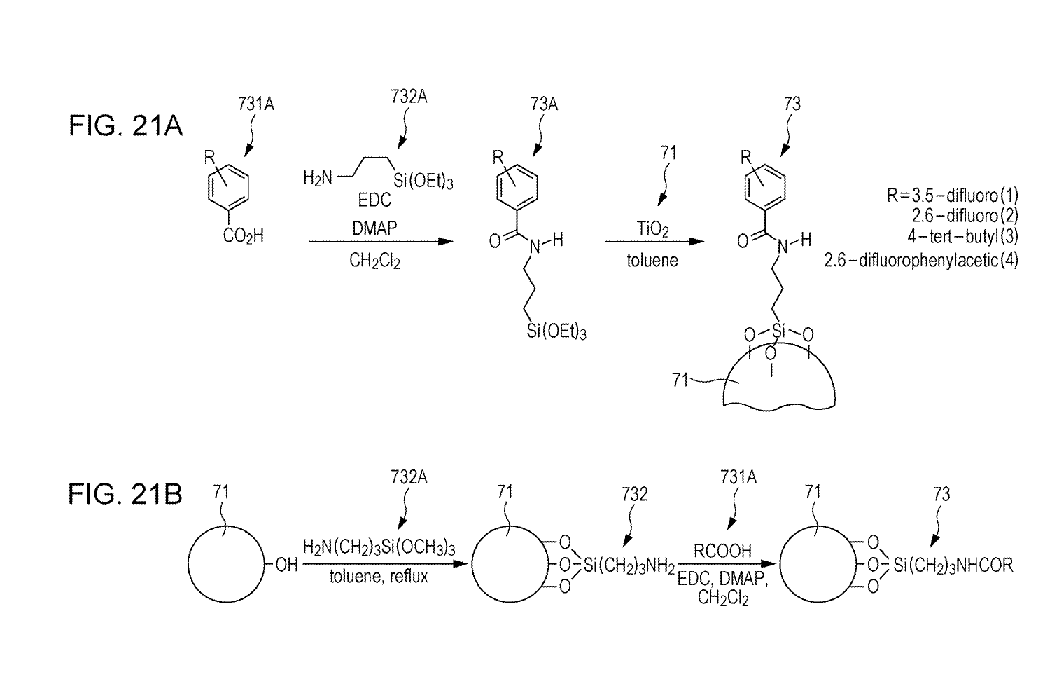

FIGS. 19A to 19F are diagrams for describing the second embodiment of the method of manufacturing an electrophoresis dispersion liquid of the invention. FIGS. 20A and 20B are diagrams for describing an example of a method of manufacturing a silicon compound, and FIGS. 21A and 21B are diagrams for describing an example of a method of manufacturing the charge control group (polarization group).

The method of manufacturing the dispersion liquid 100 shown in FIGS. 19A to 19F includes [1] a first bonding step (polymer chain-containing compound bonding step) of bonding the siloxane compound 72 to the surface of the core particles 71 in the liquid medium 8, [2] a first removing step (excess polymer chain-containing compound removing step) of removing the precursor 72A of the siloxane compound not bonded to the core particles 71, [3] a second bonding step (charge control group bonding step) of bonding the charge control group 73 to the surface of the core particles 71 in the liquid medium 8A, and [4] a second removing step (excess charge control group removing step) of removing the precursor 73A of the charge control group 73 not bonded to the core particles 71.

Below, each step will be sequentially described in detail.

### [1] First Bonding Step (Polymer Chain-Containing Compound Removing Step)

1-1

First, the core particles 71 are dispersed in the dispersion medium 8 in a container 300, as shown in FIG. 19A.

The liquid medium 8 functions as the reaction solvent in step 1-2 described later.

Examples of such a liquid medium 8 include a solvent the same as the dispersion medium 7, and a solvent different to the dispersion medium 7 and that has compatibility with the dispersion medium 7.

In a case where the liquid medium 8 is the dispersion medium 7, it becomes unnecessary to substitute the liquid medium 8 with the final dispersion medium 7, and it is possible to comparatively simply prevent or suppress involuntary liquids from being mixed in the dispersion medium 7 of the electrophoresis dispersion liquid 100 finally obtained. Because it becomes unnecessary to substitute the liquid medium 8 with the final dispersion medium 7, it is possible to simplify the first removing step [2] and the second removing step [4] described later.

In a case of using the same solvent as the dispersion medium 7 as the liquid medium 8, the viscosity (kinematic viscosity at 25° C.) of the dispersion medium 7 is determined in advance according to the type or the like of the core particle 71 or the type or the like of the siloxane compound 72, and, although not particularly limited, 0.5 mm²/s or more and 20 mm²/s or lower is preferable. In so doing, it is possible for the dispersibility of the core particles 71 with respect to dispersion medium 7 even if not bonded with the siloxane compound 72 while having excellent responsiveness of the electrophoretic particles 170 in the dispersion medium 100 finally obtained.

Meanwhile, in a case of using a solvent different to the dispersion medium 7 and has compatibility with the dispersion medium 7 as the liquid medium 8, the liquid medium 8 is substituted with the dispersion medium 7 in the first removing step [2] or the second removing step [4] described later.

By using the liquid medium 8 different to the dispersion medium 7 In this way, it is possible to select, as appropriate, a liquid medium 8 with different type (in particular, viscosity) to the dispersion medium 7 of the dispersion liquid 100 finally obtained. Therefore, in the first bonding step [1], even without the separate use of an additive such as a dispersant, it is possible to increase the dispersibility of the core particles 71 to which the siloxane compound 72 that includes a polymer chain are not bonded in the liquid medium 8. As a result, in the first bonding step [1], it is possible to effectively perform a reaction of the precursor 72A and the surface of the core particles 71.

In this case, it is preferable that a liquid having similar characteristics to the dispersion medium 7 be used as the liquid medium 8, and specifically, it is preferable to have the same comparatively high insulation properties as the above-described dispersion medium 7, and it is more preferable that one having aliphatic hydrocarbons (liquid paraffin), or silicone oil as a main component be used.

In this case, it is preferable that the liquid medium 8 have a higher viscosity than the dispersion medium 7. In so doing, while using a liquid medium 8 with chemical characteristics close to the dispersion medium 7, in the first bonding step [1], it is possible to increase the dispersibility of the core particles 71 to which the siloxane compound 72 are not bonded in the liquid medium 8. From such a viewpoint, it is preferable that the liquid medium 8 be the same type of liquid with a higher viscosity than the dispersion medium 7. For example, in a case in which the dispersion medium 7 is a silicone oil, it is preferable that silicone oil with a higher viscosity than the dispersion medium 7 be used as the liquid medium 8.

The viscosity (kinematic viscosity at 25° C.) of the specific liquid medium 8 is determined in advance according to the type or the like of the core particles 71 or the type or the like of the liquid medium 8, and, although not particularly limited, 0.5 mm²/s or more and 100 mm²/s or lower is preferable. In particular, in a case in which the affinity between the core particles 71 to which the siloxane compound is not bonded and the liquid medium 8 is comparatively low, it is preferable that the viscosity of the liquid medium 8 be 2 mm²/s or more and 100 mm²/s or less, and 20 mm²/s or more and 100 mm²/s or less is more preferable, whereas, in a case in which the affinity between the core particles 71 to which the siloxane compound is not bonded and the liquid medium 8 is comparatively high, it is preferable that the viscosity of the liquid medium 8 be 0.5 mm²/s or more and 100 mm²/s or less, and 0.5 mm²/s or more and 2 mm²/s or less is more preferable. In so doing, it is possible to increase the dispersibility of the core particles 71 with respect to the liquid medium 8 even without bonding with the siloxane compound 72.

In this case, it is preferable that the liquid medium 8 have a lower boiling point than the dispersion medium 7. In so doing, in the first removing step [2] or in the second removing step [4] described later, it is possible to easily remove the liquid medium 8 using the difference in boiling point with the dispersion medium 7, in other words, it is possible to easily substitute the liquid medium 8 with the dispersion medium 7.

Such a method is particularly effective in a case in which the core particles 71 easily precipitate. For example, in a case in which the particle diameter of the core particles 71 is 250 nm or more and 350 nm or less, it is more preferable that the manufacturing method in the embodiment be used.

Another solvent is preferably included in the liquid medium 8 in addition to the above-described solvent, and for example, the liquid medium 8 is preferably a two-phase based solvent. Whether the liquid medium is a single phase-based solvent or a two phase-based solvent is preferably selected according to the type of the core particles 71 or the type of modifier bonded to the particle surface. For example, in a case in which the number average molecular weight of the polystyrene conversion of the modifier bonded to the surface of the core particles is less than 40,000, or a case in which the viscosity is less than 2000 mm²/s, it is preferable that the liquid medium 8 be a single phase-based solvent of the dispersion medium 7. In a case in which the molecular weight of the modifier bonded to the surface of the core particles is less than 40,000 or a case in which the viscosity is 2,000 mm²/s or more, it is preferable that a minute amount of a polar solvent be added with respect to the overall weight of the liquid medium. It is preferable that water be added as the polar solvent, it is preferable that the content amount occupied in the overall liquid medium of the polar solvent added be 0.01 wt % or more and 0.1 wt % or less, and 0.02 wt % or more and 0.1 wt % or less is more preferable. In so doing, it is possible to prevent unnecessary liquid from being mixed into the dispersion medium 7 of the electrophoresis dispersion liquid 100 finally obtained, and for the characteristics of the electrophoresis dispersion liquid 100 to be excellent. When the amount of water (polar solvent) added is excessive, the modifier may react with itself, and there are cases in which the dispersibility of the core particles 71 is lowered. From this viewpoint, even in a case in which other solvents of the dispersion medium 7 are included in the liquid medium 8, it is preferable that the content amount of the solvent in the liquid medium 8 be 0.1 wt % or less, and 0.01 wt % or more and 0.1 wt % or less is more preferable. The wording “the liquid medium is a single phase-based solvent of the dispersion medium” in the specification includes a state in which a plurality of types of solvent with similar polarities are mixed together without excessive phase separation or suspension occurring. “Two phase-based” refers to a state in which the plurality of types of solvent are in a state of phase separation or suspension.

It is preferable that the usage amount of the liquid medium 8 with respect to the addition amount of the core particles 71 in this step be 3 times or more and 80 times or less, and 5 times or more and 60 times or less is more preferable. In a case in which the particle diameter (number average particle diameter) of the core particles 71 is 50 nm or more and 150 nm or less, 15 times or more and 60 times or less with respect to the addition amount of the core particles 71 is more preferable. In so doing, it is possible to favorably maintain the reaction opportunity between the core particles 71 and the precursor 72A in the step 1-2, described later, and to increase the dispersibility of the core particles 71 and the precursor 72A in the liquid medium.

1-2

Next, as shown in FIG. 19B, the precursor 72A of the siloxane compound 72 is added. By the precursor 72A and the surface of the core particles 71 being reacted in the dispersion medium 8, the siloxane compound 72 is chemically bonded to the surface of the core particles 71.

The precursor 72A is a coupling agent that includes the structure of the siloxane compound 72, and is obtained by a siloxane bond-containing substance and a coupling agent being reacted. The reaction is between a reactive functional group included in the siloxane bond-containing substance and a reactive functional group included in the coupling agent. In so doing, the siloxane bond-containing substance is modified by the coupling agent, and the coupling agent-derived hydrolysable group is positioned on one terminal end of the obtained reactant.

It is possible for the reaction of the siloxane bond-containing substance and the coupling agent to be performed by adding a sufficient amount of the coupling agent that includes a reactive functional group with respect to the siloxane bond-containing substance that includes a reactive functional group. In so doing, it is possible for the reaction probability between the siloxane bond-containing substance and the coupling agent to be improved, and for the yield of the reactant to be particularly improved.

Although examples of the siloxane bond-containing substance include silicone oil, organopolysiloxane, or modified materials thereof, it is particularly preferable that a modified material of silicone oil be used.

Any modified silicone oil is preferably used if it includes a reactive functional group such as an amino group, an epoxy group, a carboxyl group, a hydroxyl group, a mercapto group, an isocyanate group, a carbinol group, and an acid chloride. Specifically, examples thereof include an amino-modified silicone oil, an epoxy-modified silicone oil, a carboxyl-modified silicone oil, and a carbinol-modified silicone oil.

The silicone oil preferably includes two or more types from the above-described reactive functional groups.

Meanwhile, any coupling agent is preferably used if it includes a reactive functional group such as an amino group, an epoxy group, a sulfide group, a vinyl group, an acryloxy group, a methacryloxy group, and a mercapto group. Specifically, examples thereof include a silane coupling agent and a titanium coupling agent.

The coupling agent preferably includes two or more types from the above-described reactive functional groups.

It is preferable that the addition amount of the coupling agent be set to an amount that includes one equivalent or more of the reactive functional group with respect to the reactive functional group in the siloxane bond-containing substance, and being set to an amount including a 1.5 equivalents or more of the reactive functional group is more preferable.

FIGS. 20A and 20B show an example of the reaction formula showing the reaction pathway of the modified silicone oil and the silane coupling agent.

The reaction shown in FIG. 20A is a reaction known as hydrosilylation in which an Si—H bond is added to an organic double bond, such as C═C. A metal complex or the like from groups 8 to 10 of the periodic table, and it is particularly preferable that platinum or a compound thereof be used.

As necessary, as shown in FIG. 20B, first, a linking portion is reacted with the modified silicone oil, and thereafter, the coupling agent is further reacted with respect to the obtained reactant, and a reactant is preferably finally obtained. At this time, it is possible to use 10-undecenoyl chloride, 10-undecenic acid, and 4-pentenic acid, in addition to 4-pentenoyl chloride shown in FIG. 20B. By using such a method, it is possible to more finely tune the molecular weight of the siloxane compound 72 and the hydrophilic balance.

It is possible to perform the reaction in conditions of a temperature of 0° C. or higher and 70° C. or lower, and time of 30 min or more and 6 hours or less, in a case of using a chloride.

The coupling agent-derived hydrolysable group in the reactant and the functional group of the surface of the core particles 71 are reacted by adding the precursor 72A that is the reactant obtained as above to the liquid medium 8 in which the core particles 71 are dispersed. As a result, it is possible to introduce the siloxane compound 72 to the surface of the core particles 71.

When the precursor 72A is reacted with the functional group of the surface of the core particles 71, it is preferable that 8 wt % or more and 50 wt % or less of the precursor 72A be added with respect to the weight of the core particles 71, and more preferable that 8 wt % or more and 40 wt % or less be added. In so doing, electrophoretic particles 170 with still superior dispersibility are obtained.

From the viewpoint of reliably performing the reaction of the precursor 72A and the surface of the core particles 71, that is, from the viewpoint of chemical bonding between the siloxane compound 72 and the core particles 71 occurring, it is preferable that reaction temperature of the reaction be 100° C. or higher and 200° C. or lower, and 120° C. or higher and 180° C. or lower is more preferable, and further it is preferable that the reaction time of the reaction be 1 hour or more and 10 hours or less, and 2 hours or more and 8 hours or less is more preferable. In contrast, when the reaction temperature is too low or the reaction time is too short, there are cases in which the chemical bonding of the siloxane compound 72 and the core particles 71 is insufficient according to the type of precursor 72A and the core particles 71, whereas when the reaction temperature is too high or the reaction time is too long, an increased effect of performing the reaction of the precursor 72A and the surface of the core particles 71 is not obtained and there is concern of not only the waste increasing, but also of the siloxane compound 72 bonded to the core particles 71 being damaged according to the type of siloxane compound 72.

According to the method of introducing the siloxane compound 72 to the surface of the core particles 71 as above, after obtaining the reactant by reacting the siloxane bond-containing substance with the coupling agent in advance, a process of reacting the reactant with the surface of the core particles 71 is passed through. Therefore, as described above, it is possible for the reaction chance between the siloxane bond-containing substance and the coupling agent to sufficiently ensured when generating the reactant, and for the reaction probability to be improved. As a result, it is possible for the yield of the reactant to be increased.

In contrast, in a case in which, after the coupling agent is introduced to the core particles and modified, the siloxane bond-containing substance is added thereto and a process of reacting the siloxane bond-containing substance and the coupling agent is passed through, it is difficult to control the reaction frequency of the reactive functional group of the coupling agent introduced to the core particles and the reactive functional group of the siloxane bond-containing substance. Therefore, it is difficult to strictly adjust the introduction amount of the siloxane compound 72. In particular, because the siloxane bond-containing substance has a straight chain molecular structure as a long chain, the reactive functional group has a tendency toward the probability of reacting with another functional group becoming lower, in order to supplement the lowering of the probability, it is necessary to add as much coupling agent as possible in advance with respect to the core particles. As a result, the charging characteristics derived from the core particles cancel each other out through large amounts of the coupling agent. Accordingly, if the siloxane compound is only introduced, it is difficult to sufficiently achieve both the dispersibility and the charging characteristics.

Meanwhile, in the embodiment, by reliably reacting the siloxane bond-containing substance and the coupling agent in advance, the introduction amount of the obtained reactant is easily controlled with respect to the core particles 71. It is thought that one cause is because the coupling agent-derived hydrolysable group is multi-functional, the reaction probability with the surface of the core particles 71 easily increases, and, furthermore, the amount of the siloxane compound 72 introduced to the core particles 71 is easily strictly adjusted by reacting the reactant in an amount according to the amount of the siloxane compound 72 to be introduced with respect to the surface of the core particles 71.

In the first bonding step [1], because the siloxane compound 72 is chemically bonded to the surface of the core particles 71, the bond between the siloxane compound 72 and the surface of the core particles 71 is strongly fixed, and it is possible to prevent the siloxane compound 72 from separating from the surface of the core particles 71 in the first removing step [2] or the second removing step [4], described later. As a result, it is possible to effectively reduce the conductivity of the dispersion liquid obtained in the first removing step [2] and the second removing step [4] and the conductivity of the dispersion liquid 100 finally obtained while realizing the dispersibility (dispersibility of the electrophoretic particles 170) of the core particles 71 obtained after the first removing [2] or the second removing step [4].

Because the siloxane compound 72 includes a linking structure in which a plurality of siloxane bonds are linked in series, it is possible for the dispersibility of the electrophoretic particles 170 finally obtained to be improved. It is possible for the amount of the siloxane compound 72 that bonds with the surface of the core particles 71 to be reduced, and the area of the region to which the charge control group 73 is able to be introduced on the surface of the core particles 71 to be increased, and, as a result, it is possible for the breadth of control of the charging properties of the electrophoretic particles 170 to be increased due to the charge control group 73.

### [2] First Removing Step (Excess Polymer Chain-Containing Compound Removing Step)

2-1

Next, the precursor 72A not bonded to the core particles 71 is removed. In so doing, as shown in FIG. 19C, it is possible to attain a state in which the electrophoretic particles 170 are dispersed in the dispersion medium 8A, without excess precursor 72A being present.

As the method for removing the precursor 72A in the first removing step [2], although not particularly limited, it is preferable that first removing step [2] be performed while maintaining a state (state of contact between the core particles 71 and the dispersion medium 8A) in which core particles 71 to which the siloxane compound 72 is bonded are present in the dispersion medium 8A without drying and hardening. In so doing, in the first removing step [2], it is possible for damage to or aggregation of the core particles 71 to which the siloxane compound 72 is bonded to be effectively suppressed. In the specification, the wording “the core particles 71 are not dried and hardened” indicates maintaining a state in which the modifier bonded to the core particles 71 is dispersed in the dispersion medium 8A. If the volume of the liquid medium 8A included in the system is 50% or more of the volume of the core particles 71, it is possible for the state in which the modifier bonded to the core particles 71 is dispersed in the liquid medium 8A to be maintained. Thus, in the method of manufacturing an electrophoresis dispersion liquid of the invention, it is preferable that the volume of the dispersion medium 8A be managed so as to not drop below 50% of the volume of the core particles 71.

Although it is possible to use the same solvent as the liquid medium 8 or dispersion medium 7 described above as the liquid medium 8A, a solvent different to the liquid medium 8 or the dispersion medium 7 is preferably used.

Specifically, it is preferable that first removing step [2] include a step for washing the core particles 71 to which the siloxane compound 72 is bonded using a new dispersion medium 8A. In so doing, in the first removing step [2], it is possible to comparatively simply maintain the state which the liquid medium 8A is present with the core particles 71 to which the siloxane compound 72 is bonded without drying and hardening. In a case of using the same solvent as the dispersion medium 7 as the liquid medium 8A, it is possible for the unnecessary components in the dispersion medium 7 of the dispersion liquid 100 finally obtained to be effectively reduced.

Examples of the washing method, although not particularly limited, include a method using a filter and a method using centrifugation. A solvent different to the liquid medium 8A is preferably used as the washing solvent. In this case, after washing using the washing solvent different to the liquid medium 8A, washing is preferably performed using the liquid medium 8A, and the washing solvent substituted with the liquid medium 8A. In this case, it is preferable that a washing solvent have the same characteristics (in particular, electrical characteristics) as the dispersion medium 8A.

It is preferable that washing be repeated a plurality of times. In so doing, it is possible to more reliably prevent excess precursor 72A from remaining. For example, it is preferable that the washing be repeated until the volume resistivity of the dispersion liquid obtained after the first removing step [2] is 1011 Ω·cm or more.

It is preferable that the first removing step [2] be performed in temperature conditions of less than the boiling point of the liquid medium 8. In so doing, in the first removing step [2], it is possible to comparatively simply maintain the state which the liquid medium 8 is present with the core particles 71 to which the siloxane compound 72 is bonded without drying and hardening. From the same viewpoint, it is preferable that the first removing step [2] be performed at atmospheric pressure or a higher pressure, and, in particular, from the viewpoint of simplifying the facilities, performing at atmospheric pressure is preferable.

According to the first removing step [2] described above, because the siloxane compound 72 not bonded to the core particles 71 or the precursor 72A thereof is removed after the first bonding step [1], it is possible to reduce the siloxane compound 72 or the precursor 72A thereof from remaining in the obtained dispersion liquid. As a result, it is possible to reduce the conductivity of the dispersion liquid 100 finally obtained. By reducing the excess precursor 72A remaining in the dispersion liquid obtained in the first removing step [2], it is possible for bonding of the core particles 71 and the charge control group 73 to be suitably performed in the second bonding step [3], described later.

The first removing step [2] is preferably not performed, as necessary. In this case, it is possible to remove the excess precursor 72A in the second removing step [4], described later.

### [3] Second Bonding Step (Charge Control Group Bonding Step)

Next, as shown in FIG. 19D, the precursor 73A of the charge control group 73 is added. In the dispersion medium 8A, by the precursor 73A and the surface of the core particles 71 being reacted, the charge control group 73 is chemically bonded to the surface of the core particles 71. In so doing, a dispersion liquid is obtained in which electrophoretic particles 170 in which the siloxane compound 72 and the charge control group 73 are bonded to the surface of the core particles 71 are dispersed in the liquid medium 8A.

The precursor 73A is a coupling agent having the charge control group 73 (polarization group), and for example, is synthesized as below.

The ring structure-containing substance including a portion (part of ring structure to which substituent is bonded) of the polarization group and the coupling agent including the remainder (spacer portion) of the polarization group are reacted. In so doing, the coupling agent having the structure of the polarization group is obtained as the precursor 73A. The reaction is between a reactive functional group included in the ring structure-containing substance and a reactive functional group included in the coupling agent. In so doing, the ring structure-containing substance is modified by the coupling agent, and the coupling agent-derived hydrolysable group is positioned on one terminal end of the obtained reactant.

It is possible for the reaction of the ring structure-containing substance and the coupling agent to be performed by adding a sufficient amount of the coupling agent that includes a reactive functional group with respect to the ring structure-containing substance that includes a reactive functional group. In so doing, it is possible for the reaction probability between the ring structure-containing substance and the coupling agent to be improved, and for the yield of the reactant to be particularly improved.

The ring structure-containing substance is preferably any substance if it includes a part with a ring structure (electron absorbing group or electron donating group) in which the substituent described above is bonded and a reactive functional group able to react with the coupling agent. Any reactive functional group is preferably used if it includes a reactive functional group such as an amino group, an epoxy group, a carboxyl group, a hydroxyl group, a mercapto group, an isocyanate group, a carbinol group, and an acid chloride. Specific examples of the ring structure-containing substance having a carboxyl group as the reactive functional group include the carboxylic acid represented, for example, the following formulae (a-1) to (a-7).

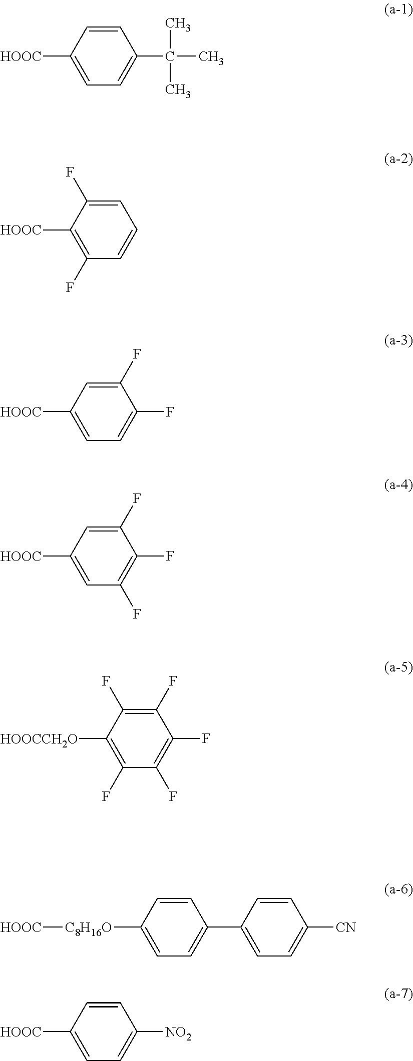

Meanwhile, any coupling agent that includes a remainder (spacer portion) of the polarization group is preferably used if it includes a reactive functional group such as an amino group, an epoxy group, a sulfide group, a vinyl group, an acryloxy group, a methacryloxy, and a mercapto group. Specifically, examples thereof include a silane coupling agent and a titanium coupling agent.

The coupling agent preferably includes two or more types from the above-described reactive functional groups.

It is preferable that the addition amount of the coupling agent be set to an amount that includes one equivalent or more of the reactive functional group with respect to the reactive functional group in the ring structure-containing substance, and being set to an amount including 1.5 equivalents or more of the reactive functional group is more preferable.

FIG. 21A shows an example of a case using an aromatic carboxylic acid as the ring structure-containing substance, and using the silane coupling agent as the coupling agent.

In this way, in the second bonding step [3], by the precursor 73A of the charge control group 73 and the surface of the core particles 71 being reacted in the dispersion medium 8A, the charge control group 73 is chemically bonded to the surface of the core particles 71. In so doing, the bond between the charge control group 73 and the surface of the particles 71 is strongly fixed, it is possible to prevent the charge control group 73 from being separated from the surface of the core particles 71 in the second removing step [4]. As a result, it is possible to effectively reduce the conductivity of the dispersion liquid obtained in the second removing step [4] and the conductivity of the dispersion liquid 100 finally obtained while realizing the dispersibility (dispersibility of the electrophoretic particles 170) of the core particles 71 obtained after the second removing steps [4].

### [4] Second Removing Step (Excess Charge Control Group Removing Step)

4-1

Next, the precursor 73A not bonded to the core particles 71 is removed. In so doing, as shown in FIG. 19E, it is possible to attain a state in which the electrophoretic particles 170 are dispersed in the dispersion medium 7, without excess precursor 73A being present. Concentration adjustment is performed as necessary, and, as shown in FIG. 19F, the dispersion liquid 100 is obtained. In so doing, it is possible to reduce the excess precursor 73A remaining in the obtained dispersion liquid 100. As a result, it is possible to reduce the conductivity of the dispersion liquid 100 finally obtained.

As the method for removing the precursor 73A in the second removing step [4], although not particularly limited, it is preferable that the step be performed while maintaining a state which core particles 71 to which the charge control group 73 is bonded are present in the dispersion medium 7 without being dried and hardened. In so doing, in the second removing step [4], it is possible for damage to or aggregation of the core particles 71 to which the charge control group 73 is bonded to be effectively suppressed.

Specifically, it is preferable that the second removing step [4] include a step of washing the core particles 71 to which the charge control group 73 is bonded using the dispersion medium 7. In so doing, in the second removing step [4], it is possible to comparatively simply maintain the state which the dispersion medium 7 is present without the core particles 71 to which the charge control group 73 is bonded without drying and hardening. It is possible to effectively reduce unnecessary components mixed into the dispersion medium 7 of the dispersion liquid 100 finally obtained.

Examples of the washing method, although not particularly limited, include a method using a filter and a method using centrifugation. A solvent different to the dispersion medium 7 is preferably used as the washing solvent. In this case, after washing using the washing solvent different to the dispersion medium 7, washing is performed using the dispersion medium 7, and the washing solvent is preferably substituted with the dispersion medium 7. In this case, it is preferable that a washing solvent having the same characteristics (in particular, electrical characteristics) as the dispersion medium 7.

It is preferable that washing be repeated a plurality of times. In so doing, it is possible to more reliably prevent excess precursor 73A from remaining. For example, it is preferable that the washing be repeated until the volume resistivity of the dispersion liquid obtained after the second removing step [4] is 1011 Ω·cm or more.

By the volume resistivity of the dispersion liquid obtained after the second removing step [4] being 1011 Ω·cm or more, it is possible to make the volume resistivity of the dispersion liquid 100 finally obtained 1011 Ω·cm or more.

It is preferable that the second removing step [4] be performed in temperature conditions of less than the boiling point of the dispersion medium 7. In so doing, in the second removing step [4], it is possible to comparatively simply maintain the state which the dispersion medium 7 is present without the core particles 71 to which the charge control group 73 is bonded without drying and hardening. From the same viewpoint, it is preferable that the second removing step [4] be performed at atmospheric pressure or a higher pressure, and, in particular, from the viewpoint of simplifying the facilities, performing at atmospheric pressure is preferable.

According to the second removing step [4] described above, because the charge control group 73 not bonded to the core particles 71 or the precursor 73A thereof is removed after the second bonding step [3], it is possible to reduce the excess charge control group 73 or the precursor 73A thereof from remaining in the obtained dispersion liquid. As a result, it is possible to reduce the conductivity of the dispersion liquid 100 finally obtained.

As described above, it is possible to obtain the dispersion liquid 100.

According to such a method of manufacturing the dispersion liquid 100, it is possible to independently introduce the siloxane compound 72 and the charge control group 73 to the surface of the core particles 71. Therefore, it is possible for the obtained electrophoretic particles 170 of the electrophoresis dispersion liquid 100 to contribute charging properties through the charge control group 73, and the dispersibility in the dispersion medium 7 is improved due to the siloxane compound 72. It is possible to control the charging properties of the electrophoretic particles 170 by adjusting the type, introduction amount, or the like of the of charge control group 73. Therefore, regardless of the type of core particles 71, it is possible to exhibit a desired polarity or the charging characteristics of the charging amount.

### Fourth Embodiment of Method of Manufacturing Electrophoresis Dispersion Liquid

Next, a fourth embodiment of the method of manufacturing an electrophoresis dispersion liquid of the invention will be described. Below, an example of using the charging group such as shown in the above-described FIG. 16 as the charge control group is described.

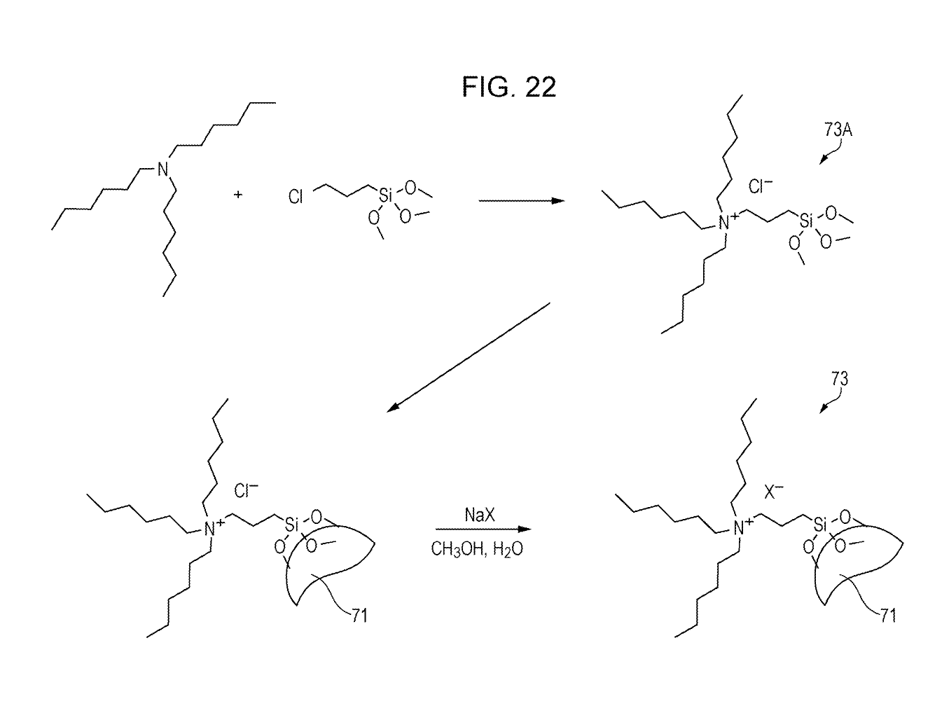

FIG. 22 is a diagram for describing an example of a method of manufacturing the charge control group (polarization group) in the fourth embodiment of the method of manufacturing an electrophoresis dispersion liquid of the invention.

In the description below, description will be given focusing on the points of difference with the above-described embodiment and description of the points of similarity will not be made.

In a case of using the charging group as the charge control group 73, examples of the method of introducing the charge control group 73 to the surface of the core particles 71 include, in the above-described method [B], a method of [S1] introducing the precursor 73A that is the charging group forming compound to the core particles 71 via the coupling agent-derived structure and [S2] thereafter, performing ion exchange on the counter ion of the ion pair, as necessary, or a method of introducing the coupling agent-derived structure to the surface of the core particles 71 after performing ion exchange on the counter ion of the ion pair, as necessary, with respect to the precursor 73A. In the description below, the former method is described as representative.

### [S1]

First the precursor 73A that is the charging group forming compound for forming the charge control group 73 is synthesized. FIG. 22 is an example of reacting a silane coupling agent with a compound including a tertiary amine (trihexylamine), and synthesizing the charging group forming compound including an ion pair of a quaternary ammonium cation and an X-counter anion. Examples of the X-counter anion include anions including a structure, such as in the formulae (D-4) to (D-6).

Among these, in a case in which silane coupling agent is reacted with the compound including a tertiary amine, it is possible for the yield of the quaternary ammonium cation to be increased by using a sufficient amount of the silane coupling agent.

Examples of the silane coupling agent used in this case include a halogenated silane coupling agent represented by the following formulae (H-1) to (H-5).

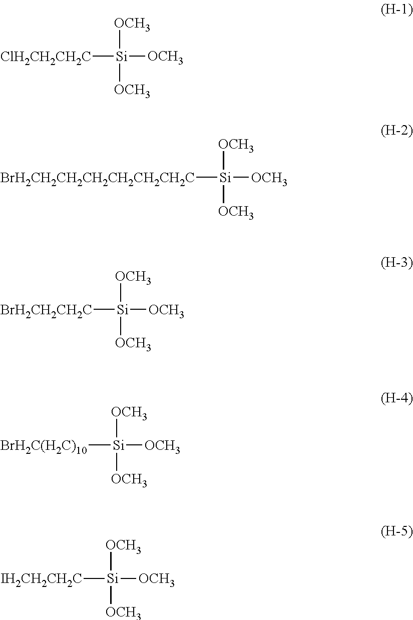

Examples of the reactive functional group of the coupling agent used include a halogen group, such as a chloro group, a bromo group, and an iodine group.

As described above, since the structure between the hydrolysable group of the coupling agent and the reactive functional group is the main skeleton of the charge control group 73, the structure of the coupling agent is selected, as appropriate, according to the structure of the main skeleton of the charge control group 73 to be manufactured, when selecting the type of coupling agent. For example, the type of coupling agent is preferably selected so that the total number of carbon atoms in the main skeleton is within the above-described range.

### [S2]

Next, the core particles 71 are added to the liquid that includes the precursor 73A obtained in the above-described step [S1]. In so doing, as shown in FIG. 16, the coupling agent-derived hydrolysable group and the functional group of the surface of the core particles 71 are reacted in the precursor 73A. As a result, it is possible to introduce the precursor 73A to the surface of the core particles 71.

Thereafter, the ion exchange reaction is performed on the core particles 71 to which the precursor 73A is introduced. Through the ion exchange reaction adding ions of the exchange subject in the liquid including the core particles 71, the counter ion of the ion pair is exchanged according to the difference in the adsorptivity due to the type of ion. As a result, as shown in FIG. 22, the Cl— that is the counter ion of the precursor 73A is exchanged with the X—, and the charge control group 73 is obtained.

It is possible for the charge control group 73 to be introduced to the surface of the core particles 71 as above.

### Examples

Next, a specific example of the invention of the configuration that includes the electrophoretic particles 170 of the second embodiment will be described.

### 1. Method of Manufacturing Electrophoresis Dispersion Liquid

The electrophoresis dispersion liquid is manufactured as follows. Each reference example, and the manufacturing conditions in each example and each reference example are shown in Table 4.

### Embodiment 66

[1]

As above, the siloxane compound and the charge control group are manufactured.

### Manufacturing of Precursor of Siloxane Compound

First, a modified silicone oil represented by the following formula (1), triethylamine, and dichloromethane are mixed and stirred in a round bottomed flask.

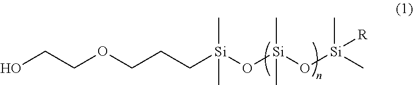

[In formula (1), n is 50 to 300. R is an alkyl group (butyl group).]

Next, 4-pentenoyl chloride is added dropwise to the obtained mixture. Thereafter, the mixture was stirred at room temperature.

Hexane is added after distilling the dichloromethane. The precipitated solids are filtered, the solvent is volatilized and removed from the liquid, and the reactant between the modified silicone oil and the 4-pentenoyl chloride is obtained.

First, the obtained reactant, a silane coupling agent that includes a reactive functional group of one equivalent or more with respect to a modified silicone oil-derived reactive functional group included therein, and toluene are mixed in a round bottomed flask, and the platinum catalyst is added thereto. The mixture is left in a state of being stirred, and heated. Next, the mixture is cooled to room temperature, the solvent removed under reduced pressure, and the residue dried. As above, the reactant of the compound to which the graft chain is introduced to the silicone oil and the silane coupling agent (coupling agent that includes a siloxane compound structure) shown in formula (2) is obtained as the precursor of the siloxane compound.

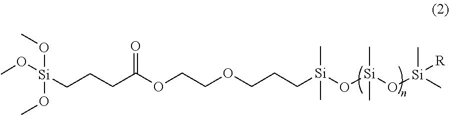

[In formula (2), n is 50 to 300. R is an alkyl group (butyl group).]

### Manufacturing of Precursor of Charge Control Group

First, the carboxylic acid represented by the following formula (6), the 3-aminopropyltrimethoxysilane (silane coupling agent), 1-ethyl-3-(3-dimethylaminopropyl)-carbodiimide hydrochloride (EDC) as the condensation agent for forming the amide bond, 4-(dimethyl amino)pyridine (DMAP), and anhydrous methylene chloride are mixed, and the amino group and the carboxylic acid are condensed. In so doing, the charge control group (precursor) is obtained.

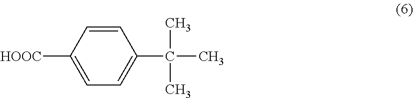

[2]

Next, the siloxane compound obtained in [1] above and the charge control group are used, and, as below, the polymer chain-containing compound bonding step, the first removing step (excess polymer chain-containing compound removing step in the example), the charge control group bonding step, the second removing step (excess charge control group removing step in the example) are sequentially performed, and the electrophoresis dispersion liquid is obtained.

### First Bonding Step (Polymer Chain-Containing Compound Bonding Step in the Example)

First, 3 g of titania mother particles (“CR-97”, manufactured by Ishihara Sangyo Kaisha, Ltd.) as mother particles, and 15 g of silicone oil (“KF-96L-2cs”, manufactured by Shin-Etsu Chemical Co., Ltd.) as the liquid medium were introduced to a glass container, mixed, and the titania mother particles dispersed in the liquid medium.

Thereafter, 0.3 g of the siloxane compound obtained in [1] is added to the obtained mixture.

Next, a dispersion process is performed on the obtained mixture using an ultrasound washing machine.

A heat-insulating material covers the container, and the mixture is heated and stirred at a temperature of 180° C. (reaction temperature) using a hot stirrer (“1-5477-02”, manufactured by AS ONE Corporation). In so doing, the surface of the titania mother particles and the precursor of the siloxane compound are reacted, and a dispersion liquid in which the particles in which the siloxane compound is bonded to the surface of the titania mother particles are dispersed in the liquid medium is obtained.

### First Removing Step (Excess Polymer Chain-Containing Compound Removing Step)

After the obtained dispersion liquid (reaction liquid) is returned to room temperature, a polar solvent (tetrahydrofuran) is added, removal of the supernatant liquid after centrifugation is repeated, and the polar solvent is finally substituted with the silicone oil (“KF96L-2cs” manufactured by Shin-Etsu Chemical Co., Ltd.). In so doing, a dispersion liquid is obtained in which excess precursor of the siloxane compound is removed.

### Second Bonding Step (Charge Control Group Bonding Step in Example

Next, after the charge control group obtained in [1] is added to the dispersion liquid (reaction liquid) obtained in the first removing step so as to reach 0.5 wt % of the weight of the particles, the precipitate at the bottom portion of the container is again stirred.

A heat-insulating material covers the container, and the mixture is heated and stirred at a temperature of 180° C. (reaction temperature) using a hot stirrer (“1-5477-02”, manufactured by AS ONE Corporation). In so doing, the surface of the titania mother particles and charge control group are reacted, and a dispersion liquid (pre-washing electrophoresis dispersion liquid) in which the electrophoretic particles in which the siloxane compound and the charge control group are bonded to the surface of the titania mother particles are dispersed in the liquid medium is obtained.

### Second Bonding Step (Excess Charge Control Group Removing Step in Example)

The obtained dispersion liquid is transferred to a centrifuge bottle, and, after weight adjustment with a washing solvent (“KF-96L-2cs” manufactured by Shin-Etsu Silicone), the mixture is centrifuged using a centrifuge (“High speed Refrigerated Micro Centrifuge MX-207”, manufactured by TOMY Digital Biology Co., Ltd.) and the supernatant liquid is decanted (first washing).

After the same washing is repeated, the washing solvent is added to the precipitate, and adjusted to 40 wt %. In so doing, a dispersion liquid (post-washing electrophoresis dispersion liquid) in which the electrophoretic particles in which the siloxane compound and the charge control group are bonded to the titania mother particles are suspended in the washing solvent (dispersion medium) is obtained.

### Examples 67 and 68

Other than the addition amount of the charge control group in the bonding step being 2 wt %, the electrophoresis dispersion liquid of Example 67 was obtained similarly to the above-described Example 66. Other than the addition amount of the charge control group in the bonding step being 5 wt %, the electrophoresis dispersion liquid of Example 68 was obtained similarly to the above-described Example 66.

### Examples 69 to 74

Other than using the carboxylic acid represented by the following formulae (7) to (12) as the carboxylic acid using in generation of the charge control group, the electrophoresis dispersion liquid of Examples 69 to 74 was obtained similarly to the above-described Example 68.

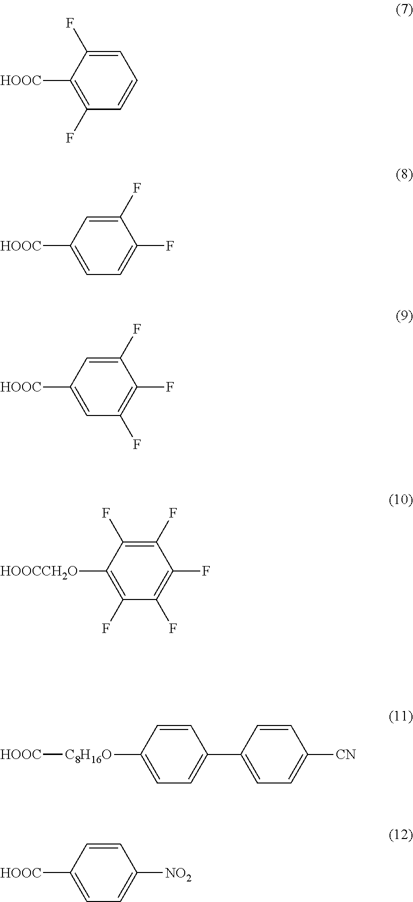

### Examples 75 to 77

Other than using the siloxane compound represented by the following formula (4) as the siloxane compound, the electrophoresis dispersion liquid of Example 75 was obtained similarly to the above-described Example 68. Other than using the siloxane compound represented by the following formula (4) as the siloxane compound, the electrophoresis dispersion liquid of Example 76 was obtained similarly to the above-described Example 72. Other than using the siloxane compound represented by the following formula (4) as the siloxane compound, the electrophoresis dispersion liquid of Example 77 was obtained similarly to the above-described Example 73.

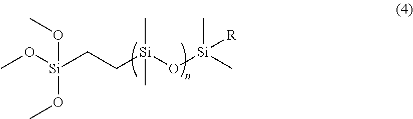

[In formula (4), n is 50 to 500. R is an alkyl group (butyl group).]

Generation of the silicone compound represented by formula (4) is performed as below.

First, the silicone oil shown by formula (3), a silane coupling agent that includes a reactive functional group of one equivalent or more with respect to reactive silicone oil-derived functional group included therein, and toluene are mixed in a round bottomed flask, and the platinum catalyst is added thereto. The mixture is left in a state of being stirred, and heated. Next, the mixture is cooled to room temperature, the solvent removed under reduced pressure, and the residue dried. As above, the reactant of the modified silicone oil and the silane coupling agent (coupling agent that includes a siloxane compound structure) shown in formula (4) is obtained as the precursor of the silicone compound.

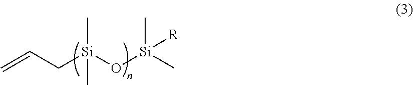

[In the formula (3), n is 50 to 500. R is an alkyl group (butyl group).]

### Examples 78 to 80

Other than using a mixed solution of 15 g of silicone oil (manufactured by Shin-Etsu Chemical Co., Ltd., “KF-96L-2cs”) and 0.003 g of water as the liquid medium used in the bonding step, the electrophoresis dispersion liquids of Examples 78 to 80 were obtained similarly to the above-described Examples 75 to 77.

### Example 81

Other than the order of the charge control group bonding step and the polymer chain-containing compound bonding step being switched, performing the charge control group bonding step in the first bonding step, and performing the polymer chain-containing compound bonding step in the second bonding step, the electrophoresis dispersion liquid of Example 81 was manufactured similarly to the above-described Example 68.

In the Example 81, the first and second bonding steps were performed as below.

### First Bonding Step (Charge Control Group Bonding Step in Example

First, 3 g of titania mother particles (“CR-97”, manufactured by Ishihara Sangyo Kaisha, Ltd.) as mother particles, and 15 g of silicone oil (“KF-96L-2cs”, manufactured by Shin-Etsu Chemical Co., Ltd.) as the liquid medium were introduced to a glass container, mixed, and the titania mother particles were dispersed in the liquid medium.

Thereafter, the charge control group was added to the obtained mixture to reach 5 wt % with respect to the weight of the particles.

Next, a dispersion process was performed on the obtained mixture using an ultrasound washing machine.

A heat-insulating material covered the container, and the mixture was heated and stirred at a temperature of 180° C. (reaction temperature) using a hot stirrer (“1-5477-02”, manufactured by AS ONE Corporation). In so doing, the surface of the titania mother particles and the charge control group were bonded, and a dispersion liquid in which the particles in which the charge control group is bonded to the surface of the titania mother particles are dispersed was obtained.

### Second Bonding Step (Polymer Chain-Containing Compound Bonding Step in Example)

After adding 0.3 g of the siloxane compound to the dispersion liquid (reaction liquid) obtained in the first removing step, the precipitate at the bottom portion of the container was again stirred.

A heat-insulating material covered the container, and the mixture was heated and stirred at a temperature of 180° C. (reaction temperature) using a hot stirrer (“1-5477-02”, manufactured by AS ONE Corporation). In so doing, the surface of the titania mother particles and the siloxane compound were reacted, and a dispersion liquid (pre-washing electrophoresis dispersion liquid) in which the electrophoretic particles in which the siloxane compound and the charge control group are bonded to the surface of the titania mother particles are dispersed in the liquid medium was obtained.

### Examples 82 to 84

Other than not performing the first removing step, and performing the polymer chain-containing compound bonding step and the charge control group bonding step at the same time, the electrophoresis dispersion liquid of Example 82 was obtained similarly to the above-described Example 68. Other than not performing the first removing step, and performing the polymer chain-containing compound bonding step and the charge control group bonding step at the same time, the electrophoresis dispersion liquid of Example 83 was obtained similarly to the above-described Example 72. Other than not performing the first removing step, and performing the polymer chain-containing compound bonding step and the charge control group bonding step at the same time, the electrophoresis dispersion liquid of Example 84 was obtained similarly to the above-described Example 73.

In Examples 82 and 84, the polymer chain-containing compound bonding step and the charge control group bonding step were performed as below.

First, 3 g of titania mother particles (“CR-97”, manufactured by Ishihara Sangyo Kaisha, Ltd.) as mother particles, and 15 g of silicone oil (“KF-96L-2cs”, manufactured by Shin-Etsu Chemical Co., Ltd.) as the liquid medium were introduced to a glass container, mixed, and the titania mother particles dispersed in the liquid medium.

Thereafter, 0.3 g of the siloxane compound was added to the obtained mixture, and the charge control group was further added so as to reach 5 wt % with respect to the weight of the particles.

Next, a dispersion process was performed on the obtained mixture using an ultrasound washing machine.

A heat-insulating material covered the container, and the mixture was heated and stirred at a temperature of 180° C. (reaction temperature) using a hot stirrer (“1-5477-02”, manufactured by AS ONE Corporation). In so doing, the surface of the titania mother particles and the siloxane compound and the charge control group are reacted, and a dispersion liquid (pre-washing electrophoresis dispersion liquid) in which the particles in which the siloxane compound and the charge control group are bonded to the surface of the titania mother particles are dispersed in the liquid medium was obtained.

### Examples 85 to 88

Other than using the titanium nitride particles as the mother particles, the electrophoresis dispersion liquid of Example 85 was obtained similarly to Example 68. Other than using the titanium nitride particles as the mother particles, the electrophoresis dispersion liquid of Example 86 was obtained similarly to Example 73. Other than using the titanium nitride particles as the mother particles, the electrophoresis dispersion liquid of Example 87 was obtained similarly to Example 82. Other than using the titanium nitride particles as the mother particles, the electrophoresis dispersion liquid of Example 88 was obtained similarly to Example 84.

### Examples 89 and 90

Other than not performing the first and second removing steps, the electrophoresis dispersion liquid of Example 89 was obtained similarly to Example 68. Other than not performing the first and second removing steps, the electrophoresis dispersion liquid of Example 90 was obtained similarly to Example 85.

### Reference Example 18

Other than not performing the second bonding step (charge control group bonding step) and the second removing step, the electrophoresis dispersion liquid of Reference Example 18 was obtained similarly to Example 66.

### Reference Example 19

Other than using a mixed solution of 15 g of the silicone oil (“KF96L-2cs” manufactured by Shin-Etsu Chemical Co., Ltd.) and 0.003 g of water as the liquid medium in the polymer chain-containing compound bonding step, and adding 5 wt % of the dispersant (“solsperse 18000” manufactured by Lubrizol Co., Ltd.), the electrophoresis dispersion liquid of Reference Example 19 was obtained similarly to the above-described Reference Example 18.

### Reference Example 20

Other than not performing the second bonding step (charge control group bonding step) and the second removing step, the electrophoresis dispersion liquid of Reference Example 20 was obtained similarly to Example 87.

### Reference Example 21

Other than using a mixed solution of 15 g of the silicone oil (“KF96L-2cs” manufactured by Shin-Etsu Chemical Co., Ltd.) and 0.003 g of water as the liquid medium in the polymer chain-containing compound bonding step, and adding 5 wt % of the dispersant (“solsperse 18000” manufactured by Lubrizol Co., Ltd.), the electrophoresis dispersion liquid of Reference Example 21 was obtained similarly to the above-described Reference Example 20.

### Reference Examples 22 and 23

The particles in a powdered state were obtained by drying the electrophoresis dispersion liquid obtained in Example 68 at 120° C. The particles were dispersed in the silicone oil (“KF96L-2cs” manufactured by Shin-Etsu Silicones Corporation”), and the electrophoresis dispersion liquid of Reference Example 22 was obtained. The particles in a powdered state are obtained by drying the electrophoresis dispersion liquid obtained in Example 87 at 120° C. The particles were dispersed in the silicone oil (“KF96L-2cs″ manufactured by Shin-Etsu Silicones Corporation”), and the electrophoresis dispersion liquid of Reference Example 23 was obtained.

### 2. Evaluation of Electrophoretic Particles

### 2.1 Evaluation of Dispersibility (Reflectivity)

The electrophoresis dispersion liquid of each Example and each reference example was poured into a pectinate electrode cell, and the inside of the cell was observed using an optical microscope. Samples confirmed to have dispersibility were further measured using a laser diffraction-scattering type particle size analyzer MT 3400 II, manufactured by Nikkiso Co., Ltd., and the dispersibility was evaluated according to the following evaluation standard.

B: no aggregation and is a monodispersion.
C: no aggregation, but is a polydispersion. Or aggregation is present, but is a monodispersion.
D: aggregation present and is a polydispersion.

In the evaluation standard, a case in which the volume average particle diameter (Mv) of the electrophoretic particles is 1.2 times or more with respect to the average particle diameter of the mother particles is determined to be a polydispersion.

### 2.2 Evaluation of Charging Characteristics (Mobility)

A predetermined voltage was applied between the pair of electrodes for each example and each reference example. At this time, the mobility [μm/s] of the electrophoretic particles was measured by measuring the time necessary for moving a predetermined distance.

### Evaluation Standard of Charging Characteristics

A: Mobility of electrophoretic particles of 10 or more.
B: Mobility of electrophoretic particles of 5 or more and less than 10.
C: Mobility of electrophoretic particles of 0 (where 0 is not included) or more and less than 5.
D: Movement of electrophoretic particles not observed, particles with different directions of movement mixed.

The minus symbol in the results in Table 1 signifies movement in the reverse direction when the movement direction of particles to which the minus symbol is not applied is taken as the standard.

### 2.3 Evaluation of Electrical Characteristics

A voltage was applied between a pair electrodes, and the volume resistivity ρv [Ω·cm] between the electrodes was measured.

### Evaluation Standard of Electrical Characteristics

B: ρv>1011
C: 109≦ρv≦1011
D: ρv<109

The results of the above evaluation are shown in Table 4. The various conditions in each of the examples and the reference examples described above are noted in Table 4. The “introduction ratio” disclosed in Table 4 is the change in weight when the electrophoretic particles obtained in each of the above-described examples and reference examples are headed from room temperature to 700 degrees (° C.) using thermogravimetric analysis (TGA).

TABLE 4

| | ELECTROPHORETIC PARTICLES | | | | | | | | | | | |
|---|---|---|---|---|---|---|---|---|---|---|---|---|
| | | SILOXANE | | CHARGE CONTROL | | | | | | EVALUATION RESULTS | | |
| | | COMPOUND (A) | | GROUP (B) | | | REACTION | | | | | VOL- |
| | | | INTRO- | STRUCTURE | INCORPORATION | INTRO- | INTRO- | | | | | UME |
| | CORE | STRUCTURE | DUCTION | (CARBOXYLIC | CONCEN- | DUCTION | DUCTION | WATER | ADDITIVE | | TRANSITION | RESIS- |
| | PARTICLES | (PRECURSOR) | RATE [%] | ACID) | TRATION [wt %] | RATE [%] | ORDER | ADDITION | [MASS %] | DISPERSIBILITY | DEGREE | TIVITY |
| EXAMPLE 66 | TiO₂ | FORMULA (2) | 1.5 | FORMULA (6) | 0.5 | 0.1 | A→B | NO | — | B | B | B |
| EXAMPLE 67 | TiO₂ | FORMULA (2) | 1.5 | FORMULA (6) | 2 | 1.1 | A→B | NO | — | B | A | B |
| EXAMPLE 68 | TiO₂ | FORMULA (2) | 1.5 | FORMULA (6) | 5 | 2.2 | A→B | NO | — | B | A | B |
| EXAMPLE 69 | TiO₂ | FORMULA (2) | 1.6 | FORMULA (7) | 5 | 0.8 | A→B | NO | — | B | C | B |
| EXAMPLE 70 | TiO₂ | FORMULA (2) | 1.6 | FORMULA (8) | 5 | 0.3 | A→B | NO | — | B | −C | B |
| EXAMPLE 71 | TiO₂ | FORMULA (2) | 1.8 | FORMULA (9) | 5 | 0.3 | A→B | NO | — | C | −C | B |
| EXAMPLE 72 | TiO₂ | FORMULA (2) | 1.7 | FORMULA (10) | 5 | 0.2 | A→B | NO | — | B | −B | B |
| EXAMPLE 73 | TiO₂ | FORMULA (2) | 1.5 | FORMULA (11) | 5 | 0.4 | A→B | NO | — | B | −A | B |
| EXAMPLE 74 | TiO₂ | FORMULA (2) | 1.4 | FORMULA (12) | 5 | 0.3 | A→B | NO | — | B | −C | B |
| EXAMPLE 75 | TiO₂ | FORMULA (4) | 1.5 | FORMULA (6) | 5 | 0.2 | A→B | NO | — | B | A | B |
| EXAMPLE 76 | TiO₂ | FORMULA (4) | 1.5 | FORMULA (10) | 5 | 0.1 | A→B | NO | — | B | C | B |
| EXAMPLE 77 | TiO₂ | FORMULA (4) | 1.4 | FORMULA (11) | 5 | 0.2 | A→B | NO | — | B | −A | B |
| EXAMPLE 78 | TiO₂ | FORMULA (4) | 1.6 | FORMULA (6) | 5 | 0.2 | A→B | YES | — | B | A | B |
| EXAMPLE 79 | TiO₂ | FORMULA (4) | 1.7 | FORMULA (10) | 5 | 0.1 | A→B | YES | — | B | C | B |
| EXAMPLE 80 | TiO₂ | FORMULA (4) | 1.9 | FORMULA (11) | 5 | 0.2 | A→B | YES | — | B | −A | B |
| EXAMPLE 81 | TiO₂ | FORMULA (2) | 1.0 | FORMULA (6) | 5 | 0.7 | B→A | NO | — | c | A | B |
| EXAMPLE 82 | TiO₂ | FORMULA (2) | — | FORMULA (6) | 5 | 1.3 | SAME TIME | NO | — | B | A | B |
| EXAMPLE 83 | TiO₂ | FORMULA (2) | — | FORMULA (10) | 5 | 1.1 | SAME TIME | NO | — | C | −B | B |
| EXAMPLE 84 | TiO₂ | FORMULA (2) | — | FORMULA (11) | 5 | 1.2 | SAME TIME | NO | — | B | −A | B |
| EXAMPLE 85 | TiN | FORMULA (2) | 3.5 | FORMULA (6) | 5 | 1.4 | A→B | NO | — | B | A | B |
| EXAMPLE 86 | TiN | FORMULA (2) | 3.5 | FORMULA (11) | 5 | 1.2 | A→B | NO | — | B | −A | B |
| EXAMPLE 87 | TiN | FORMULA (2) | — | FORMULA (6) | 5 | 5.1 | SAME TIME | NO | — | B | A | B |
| EXAMPLE 88 | TiN | FORMULA (2) | — | FORMULA (11) | 5 | 4.9 | SAME TIME | NO | — | C | −A | B |
| EXAMPLE 89 | TiO₂ | FORMULA (2) | 1.5 | FORMULA (6) | 5 | 2.5 | A→B (NO | NO | — | B | A | C |
| | | | | | | | WASHING) | | | | | |
| EXAMPLE 90 | TiN | FORMULA (2) | 3.5 | FORMULA (6) | 5 | 1.8 | A→B (NO | NO | — | B | A | C |
| | | | | | | | WASHING) | | | | | |
| REFERENCE | TiO₂ | FORMULA (2) | 1.5 | — | — | — | A ONLY | NO | — | B | D | B |
| EXAMPLE 18 | | | | | | | | | | | | |
| REFERENCE | TiO₂ | FORMULA (2) | 1.5 | — | — | — | A ONLY | YES | 5 | B | A | D |
| EXAMPLE 19 | | | | | | | | | | | | |
| REFERENCE | TiN | FORMULA (2) | 3.5 | — | — | — | A ONLY | NO | — | B | D | B |
| EXAMPLE 20 | | | | | | | | | | | | |
| REFERENCE | TiN | FORMULA (2) | 3.5 | — | — | — | A ONLY | YES | 5 | B | A | D |
| EXAMPLE 21 | | | | | | | | | | | | |
| REFERENCE | TiO₂ | FORMULA (2) | 1.5 | FORMULA (6) | 5 | 2.2 | A→B (DRY AND | NO | — | C | B | B |
| EXAMPLE 22 | | | | | | | HARDEN) | | | | | |
| REFERENCE | TiN | FORMULA (2) | 3.5 | FORMULA (6) | 5 | 1.4 | A→B (DRY AND | NO | — | D | D | B |
| EXAMPLE 23 | | | | | | | HARDEN) | | | | | |

### Electronic Apparatus

It is possible for the display device 20 including the electrophoresis dispersion liquid described above to be respectively incorporated into various types of electronic apparatuses. Examples of the electronic apparatus include e-paper, e-books, televisions, view finder-type or direct-view monitor-type video tape recorders, car navigation systems, pagers, electronic organizers, calculators, electronic newspapers, word processors, personal computers, workstations, video phones, POS terminals, and electronic apparatuses provided with touch panels.

An example of electronic paper will be specifically described from among these electronic apparatuses.

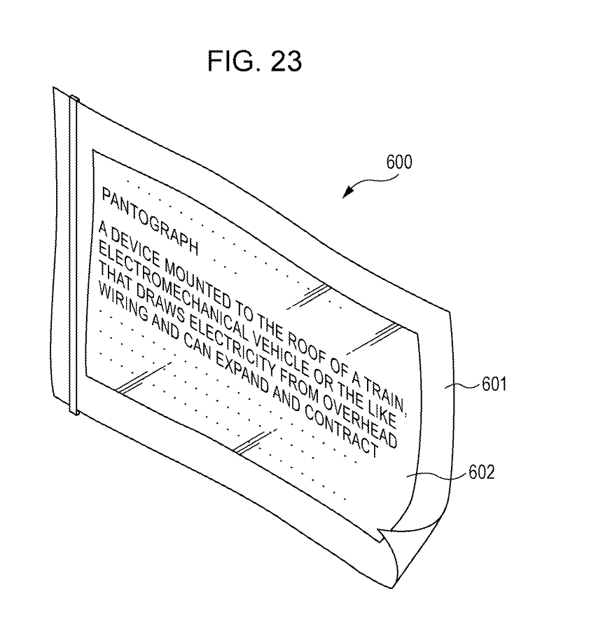

FIG. 23 is a perspective view showing an embodiment of a case where the electronic apparatus of the invention is applied to electronic paper.

The electronic paper 600 shown in FIG. 23 is provided with a main body 601 configured by a rewritable sheet having a similar texture and flexibility as paper, and a display unit 602. In such an electronic paper 600, the display unit 602 is configured by the display device 20 as described above.

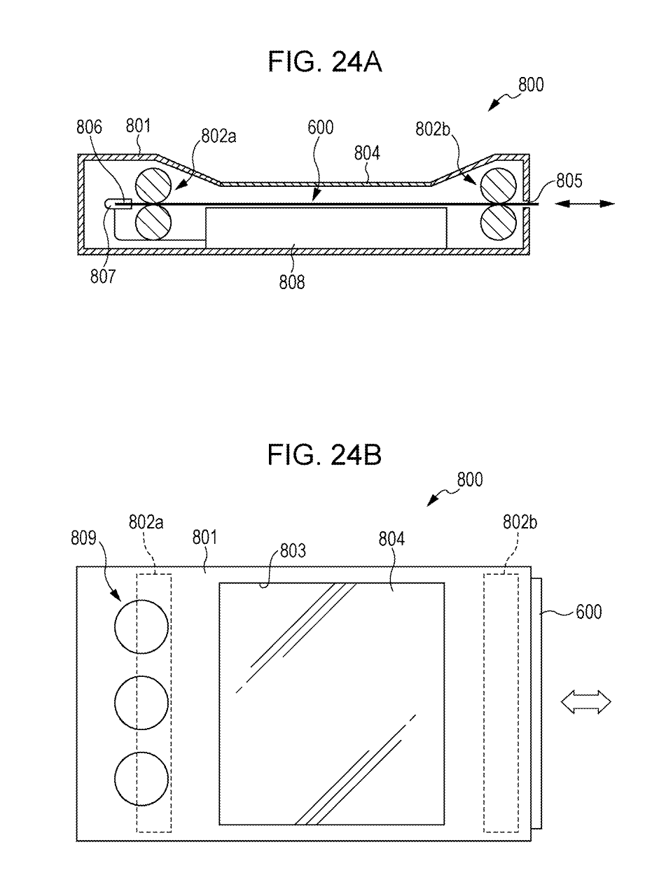

Next, description will be given of a case where the electronic apparatus of the invention is applied to a display. FIGS. 24A and 24B are diagrams showing an embodiment of a case where the electronic apparatus of the invention is applied to a display. Here, FIG. 24A is a cross-sectional view, and FIG. 24B is a plan view.

The display (display device) 800 shown in FIGS. 24A and 24B is provided with a main body unit 801, and the electronic paper 600 provided so as to be freely detachable with respect to the main body unit 801. The electronic paper 600 has the configuration described above, that is, the same configuration as shown in FIG. 23.

The main body unit 801 has an insertion port 805 allowing insertion of the electronic paper 600 formed in the side thereof (in FIG. 24A, the left side), and is also provided with two sets of transport roller pairs 802a and 802b in the interior thereof. When the electronic paper 600 is inserted inside the main body unit 801 through the insertion port 805, the electronic paper 600 is placed in the main body unit 801 in a state of being pinched by the transport roller pairs 802a and 802b.

At the display surface side of the main body unit 801 (in FIG. 24B, the front side of the paper surface), a rectangular hole portion 803 is formed and a transparent glass plate 804 is fitted into the hole portion 803. In so doing, it is possible to view the electronic paper 600 in a state of being placed in the main body unit 801 from outside the main body unit 801. That is, in the display 800, the display surface is configured by viewing the electronic paper 600 in a state of being placed in the main body unit 801 through the transparent glass plate 804.

A terminal unit 806 is provided at the insertion direction tip portion of the electronic paper 600 (in FIG. 24A, the left side), and a socket 807 to which the terminal unit 806 is connected in a state in which the electronic paper 600 is placed in the main body unit 801 is provided in the interior of the main body unit 801. A controller 808 and an operation unit 809 are electrically connected to the socket 807.

In the display 800, the electronic paper 600 is placed to be freely detachable from the main body unit 801, and may be carried and used in a state of being removed from the main body unit 801. In this manner, the convenience is improved.

Above, although the method of manufacturing an electrophoresis dispersion liquid, the electrophoresis dispersion liquid, the display device, and the electronic apparatus of the invention was described based on the embodiments shown, the invention is not limited thereto and the configuration of each part may be changed to an arbitrary configuration having the same function. In addition, in the invention, any other arbitrary constituent parts may be added. Each of the embodiments is preferably combined, as appropriate.

In the above-described examples, although an example of a case of using a siloxane compound having a silicone main chain as the compound that includes a polymer chain, there is no limitation thereto, and if the compound that includes a polymer chain has characteristics of increasing the dispersibility of particles with respect to dispersion medium, and chemically bonds by reacting with surface of the particles in the liquid medium, a polymer having a silicone side chain is preferably used.

The entire disclosure of Japanese Patent Application Nos. 2014-008135, filed Jan. 20, 2014 and 2014-008136, filed Jan. 20, 2014 are expressly incorporated by reference herein.

What is claimed is:

1. A method of manufacturing an electrophoresis dispersion liquid in which electrophoretic particles in which a compound that includes a polymer chain is bonded to the surface of the particles are dispersed in a dispersion medium, the method comprising:
bonding the compound to the surface of the particles in a liquid medium; and
removing the compound or a precursor thereof from particles not bonded to,
wherein, the removing is performed while maintaining a state in which the particles to which the compound is bonded contact the liquid medium.

2. The method of manufacturing an electrophoresis dispersion liquid according to claim 1,
wherein, in the bonding, the compound is chemically bonded to the surface of the particles by a precursor of the compound and the surface of the particles being reacted in the liquid medium.

3. The method of manufacturing an electrophoresis dispersion liquid according to claim 1,
wherein the liquid medium is the dispersion medium.

4. The method of manufacturing an electrophoresis dispersion liquid according to claim 1,
wherein, the liquid medium is different to the dispersion medium, and is compatible with the dispersion medium; and
adding the dispersion medium, and removing the liquid medium are further included, either during the removing or after the removing.

5. The method of manufacturing an electrophoresis dispersion liquid according to claim 4,
wherein the liquid medium has a higher viscosity than the dispersion medium.

6. The method of manufacturing an electrophoresis dispersion liquid according to claim 1,
wherein the number average molecular weight of the polystyrene conversion of the compound is 40,000 or more; and
in the bonding, 0.01 wt % or more and 0.1 wt % or less of water is added with respect to the weight of the liquid medium.

7. The method of manufacturing an electrophoresis dispersion liquid according to claim 1,
wherein the number average particle diameter of the particles is 50 nm or more and 150 nm or less; and
in the bonding, the weight of the liquid medium is 15 times or more and 60 times or less with respect to the weight of the particles.

8. The method of manufacturing an electrophoresis dispersion liquid according to claim 1,
wherein the number average particle diameter of the particles is 250 nm or more and 350 nm or less.

9. The method of manufacturing an electrophoresis dispersion liquid according to claim 8,
wherein the dynamic viscosity of the liquid medium is 10 mm²/s or more and 100 mm²/s or less.

10. The method of manufacturing an electrophoresis dispersion liquid according to claim 1,
wherein, in the bonding, 8 wt % or more and 50 wt % or less of the compound is added with respect to the weight of the particles.

11. The method of manufacturing an electrophoresis dispersion liquid according to claim 1,
wherein the volume resistivity of the dispersion liquid obtained after the removing is 1011 Ω·cm or more.

12. The method of manufacturing an electrophoresis dispersion liquid according to claim 1,
wherein the removing is performed under temperature conditions of less than the boiling point of the liquid medium or the dispersion medium.

13. The method of manufacturing an electrophoresis dispersion liquid according to claim 1,
wherein the removing further includes washing the particles to which the compound is bonded using the liquid medium or the dispersion liquid.

14. The method of manufacturing an electrophoresis dispersion liquid according to claim 1,
wherein the polymer chain includes a linking structure in which a plurality of siloxane bonds is linked in series.

15. The method of manufacturing an electrophoresis dispersion liquid according to claim 14,
wherein the polymer chain includes a straight chain molecular structure configured by a main chain including the linking structure and a side chain bonded to the main chain.

16. The method of manufacturing an electrophoresis dispersion liquid according to claim 14,
wherein the precursor is a reactant obtained by reacting a silicone oil and a coupling agent; and
a coupling agent-derived hydrolysable group and the surface of the particles are dehydration-condensation reacted in the bonding.

17. The method of manufacturing an electrophoresis dispersion liquid according to claim 14,
wherein the precursor is a silicone oil; and
a silicone oil-derived functional group and the surface of the particles are reacted in the bonding.

18. A method of manufacturing an electrophoresis dispersion liquid in which electrophoretic particles in which a polymer chain-containing compound is bonded to the surface of the particles are dispersed in a dispersion medium, the method comprising:
bonding the polymer chain-containing compound to the surface of the particles in the liquid medium;
bonding a charge control group to the surface of the particles; and
preparing the electrophoresis dispersion liquid in which the electrophoretic particles are dispersed in the dispersion medium, obtained through the bonding of the polymer chain-containing compound and the bonding of the charge control group,
wherein the particles maintain a state of contact with the liquid medium between the bonding of the polymer chain-containing compound and the bonding of the charge control group, and between the bonding of the charge control group and the preparing of the electrophoresis dispersion liquid.

19. The method of manufacturing an electrophoresis dispersion liquid according to claim 18,
wherein the bonding of the charge control group is performed after the bonding of the polymer chain-containing compound.

20. The method of manufacturing an electrophoresis dispersion liquid according to claim 18,
wherein the bonding of the charge control group is performed before the bonding of the polymer chain-containing compound.

21. A method of manufacturing an electrophoresis dispersion liquid in which electrophoretic particles in which a polymer chain-containing compound is bonded to the surface of the particles are dispersed in a dispersion medium, the method comprising:
bonding the polymer chain-containing compound to the surface of the particles in the liquid medium;
preparing the electrophoresis dispersion liquid in which the electrophoretic particles are dispersed in the dispersion medium, obtained through the bonding of the polymer chain-containing compound,
wherein the bonding of the polymer chain-containing compound is performed at the same time as bonding the charge control group to the surface of the particles; and
the particles maintain a state of contact with the liquid medium between the bonding of the polymer chain-containing compound and the preparing of the electrophoresis dispersion liquid.

22. The method of manufacturing an electrophoresis dispersion liquid according to claim 18, further comprising:
removing the excess polymer chain-containing compound or precursor thereof not bonded to the particles, after the bonding of the polymer chain-containing compound,
wherein, the removing of the excess polymer chain-containing compound is performed while maintaining a state in which the particles contact the liquid medium or the dispersion medium.

23. The method of manufacturing an electrophoresis dispersion liquid according to claim 18, further comprising:
removing the excess charge control group or a precursor thereof not bonded to the particles after the bonding of the charge control group,
wherein the removing of the excess charge control group is performed while maintaining a state in which the particles contact the liquid medium or the dispersion medium.

24. The method of manufacturing an electrophoresis dispersion liquid according to claim 18,
wherein, in the bonding of the polymer chain-containing compound, the polymer chain-containing compound is chemically bonded to the surface of the particles by the precursor of the polymer chain-containing compound and the surface of the particles being reacted in the liquid medium.

25. The method of manufacturing an electrophoresis dispersion liquid according to claim 18,
wherein the liquid medium is the dispersion medium.

26. The method of manufacturing an electrophoresis dispersion liquid according to claim 18,
wherein the liquid medium is different to the dispersion medium, and has compatibility with the dispersion medium.

27. The method of manufacturing an electrophoresis dispersion liquid according to claim 18,
wherein, in the bonding of the charge control group, the charge control group is chemically bonded to the surface of the particles by a precursor of the charge control group and the surface of the particles being reacted in the liquid medium.

28. The method of manufacturing an electrophoresis dispersion liquid according to claim 18,
wherein the charge control group is an organic group, includes a main skeleton and a substituent bonded to the main skeleton, and is a polarization group in which the electrons are biased to the particle side or the opposite side thereof of the main skeleton in a state in of being bonded to the particles.

29. The method of manufacturing an electrophoresis dispersion liquid according to claim 18,
wherein the charge control group is an organic group, includes a main skeleton and is a charging group that has a positive or negative charge.

30. The method of manufacturing an electrophoresis dispersion liquid according to claim 18,
wherein the polymer chain-containing compound includes a linking structure in which a plurality of siloxane bonds is linked in series.

31. An electrophoresis dispersion liquid manufactured using the method of manufacturing according to claim 1.

32. A display device comprising:
a first substrate on which a first electrode is provided,
a second substrate arranged facing the first substrate and on which a second electrode is provided; and
a display layer provided between the first substrate and the second substrate, and that includes the electrophoresis dispersion liquid according to claim 31.

33. An electronic apparatus comprising the display device according to claim 32.
